(19) United States
(12) Patent Application Publication
(10) Pub. No.: US 2023/0252399 A1
(43) Pub. Date: Aug. 10, 2023

(54) SYSTEM AND METHOD FOR DETECTION AND TRACKING OF ASSETS IN A VEHICLE

(71) Applicant: Trackonomy Systems, Inc., San Jose, CA (US)

(72) Inventors: Ajay Khoche, West San Jose, CA (US); Saurabh Sanghai, Cupertino, CA (US); Hendrik J. Volkerink, Palo Alto, CA (US)

(21) Appl. No.: 18/126,707

(22) Filed: Mar. 27, 2023

Related U.S. Application Data
(63) Continuation-in-part of application No. 17/931,518, filed on Sep. 12, 2022.
Application No. 17/931,518 is a continuation-in-part of application No. 17/873,072, filed on Jul. 25, 2022.
(60) Provisional application No. 63/324,024, filed on Mar. 26, 2022.
(60) Provisional application No. 63/324,024, filed on Mar. 26, 2022.
(60) Provisional application No. 63/243,182, filed on Sep. 12, 2021.
(60) Provisional application No. 63/225,550, filed on Jul. 25, 2021.
(60) Provisional application No. 63/225,550, filed on Jul. 25, 2021.

(51) Int. Cl. G06Q 10/0833; G06Q 10/083; G06K 7/10

(52) U.S. Cl. CPC G06Q 10/0833; G06Q 10/0838; G06K 7/10297

(57) ABSTRACT

A RFID system includes an RFID controller and an RFID reader communicatively coupled to at least one RFID antenna positioned within a cargo area of a vehicle. The RFID controller includes a status indicator for generating a visual indication, a processor, and memory storing a manifest defining RFID identifiers corresponding to assets for transport by the vehicle. The memory further stores firmware having machine-readable instructions that, when executed by the processor, cause the processor to: control the RFID reader to receive an RFID signal from an RFID tag using one of the at least one RFID antenna, decode an RFID identifier from the RFID signal identifying an RFID tag attached to an asset located within the cargo area, and generate, using the status indicator, a visual indication indicative of the asset being loaded in error when the RFID identifier is not listed in the manifest.

### RELATED APPLICATIONS

This application claims priority to U.S. Patent Application Ser. No. 63/324,024, filed Mar. 26, 2022. This application also is a Continuation-in-Part of U.S. patent application Ser. No. 17/931,518, titled “Multi-Communication-Interface System for Fine Locationing”, filed Sep. 12, 2022, which is a continuation-in-part of U.S. patent application Ser. No. 17/873,072, filed on Jul. 25, 2022; U.S. patent application Ser. No. 17/931,518, and the present application, claims priority to U.S. Patent Application No. 63/243,182, filed Sep. 12, 2021, U.S. Patent Application No. 63/324,024, filed Mar. 26, 2022, and U.S. Patent Application No. 63/225,550, filed Jul. 25, 2021. U.S. patent application Ser. No. 17/873,072 also claims priority to U.S. Patent Application No. 63/225,550. Each of the above referenced Applications is incorporated herein by reference as if fully set forth.

### FIELD OF THE DISCLOSURE

This disclosure generally relates to wireless internet of things (IOT) devices and systems and methods for asset tracking using wireless readers.

### BACKGROUND

Radio frequency identification (RFID) tags are frequently used to inventory assets in a monitored area. However, the accuracy of conventional RFID tag locationing is limited to determining whether the RFID tag (asset) is, or is not, within the monitored area. Asset logistics require transport of assets in vehicles, such as delivery vans. Transportation and delivery of assets is delayed and less efficient when assets are incorrectly loaded onto the wrong vehicle, when the wrong asset is unloaded from the vehicle, and when the operator is unable to locate the assets within the vehicle for drop off at its delivery location.

### SUMMARY

One aspect of the present embodiments includes the realization that significant time and efficiency is lost when an asset is incorrectly loaded onto a vehicle. It is further realized that the optimal time to correct a loading error is during the loading of the asset onto the vehicle. A further realization is that it is also important to ensure that an asset is not incorrectly unloaded and delivered to the wrong location for example. Advantageously, the present embodiments solve this problem by detecting when an asset is being incorrectly loaded or incorrectly unloaded to/from a vehicle and providing an immediate alert to the operator. The immediate nature of the alert (e.g., in-real time via a notification device at the location of the vehicle) has the further advantage that the asset is likely in hand when the alert if given allowing immediate resolution of the error.

Another aspect of the present embodiments includes the realization that efficiency of delivery relies on assets being correctly stored and easily located within the vehicle. For example, when arriving at a delivery location for an asset the operator need to quickly find the correct asset to unload. Advantageously the present embodiments solve this problem by providing a fine RFID location tracking solution within the vehicle to (a) ensure each asset is placed in an expected rack and slot within the vehicle, and (b) provide an indication to the operator of where an asset to be unloaded is located within the vehicle, such as when arriving at its delivery location.

In some aspects, the techniques described herein relate to a system for a detecting and tracking assets in a vehicle, including: an RFID reader; at least one cargo area RFID antenna positioned within a cargo area of the vehicle and communicatively coupled with the RFID reader; and an RFID controller including: a status indicator for generating a visual indication; a processor; and memory, communicatively coupled with the processor and storing: a manifest defining RFID identifiers corresponding to assets expected to be transported by the vehicle; and firmware having machine-readable instructions that, when executed by the processor, cause the processor to: control the RFID reader to receive an RFID signal from an RFID tag using one of the at least one cargo area RFID antenna, decode the RFID signal to determine an RFID identifier of the RFID tag, and generate, using the status indicator, a visual indication indicative of an asset being loaded in error when the RFID identifier does not correspond to the manifest or not in error when the RFID identifier corresponds to the manifest.

In some aspects, the techniques described herein relate to a method including: receiving data indicative of a potential change in a load status of assets in a vehicle; in response, controlling an RFID reader to generate an interrogation signal by at least one cargo area RFID antenna located in a cargo area of the vehicle and receive an RFID signal associated with an RFID tag attached to an asset in response to the interrogation signal; determining that an asset is being loaded onto the vehicle based on the received RFID signal; decoding the RFID signal to determine an RFID identifier of the RFID tag; updating a local database stored on a device in the vehicle with the RFID identifier; and tracking the location of the asset within the interior of the vehicle, based on further received RFID signals from the RFID tag.

In some aspects, the techniques described herein relate to a method for a detecting and tracking assets in a vehicle, including: controlling an RFID reader to receive an RFID signal associated with an RFID tag in response to an interrogation signal transmitted by at least one cargo area RFID antenna located in a cargo area of the vehicle; decoding the RFID signal to determine an RFID identifier of the RFID tag; and generating, using a status indicator, a visual indication indicative of an asset being loaded in error when the RFID identifier is not listed in a manifest or not in error when the RFID identifier corresponds to the manifest.

In some aspects, the techniques described herein relate to a system for assisting in loading an unloading a vehicle, including: a rack having a plurality of slots each sized and shaped for storing an asset; a plurality of slot RFID devices each associated with one of the slots, each slot RFID device including: a wireless transducing circuit that facilitates communication with an RFID controller external to the slot RFID device, a processor, and memory storing computer-readable instructions that when executed by the processor cause the slot RFID device to respectively: identify one or more RFID tags located within the respective slot, transmit indication of presence of one or more RFID tags located within the slot.

### BRIEF DESCRIPTION OF THE FIGURES

FIG. 1 is a schematic illustrating one example adhesive tape-agent platform used to seal a package for shipment, in embodiments.

FIG. 2 is a schematic illustrating a non-adhesive surface of a segment of the adhesive tape agent platform of FIG. 1, in embodiments.

FIG. 3 shows one example adhesive tape platform that includes a set of adhesive tape platform segments on a backing sheet, in embodiments.

FIG. 4 is a block diagram illustrating components of an example wireless transducing circuit that includes one or more wireless communication modules, in embodiments.

FIG. 5 is a top view of a portion of an example flexible adhesive tape platform illustrating a first segment and a portion of a second segment, in embodiments.

FIGS. 6A-C are schematic diagrams illustrating cross-sectional side views of portions of example segments of three types of flexible adhesive tape agent platforms, in embodiments.

FIG. 7 shows an example network communications environment that includes a network for communication between one or more servers, mobile gateways, and various types of tape nodes that are associated with assets, in embodiments.

FIG. 8 is a schematic illustrating an example network communications environment that includes a network supporting communications between servers, mobile gateways, a stationary gateway, and various types of tape nodes associated with various assets, in embodiments.

FIG. 9 is a schematic illustrating one example hierarchical wireless communications network of tape nodes, in embodiments.

FIG. 10A shows a node (Node A) associated with a package (Package A), in embodiments.

FIG. 10B shows a node (Node C) associated with a package (Package C), in embodiments.

FIG. 10C shows a pallet associated with a master node that includes a low-power communications interface, a GPS receiver, and a cellular communications interface, in embodiments.

FIG. 11 is a schematic illustrating a truck configured as a mobile node, or mobile hub, with a cellular communications interface, a medium-power communications interface, and a low power communications interface, in embodiments.

FIG. 12 is a schematic illustrating a master node associated with a logistic item that is grouped together with other logistic items associated with peripheral nodes, in embodiments.

FIG. 13A is a schematic diagram illustrating an adhesive tracking product with a first example wake circuit that delivers power from an energy source to the tracking circuit in response to an event, in embodiments.

FIG. 13B is a schematic diagram illustrating an adhesive tracking product with a second example wake circuit that delivers power from an energy source to the tracking circuit in response to an event, in embodiments.

FIG. 13C is a diagrammatic cross-sectional front view of an example adhesive tape platform and a perspective view of an example asset, in embodiments.

FIG. 14 is a block diagram illustrating one example RFID reader system configured for use in a vehicle, in embodiments.

FIG. 15 is a schematic diagram illustrating example fitting of RFID reader system to a vehicle, in embodiments.

FIG. 16 is a schematic illustrating one example monolithic RFID reader apparatus, in embodiments.

FIG. 17 is a schematic diagram illustrating example fitting of RFID reader system to the vehicle of FIG. 15, in embodiments.

FIG. 18 is a diagram illustrating a rear end of the vehicle of FIG. 17, according to certain embodiments.

FIG. 19 shows one example monolithic RFID reader apparatus, in embodiments.

FIG. 20 is a perspective schematic illustrating one example slot tracking system within the vehicle of FIG. 15, in embodiments.

FIG. 21 is a perspective view showing one slot of FIG. 20 in further example detail, in embodiments.

FIG. 22 is a block diagram showing a warehouse that stores assets for transportation by vehicles, in embodiments.

FIG. 23 shows an example embodiment of computer apparatus that, either alone or in combination with one or more other computing apparatus, is operable to implement one or more of the computer systems described in this specification.

FIG. 24 is a perspective diagram illustrating example use of wireless RFID tape nodes within a vehicle to provide more fidelity to the RFID reader system of FIGS. 14-23, in embodiments.

FIG. 25 shows an example operating environment of the RFID reader systems, in embodiments.

FIG. 26 is a flowchart showing one example method for detecting and tracking assets in a vehicle, in embodiments.

### DETAILED DESCRIPTION OF THE EMBODIMENTS

The present invention is not limited in any way to the illustrated embodiments. Instead, the illustrated embodiments described below are merely examples of the invention. Therefore, the structural and functional details disclosed herein are not to be construed as limiting the claims. The disclosure merely provides bases for the claims and representative examples that enable one skilled in the art to make and use the claimed inventions. Furthermore, the terms and phrases used herein are intended to provide a comprehensible description of the invention without being limiting.

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements and are not drawn to scale.

In some contexts, the term “agent” may refer to a “node”, and an “agent” or “node” may be adhesively applied to a surface and denoted as a “tape node” or “tape agent”. These terms may be used interchangeably, depending on the context. Further, the “agent” or “node” may have two forms of hierarchy: one depending on the functionality of the “agent” or “node”, such as the range of a wireless communication interface, and another depending on which “agent” or “node” may control another “agent” or “node”. For example, an agent with a low-power wireless-communication interface may be referred to a “master agent”.

In some embodiments, a low-power wireless communication interface may have a first wireless range and be operable to implement one or more protocols including Zigbee, near-field communication (NFC), Bluetooth Low Energy, Bluetooth Classic, Wi-Fi, and ultra-wideband. For example, the low-power wireless-communication interface may have a range of between 0 and 300 meters or farther, depending on the implemented protocol. The communication interface implementation, e.g., Zigbee or Bluetooth Low Energy, may be selected based upon the distance of communication between the low-power wireless-communication interface and the recipient, and/or a remaining battery level of the low-power wireless-communication interface.

An agent with a medium-power wireless communication-interface may be referred to as a “secondary agent”. The medium-power wireless communication interface may have a second wireless range and be operable to implement one or more protocols including Zigbee, Bluetooth Low Energy interface, LoRa. For example, the medium-power wireless-communication interface may have a range of between 0 and 20 kilometers. The communication interface implementation, e.g., Zigbee, Bluetooth Low Energy, or LoRa, may be selected based upon the distance of communication between the medium-power wireless-communication interface and the recipient, and/or a remaining battery level of the medium-power wireless-communication interface.

An agent with a high-power wireless communication-interface may be referred to as a “tertiary agent”. The high-power wireless communication interface may have a third wireless range and be operable to implement one or more protocols including Zigbee, Bluetooth Low Energy, LoRa, Global System for Mobile Communication, General Packet Radio Service, cellular, near-field communication, and radio-frequency identification. For example, the high-power wireless-communication interface may have a global range, where the high-power wireless-communication interface may communicate with any electronic device implementing a similar communication protocol. The communication interface protocol selected may depend on the distance of communication between the high-power wireless-communication interface and a recipient, and/or a remaining battery level of the high-power wireless-communication interface.

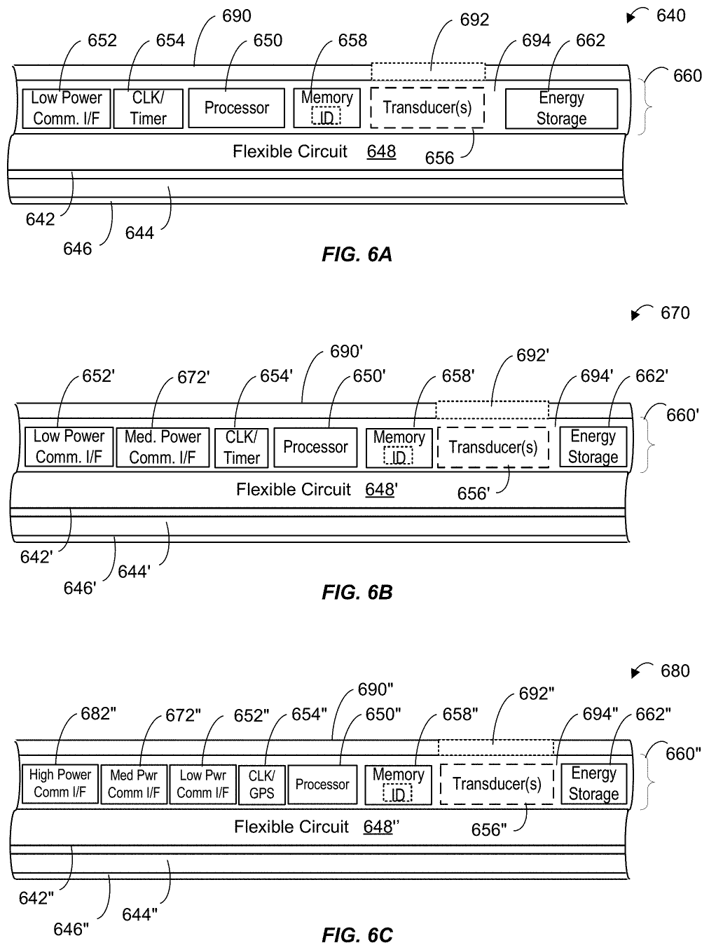

In some examples, a secondary agent may also include a low-power wireless-communication interface and a tertiary agent may also include low and medium-power wireless-communication interfaces, as discussed below with reference to FIGS. 6A-C. Further continuing the example, a “master agent”, a “secondary agent”, or a “tertiary agent” may refer to a “master tape node”, a “secondary tape node”, or a “tertiary tape node”.

With regard to the second form of hierarchy, the “agent”, “node”, “tape agent”, and “tape node”, may be qualified as a parent, child, or master, depending on whether a specific “agent” or “node” controls another “agent” or “node”. For example, a master-parent agent controls the master-child agent and a secondary or tertiary-parent agent controls a master-child agent. The default, without the qualifier of “parent” or “child” is that the master agent controls the secondary or tertiary agent Further, the “master tape node” may control a “secondary tape node” and a “tertiary tape node”, regardless of whether the master tape node is a parent node.

Further, each of the “agents”, “nodes”, “tape nodes”, and “tape agents” may be referred to as “intelligent nodes”, “intelligent tape nodes”, “intelligent tape agents”, and/or “intelligent tape agents” or any variant thereof, depending on the context and, for ease, may be used interchangeably.

Further, each of the “agents”, “nodes”, “tape nodes”, and “tape agents” may include flexible or non-flexible form factors unless otherwise specified. Thus, each of the “agents”, “nodes”, “tape nodes”, and “tape agents” include flexible and non-flexible (rigid) form factors, or a combination thereof including flexible components and non-flexible components.

An adhesive tape platform includes a plurality of segments that may be separated from the adhesive product (e.g., by cutting, tearing, peeling, or the like) and adhesively attached to a variety of different surfaces to inconspicuously implement any of a wide variety of different wireless communications-based network communications and transducing (e.g., sensing, actuating, etc.) applications. In certain embodiments, each segment of an adhesive tape platform has an energy source, wireless communication functionality, transducing functionality (e.g., sensor and energy harvesting functionality), and processing functionality that enable the segment to perform one or more transducing functions and report the results to a remote server or other computer system directly or through a network (e.g., formed by tape nodes and/or other network components). The components of the adhesive tape platform are encapsulated within a flexible adhesive structure that protects the components from damage while maintaining the flexibility needed to function as an adhesive tape (e.g., duct tape or a label) for use in various applications and workflows. In addition to single function applications, example embodiments also include multiple transducers (e.g., sensing and/or actuating transducers) that extend the utility of the platform by, for example, providing supplemental information and functionality relating characteristics of the state and/or environment of, for example, an article, object, vehicle, or person, over time.

Systems and processes for fabricating flexible multifunction adhesive tape platforms in efficient and low-cost ways also are described in US Patent Application Publication No. US-2018-0165568-A1. For example, in addition to using roll-to-roll and/or sheet-to-sheet manufacturing techniques, the fabrication systems and processes are configured to optimize the placement and integration of components within the flexible adhesive structure to achieve high flexibility and ruggedness. These fabrication systems and processes are able to create useful and reliable adhesive tape platforms that may provide local sensing, wireless transmitting, and positioning functionalities. Such functionality together with the low cost of production is expected to encourage the ubiquitous deployment of adhesive tape platform segments and thereby alleviate at least some of the problems arising from gaps in conventional infrastructure coverage that prevent continuous monitoring, event detection, security, tracking, and other logistics applications across heterogeneous environments.

As used herein, the term “or” refers an inclusive “or” rather than an exclusive “or.” In addition, the articles “a” and “an” as used in the specification and claims mean “one or more” unless specified otherwise or clear from the context to refer the singular form.

The terms “module,” “manager,” “component”, and “unit” refer to hardware, software, or firmware, or a combination thereof. The term “processor” or “computer” or the like includes one or more of: a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC), a memory controller, bus controller, and other components that manage data flow between said processor associated memory, and other components communicably coupled to the system bus. Thus the terms “module,” “manager,” “component”, and “unit” may include computer readable instructions that, when executed by a processor, implement the functionality discussed herein with respect to said “module,” “manager,” “component”, and “unit”.

### Adhesive Tape Agent Platform

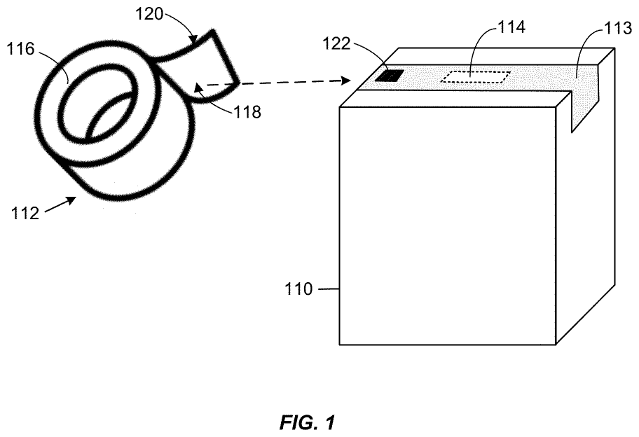

FIG. 1 is a schematic showing one example adhesive tape-agent platform 112, including wireless transducing circuit 114, used to seal a package 110 for shipment. In this example, a segment 113 of the adhesive tape-agent platform 112 is dispensed from a roll 116 and affixed to the package 110. The adhesive tape-agent platform 112 includes an adhesive side 118 and a non-adhesive surface 120. The adhesive tape-agent platform 112 may be dispensed from the roll 116 in the same way as any conventional packing tape, shipping tape, or duct tape. For example, the adhesive tape-agent platform 112 may be dispensed from the roll 116 by hand, laid across the seam where the two top flaps of the package 110 meet, and cut to a suitable length either by hand or using a cutting instrument (e.g., scissors or an automated or manual tape dispenser). Examples of such tape agents include tape agents having non-adhesive surface 120 that carry one or more coatings or layers (e.g., colored, light reflective, light absorbing, and/or light emitting coatings or layers). Further, the segment 113 may include an identifier 122 (e.g., a QR code, RFID chip, etc.) that may be used to associate the segment 113 with the package 110, as discussed below.

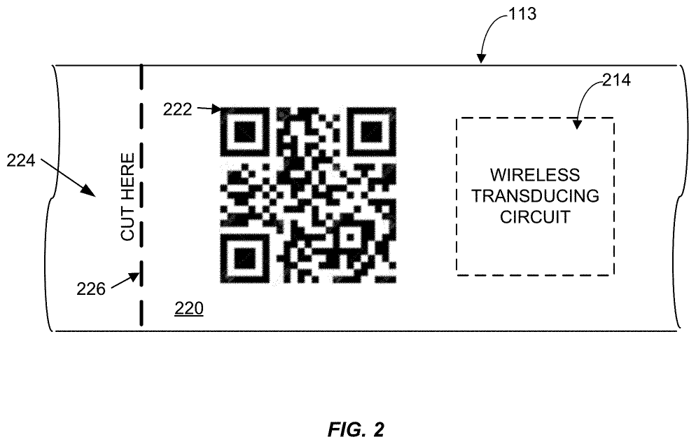

FIG. 2 is a schematic showing the non-adhesive surface 120 of the segment 113 of the adhesive tape agent platform 112 of FIG. 1 including writing or other markings that convey instructions, warnings, or other information to a person or machine (e.g., a bar code reader), or may simply be decorative and/or entertaining. For example, different types of adhesive tape-agent platforms may be marked with distinctive colorations to distinguish one type of adhesive tape agent platform from another. In the illustrated example of FIG. 2, the segment 113 of the adhesive tape agent platform 112 includes an identifier 122 (e.g., a two-dimensional bar code, such as a QR Code), written instructions 224 (e.g., “Cut Here”), and an associated cut line 226 that indicates where the user should cut the adhesive tape agent platform 112. The written instructions 224 and the cut line 226 typically are printed or otherwise marked on the top non-adhesive surface 120 of the adhesive tape agent platform 112 during manufacture. The identifier 122 (e.g., a two-dimensional bar code), on the other hand, may be marked on the non-adhesive surface 120 of the adhesive tape agent platform 112 during the manufacture of the adhesive tape agent platform 112 or, alternatively, may be marked on the non-adhesive surface 120 of the adhesive tape agent platform 112 as needed using, for example, a printer or other marking device.

To avoid damaging the functionality of the segments of the adhesive tape agent platform 112, the cut lines 226 may demarcate the boundaries between adjacent segments at locations that are free of any active components of the wireless transducing circuit 114. The spacing between the wireless transducing circuit 114 and the cut lines 226 may vary depending on the intended communication, transducing and/or adhesive taping application. In the example illustrated in FIG. 1, the length of the adhesive tape-agent platform 112 that is dispensed to seal the package 110 corresponds to a single segment of the adhesive tape-agent platform 112. In other examples, the length of the adhesive tape-agent platform 112 needed to seal a package or otherwise serve the adhesive function for which the adhesive tape-agent platform 112 is being applied may include multiple segments 113 of the adhesive tape-agent platform 112, one or more of which segments 113 may be activated upon cutting the length of the adhesive tape-agent platform 112 from the roll 116 and/or applying the segment 113 of the adhesive tape agent platform to the package 110.

In some examples, the wireless transducing circuits 114 embedded in one or more segments 113 of the adhesive tape-agent platform 112 are activated when the adhesive tape agent platform 112 is cut along the cut line 226. In these examples, the adhesive tape-agent platform 112 includes one or more embedded energy sources (e.g., thin film batteries, which may be printed, or conventional cell batteries, such as conventional watch style batteries, rechargeable batteries, or other energy storage device, such as a super capacitor or charge pump) that supply power to the wireless transducing circuit 114 in one or more segments of the adhesive tape-agent platform 112 in response to being separated from the adhesive tape-agent platform 112 (e.g., along the cut line 226).

In some examples, each segment 113 of the adhesive tape agent platform 112 includes its own respective energy source. In some embodiments, the energy source is a battery of a type described above, an energy harvesting component or system that harvests energy from the environment, or both. In some of these examples, each energy source is configured to only supply power to the components in its respective adhesive tape platform segment regardless of the number of contiguous segments that are in a given length of the adhesive tape-agent platform 112. In other examples, when a given length of the adhesive tape agent platform 112 includes multiple segments 113, the energy sources in the respective segments 113 are configured to supply power to the wireless transducing circuit 114 in all of the segments 113 in the given length of the adhesive tape agent platform 112. In some of these examples, the energy sources are connected in parallel and concurrently activated to power the wireless transducing circuit 114 in all of the segments 113 at the same time. In other examples, the energy sources are connected in parallel and alternately activated to power the wireless transducing circuit 114 in respective ones of the segments 113 at different time periods, which may or may not overlap.

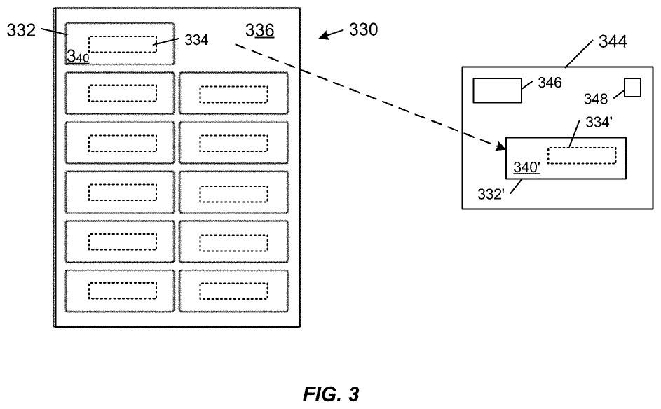

FIG. 3 is a schematic showing one example adhesive tape platform 330 that includes a set of adhesive tape platform segments 332 each of which includes a respective set of embedded wireless transducing circuit components 334, and a backing sheet 336 with a release coating that prevents the adhesive segments 332 from adhering strongly to the backing sheet 336. Adhesive tape platform 330 may represent adhesive tape platform 112 if FIG. 1. Each adhesive tape platform segment 332 includes an adhesive side facing the backing sheet 336, and an opposing non-adhesive side 340. In this example, a particular segment 332 of the adhesive tape platform 330 has been removed from the backing sheet 336 and affixed to an envelope 344. Each segment 332 of the adhesive tape platform 330 can be removed from the backing sheet 336 in the same way that adhesive labels can be removed from a conventional sheet of adhesive labels (e.g., by manually peeling a segment 332 from the backing sheet 336). In general, the non-adhesive side 340 of the segment 332 may include any type of writing, markings, decorative designs, or other ornamentation. In the illustrated example, the non-adhesive side 340 of the segment 332 includes writing or other markings that correspond to a destination address for the envelope 344. The envelope 44 also includes a return address 346 and, optionally, a postage stamp or mark 348.

In some examples, segments of the adhesive tape platform 330 are deployed by a human operator. The human operator may be equipped with a mobile phone or other device that allows the operator to authenticate and initialize the adhesive tape platform 330. In addition, the operator can take a picture of a parcel including the adhesive tape platform and any barcodes associated with the parcel and, thereby, create a persistent record that links the adhesive tape platform 330 to the parcel. In addition, the human operator typically will send the picture to a network service and/or transmit the picture to the adhesive tape platform 330 for storage in a memory component of the adhesive tape platform 330.

In some examples, the wireless transducing circuit components 334 that are embedded in a segment 332 of the adhesive tape platform 330 are activated when the segment 332 is removed from the backing sheet 336. In some of these examples, each segment 332 includes an embedded capacitive sensing system that can sense a change in capacitance when the segment 332 is removed from the backing sheet 336. As explained in detail below, a segment 332 of the adhesive tape platform 330 includes one or more embedded energy sources (e.g., thin film batteries, common disk-shaped cell batteries, or rechargeable batteries or other energy storage devices, such as a super capacitor or charge pump) that can be configured to supply power to the wireless transducing circuit components 334 in the segment 332 in response to the detection of a change in capacitance between the segment 332 and the backing sheet 336 as a result of removing the segment 332 from the backing sheet 336.

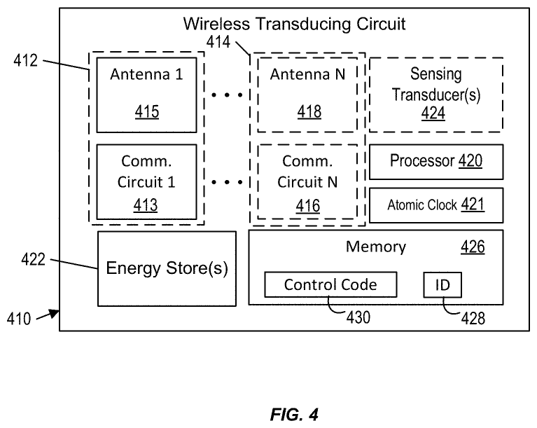

FIG. 4 is a block diagram illustrating components of an example wireless transducing circuit 410 (e.g., an agent) that includes one or more wireless communication modules 412, 414. Each wireless communication module 412, 414 includes a wireless communication circuit 413, 416, and an antenna 415, 418, respectively. Each wireless communication circuit 413, 416 may represent a receiver or transceiver integrated circuit that implements one or more of GSM/GPRS, Wi-Fi, LoRa, Bluetooth, Bluetooth Low Energy, Z-wave, and ZigBee. The wireless transducing circuit 410 also includes a processor 420 (e.g., a microcontroller or microprocessor), a solid-state atomic clock 421, at least one energy store 422 (e.g., non-rechargeable or rechargeable printed flexible battery, conventional single or multiple cell battery, and/or a super capacitor or charge pump), one or more sensing transducers 424 (e.g., sensors and/or actuators, and, optionally, one or more energy harvesting transducers). In some examples, the conventional single or multiple cell battery may be a watch style disk or button cell battery that is in an associated electrical connection apparatus (e.g., a metal clip) that electrically connects the electrodes of the battery to contact pads on the wireless transducing circuit 410.

Sensing transducers 424 may represent one or more of a capacitive sensor, an altimeter, a gyroscope, an accelerometer, a temperature sensor, a strain sensor, a pressure sensor, a piezoelectric sensor, a weight sensor, an optical or light sensor (e.g., a photodiode or a camera), an acoustic or sound sensor (e.g., a microphone), a smoke detector, a radioactivity sensor, a chemical sensor (e.g., an explosives detector), a biosensor (e.g., a blood glucose biosensor, odor detectors, antibody based pathogen, food, and water contaminant and toxin detectors, DNA detectors, microbial detectors, pregnancy detectors, and ozone detectors), a magnetic sensor, an electromagnetic field sensor, a humidity sensor, a light emitting units (e.g., light emitting diodes and displays), electro-acoustic transducers (e.g., audio speakers), electric motors, and thermal radiators (e.g., an electrical resistor or a thermoelectric cooler).

Wireless transducing circuit 410 includes a memory 426 for storing data, such as profile data, state data, event data, sensor data, localization data, security data, and/or at least one unique identifier (ID) 428 associated with the wireless transducing circuit 410, such as one or more of a product ID, a type ID, and a media access control (MAC) ID. Memory 426 may also store control code 430 that includes machine-readable instructions that, when executed by the processor 420, cause processor 420 to perform one or more autonomous agent tasks. In certain embodiments, the memory 426 is incorporated into one or more of the processor 420 or sensing transducers 424. In other embodiments, memory 426 is integrated in the wireless transducing circuit 410 as shown in FIG. 4. The control code 430 may implement programmatic functions or program modules that control operation of the wireless transducing circuit 410, including implementation of an agent communication manager that manages the manner and timing of tape agent communications, a node-power manager that manages power consumption, and a tape agent connection manager that controls whether connections with other nodes are secure connections (e.g., connections secured by public key cryptography) or unsecure connections, and an agent storage manager that securely manages the local data storage on the wireless transducing circuit 410. In certain embodiments, a node connection manager ensures the level of security required by the end application and supports various encryption mechanisms. In some examples, a tape agent power manager and communication manager work together to optimize the battery consumption for data communication. In some examples, execution of the control code by the different types of nodes described herein may result in the performance of similar or different functions.

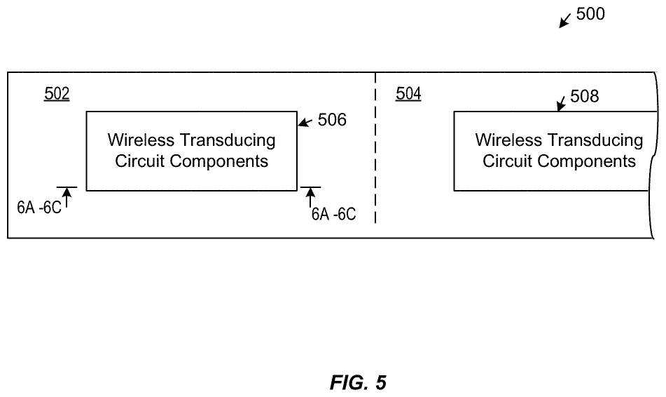

FIG. 5 is a top view of a portion of an example flexible adhesive tape platform 500 that shows a first segment 502 and a portion of a second segment 504. Each segment 502, 504 of the flexible adhesive tape platform 500 includes a respective set 506, 508 of the components of the wireless transducing circuit 410 of FIG. 4. The segments 502, 504 and their respective sets of components 506, 508 typically are identical and configured in the same way. In some other embodiments, however, the segments 502, 504 and/or their respective sets of components 506, 508 are different and/or configured in different ways. For example, in some examples, different sets of the segments of the flexible adhesive tape platform 500 have different sets or configurations of tracking and/or transducing components that are designed and/or optimized for different applications, or different sets of segments of the flexible adhesive tape platform may have different ornamentations (e.g., markings on the exterior surface of the platform) and/or different (e.g., alternating) lengths.

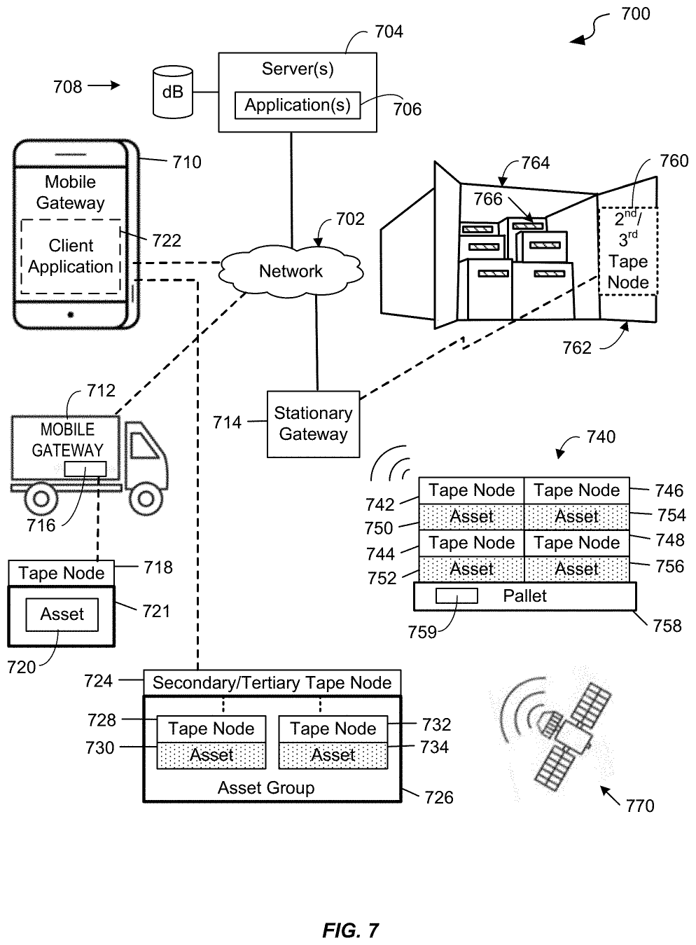

An example method of fabricating the adhesive tape platform 500 according to a roll-to-roll fabrication process is described in connection with FIGS. 6A-6C and as shown in FIGS. 7A and 7C of U.S. patent application Ser. No. 15/842,861, filed Dec. 14, 2017, the entirety of which is incorporated herein by reference.

The instant specification describes an example system of adhesive tape platforms (also referred to herein as “tape nodes”) that can be used to implement a low-cost wireless network infrastructure for performing monitoring, tracking, and other asset management functions relating to, for example, parcels, persons, tools, equipment and other physical assets and objects. The example system includes a set of three different types of tape nodes that have different respective functionalities and different respective cover markings that visually distinguish the different tape node types from one another. In one non-limiting example, the covers of the different tape node types are marked with different colors (e.g., white, green, and black). In the illustrated examples, the different tape node types are distinguishable from one another by their respective wireless communications capabilities and their respective sensing capabilities.

FIG. 6A shows a cross-sectional side view of a portion of an example segment 640 of a flexible adhesive tape agent platform (e.g., platform 500 of FIG. 5) that includes a respective set of the components of the wireless transducing circuit 410 corresponding to the first tape-agent type (e.g., white). The segment 640 includes an adhesive layer 642, an optional flexible substrate 644, and an optional adhesive layer 646 on the bottom surface of the flexible substrate 644. When the bottom adhesive layer 646 is present, a release liner (not shown) may be (weakly) adhered to the bottom surface of the adhesive layer 646. In certain embodiments where adhesive layer 646 is included, the adhesive layer 646 is an adhesive (e.g., an acrylic foam adhesive) with a high-bond strength that is sufficient to prevent removal of the segment 640 from a surface on which the adhesive layer 646 is adhered to without destroying the physical or mechanical integrity of the segment 640 and/or one or more of its constituent components.

In certain embodiments including the optional flexible substrate 644, the optional flexible substrate 644 is a prefabricated adhesive tape that includes the adhesive layers 642 and 646 and the optional release liner. In other embodiments including the optional flexible substrate 644, the adhesive layers 642, 646 are applied to the top and bottom surfaces of the flexible substrate 644 during the fabrication of the adhesive tape platform. The adhesive layer 642 may bond the flexible substrate 644 to a bottom surface of a flexible circuit 648, that includes one or more wiring layers (not shown) that connect the processor 650, a low-power wireless-communication interface 652 (e.g., a Zigbee, Bluetooth® Low Energy (BLE) interface, or other low power communication interface), a clock and/or a timer circuit 654, transducing and/or transducer(s) 656 (if present), the memory 658, and other components in a device layer 660 to each other and to the energy storage device 662 and, thereby, enable the transducing, tracking and other functionalities of the segment 640. The low-power wireless-communication interface 652 typically includes one or more of the antennas 415, 418 and one or more of the wireless communication circuits 413, 416 of FIG. 4. The segment 640 may further include a flexible cover 690, an interfacial region 692, and a flexible polymer layer 694.

FIG. 6B shows a cross-sectional side-view of a portion of an example segment 670 of a flexible adhesive tape agent platform (e.g., platform 500 of FIG. 5) that includes a respective set of the components of the wireless transducing circuit 410 corresponding to a second tape-agent type (e.g., green). The segment 670 is similar to the segment 640 shown in FIG. 6A but further includes a medium-power communication-interface 672′ (e.g., a LoRa interface) in addition to the low-power communications-interface 652. The medium-power communication-interface 672′ has a longer communication range than the low-power communication-interface 652′. In certain embodiments, one or more other components of the segment 670 differ from the segment 640 in functionality or capacity (e.g., larger energy source). The segment 670 may include further components, as discussed above and below with reference to FIGS. 6A, and 6C.

FIG. 6C shows a cross-sectional side view of a portion of an example segment 680 of the flexible adhesive tape-agent platform that includes a respective set of the components of the wireless transducing circuit 410 corresponding to the third tape-node type (e.g., black). The segment 680 is similar to the segment 670 of FIG. 6B, but further includes a high-power communications-interface 682″ (e.g., a cellular interface; e.g., GSM/GPRS) in addition to a low-power communications-interface 652″ and may include a medium-power communications-interface 672″. The high-power communications-interface 682″ has a range that provides global coverage to available infrastructure (e.g., the cellular network). In certain embodiments, one or more other components of the segment 680 differ from the segment 670 in functionality or capacity (e.g., larger energy source).

FIGS. 6A-6C show embodiments in which the flexible covers 690, 690′, 690″ of the respective segments 640, 670, and 680 include one or more interfacial regions 692, 692′, 692″ positioned over one or more of the transducers 656, 656′, 656″. In certain embodiments, one or more of the interfacial regions 692, 692′, 692″ have features, properties, compositions, dimensions, and/or characteristics that are designed to improve the operating performance of the platform for specific applications. In certain embodiments, the flexible adhesive tape platform includes multiple interfacial regions 692, 692′, 692″ over respective transducers 656, 656′, 656″, which may be the same or different depending on the target applications. Interfacial regions may represent one or more of an opening, an optically transparent window, and/or a membrane located in the interfacial regions 692, 692′, 692″ of the flexible covers 690, 690′, 690″ that is positioned over the one or more transducers and/or transducers 656, 656′, 656″. Additional details regarding the structure and operation of example interfacial regions 692, 692′, 692″ are described in U.S. Provisional Patent Application No. 62/680,716, filed Jun. 5, 2018, and U.S. Provisional Patent Application No. 62/670,712, filed May 11, 2018.

In certain embodiments, a planarizing polymer 694, 694′, 694″ encapsulates the respective device layers 660, 660′, 660″ and thereby reduces the risk of damage that may result from the intrusion of contaminants and/or liquids (e.g., water) into the device layer 660, 660′, 660″. The flexible polymer layers 694, 694′, 694″ may also planarize the device layers 660, 660′, 660″. This facilitates optional stacking of additional layers on the device layers 660, 660′, 660″ and also distributes forces generated in, on, or across the segments 640, 670, 680 so as to reduce potentially damaging asymmetric stresses that might be caused by the application of bending, torquing, pressing, or other forces that may be applied to the segments 640, 670, 680 during use. In the illustrated example, a flexible cover 690, 690′, 690″ is bonded to the planarizing polymer 694, 694′, 694″ by an adhesive layer (not shown).

The flexible cover 690, 690′, 690″ and the flexible substrate 644, 644′, 644″ may have the same or different compositions depending on the intended application. In some examples, one or both of the flexible cover 690, 690′, 690″ and the flexible substrate 644, 644′, 644″ include flexible film layers and/or paper substrates, where the film layers may have reflective surfaces or reflective surface coatings. Compositions for the flexible film layers may represent one or more of polymer films, such as polyester, polyimide, polyethylene terephthalate (PET), and other plastics. The optional adhesive layer on the bottom surface of the flexible cover 690, 690′, 690″ and the adhesive layers 642, 642′, 642″, 646, 646′, 646″ on the top and bottom surfaces of the flexible substrate 644, 644′, 644″ typically include a pressure-sensitive adhesive (e.g., a silicon-based adhesive). In some examples, the adhesive layers are applied to the flexible cover 690, 690′, 690″ and the flexible substrate 644, 644′, 644″ during manufacture of the adhesive tape-agent platform (e.g., during a roll-to-roll or sheet-to-sheet fabrication process). In other examples, the flexible cover 690, 690′, 690″ may be implemented by a prefabricated single-sided pressure-sensitive adhesive tape and the flexible substrate 644, 644′, 644″ may be implemented by a prefabricated double-sided pressure-sensitive adhesive tape; both kinds of tape may be readily incorporated into a roll-to-roll or sheet-to-sheet fabrication process. In some examples, the flexible substrate 644, 644′, 644″ is composed of a flexible epoxy (e.g., silicone).

In certain embodiments, the energy storage device 662, 662′, 662″ is a flexible battery that includes a printed electrochemical cell, which includes a planar arrangement of an anode and a cathode and battery contact pads. In some examples, the flexible battery may include lithium-ion cells or nickel-cadmium electro-chemical cells. The flexible battery typically is formed by a process that includes printing or laminating the electro-chemical cells on a flexible substrate (e.g., a polymer film layer). In some examples, other components may be integrated on the same substrate as the flexible battery. For example, the low-power wireless-communication interface 652, 652′, 652″ and/or the processor(s) 650, 650′, 650″ may be integrated on the flexible battery substrate. In some examples, one or more of such components also (e.g., the flexible antennas and the flexible interconnect circuits) may be printed on the flexible battery substrate.

In examples of manufacture, the flexible circuit 648, 648′, 648″ is formed on a flexible substrate by one or more of printing, etching, or laminating circuit patterns on the flexible substrate. In certain embodiments, the flexible circuit 648, 648′, 648″ is implemented by one or more of a single-sided flex circuit, a double access or back-bared flex circuit, a sculpted flex circuit, a double-sided flex circuit, a multi-layer flex circuit, a rigid flex circuit, and a polymer-thick film flex circuit. A single-sided flexible circuit has a single conductor layer made of, for example, a metal or conductive (e.g., metal filled) polymer on a flexible dielectric film. A double access or back bared flexible circuit has a single conductor layer but is processed so as to allow access to selected features of the conductor pattern from both sides. A sculpted flex circuit is formed using a multi-step etching process that produces a flex circuit that has finished copper conductors that vary in thickness along their respective lengths. A multilayer flex circuit has three of more layers of conductors, where the layers typically are interconnected using plated through holes. Rigid flex circuits are a hybrid construction of flex circuit consisting of rigid and flexible substrates that are laminated together into a single structure, where the layers typically are electrically interconnected via plated through holes. In polymer thick film (PTF) flex circuits, the circuit conductors are printed onto a polymer base film, where there may be a single conductor layer or multiple conductor layers that are insulated from one another by respective printed insulating layers.

In the example segments 640, 670, 680 shown in FIGS. 6A-6C, the flexible circuit 648, 648′, 648″ represents a single-access flex-circuit that interconnects the components of the adhesive tape platform on a single side of the flexible circuit 648, 648′, 648″. However, in other embodiments, the flexible circuit 648, 648′, 648″ represents a double access flex circuit that includes a front-side conductive pattern that interconnects the low-power communications interface 652, 652′, 652″, the timer circuit 654, 654′, 654″, the processor 650, 650′, 650″, the one or more sensor transducers 656, 656′, 656″ (if present), and the memory 658, 658′, 658″, and allows through-hole access (not shown) to a back-side conductive pattern that is connected to the flexible battery (not shown). In these embodiments, the front-side conductive pattern of the flexible circuit 648, 648′, 648″ connects the communications circuits 652, 652′, 652″, 672′, 672″, 682″ (e.g., receivers, transmitters, and transceivers) to their respective antennas and to the processor 650, 650′, 650″ and also connects the processor 650, 650′, 650″ to the one or more sensors and the memory 658, 658′, and 658″. The backside conductive pattern connects the active electronics (e.g., the processor 650, 650′, 650″, the communications circuits 652, 652′, 652″, 672′, 672″, 682″ and the transducers) on the front-side of the flexible circuit 648, 648′, 648″ to the electrodes of the energy storage device 662, 662′, 662″ via one or more through holes in the substrate of the flexible circuit 648, 648′, 648″.

The various units of the segments 640, 670, 680 shown in FIGS. 6A-6C may be arranged to accommodate different objects or structures (e.g., trash bins, fire extinguishers, etc.) and sensors may be added to, or subtracted from, the segments 640, 670, and 680, according to a particular task.

FIG. 7 shows an example network communications environment 700 that includes a network 702 that supports communications between one or more servers 704 executing one or more applications of a network service 708, mobile gateways 710 (a smart device mobile gateway), 712 (a vehicle mobile gateway), a stationary gateway 714, and various types of tape nodes that are associated with various assets (e.g., parcels, equipment, tools, persons, and other things). Network communications environment 700 may also be called a wireless tracking system 700. Hereinafter “tape nodes” may be used interchangeably with the “agents”, as described above, with reference to FIGS. 1-6C; the “agents” are in the form of a “tape node” attached to different objects, e.g., an asset, storage container, vehicle, equipment, etc.; the master agent may be referred to as a master tape node, a secondary agent may be referred to as a secondary tape node; and a tertiary agent may be referred to as a tertiary tape node.

In some examples, the network 702 (e.g., a wireless network) includes one or more network communication systems and technologies, including any one or more of wide area networks, local area networks, public networks (e.g., the internet), private networks (e.g., intranets and extranets), wired networks, and wireless networks. For example, the network 702 includes communications infrastructure equipment, such as a geolocation satellite system 770 (e.g., GPS, GLONASS, and NAVSTAR), cellular communication systems (e.g., GSM/GPRS), Wi-Fi communication systems, RF communication systems (e.g., LoRa), Bluetooth communication systems (e.g., a Bluetooth Low Energy system), Z-wave communication systems, and ZigBee communication systems.

In some examples, the one or more network service applications leverage the above-mentioned communications technologies to create a hierarchical wireless network of tape nodes improves asset management operations by reducing costs and improving efficiency in a wide range of processes, from asset packaging, asset transporting, asset tracking, asset condition monitoring, asset inventorying, and asset security verification. Communication across the network is secured by a variety of different security mechanisms. In the case of existing infrastructure, a communication link uses the infrastructure security mechanisms. In the case of communications among tapes nodes, the communication is secured through a custom security mechanism. In certain cases, tape nodes may also be configured to support block chain to protect the transmitted and stored data.

A network of tape nodes may be configured by the network service to create hierarchical communications network. The hierarchy may be defined in terms of one or more factors, including functionality (e.g., wireless transmission range or power), role (e.g., master-tape node vs. peripheral-tape node), or cost (e.g., a tape node equipped with a cellular transceiver vs. a peripheral tape node equipped with a Bluetooth LE transceiver). As described above with reference to the agents, tape nodes may be assigned to different levels of a hierarchical network according to one or more of the above-mentioned factors. For example, the hierarchy may be defined in terms of communication range or power, where tape nodes with higher-power or longer-communication range transceivers are arranged at a higher level of the hierarchy than tape nodes with lower-power or lower-range power or lower range transceivers. In another example, the hierarchy is defined in terms of role, where, e.g., a master tape node is programmed to bridge communications between a designated group of peripheral tape nodes and a gateway node or server node. The problem of finding an optimal hierarchical structure may be formulated as an optimization problem with battery capacity of nodes, power consumption in various modes of operation, desired latency, external environment, etc. and may be solved using modern optimization methods e.g. neural networks, artificial intelligence, and other machine learning computing systems that take expected and historical data to create an optimal solution and may create algorithms for modifying the system's behavior adaptively in the field.

The tape nodes may be deployed by automated equipment or manually. In this process, a tape node typically is separated from a roll or sheet and adhered to a parcel (e.g., asset 720) or other stationary (e.g., stationary gateway 714) or mobile object (e.g., a, such as a delivery truck, such as mobile gateway 712) or stationary object (e.g., a structural element of a building). This process activates the tape node (e.g., the tape node 718) and causes the tape node 718 to communicate with the one or more servers 704 of the network service 708. In this process, the tape node 718 may communicate through one or more other tape nodes (e.g., the tape nodes 742, 744, 746, 748) in the communication hierarchy. In this process, the one or more servers 704 executes the network service application 706 to programmatically configure tape nodes 718, 724, 728, 732, 742, 744, 746, 748, that are deployed in the network communications environment 700. In some examples, there are multiple classes or types of tape nodes (e.g., the master agent, secondary agent, or tertiary agent discussed herein), where each tape node class has a different respective set of functionalities and/or capacities, as described herein with respect to the “agents.”

In some examples, the one or more servers 704 communicate over the network 702 with one or more gateways 710, 712, 714 that are configured to send, transmit, forward, or relay messages to the network 702 in response to transmissions from the tape nodes 718, 724, 728, 732, 742, 744, 746, 748 that are associated with respective assets and within communication range. Example gateways include mobile gateways 710, 712 and a stationary gateway 714. In some examples, the mobile gateways 710, 712, and the stationary gateway 714 are able to communicate with the network 702 and with designated sets or groups of tape nodes.

In some examples, the mobile gateway 712 is a vehicle (e.g., a delivery truck or other mobile hub) that includes a wireless communications unit 716 that is configured by the network service 708 to communicate with a designated network of tape nodes, including tape node 718 (e.g., a master tape node) in the form of a label that is adhered to a parcel 721 (e.g., an envelope) that contains an asset 720, and is further configured to communicate with the network service 708 over the network 702. In some examples, the tape node 718 includes a lower-power wireless-communications interface of the type used in, e.g., segment 640 (shown in FIG. 6A), and the wireless communications unit 716 may implemented by a secondary or tertiary tape node (e.g., one of segment 670 or segment 680, respectively shown in FIGS. 6B and 6C) that includes a lower-power communications interfaces for communicating with tape nodes within range of the mobile gateway 712 and a higher-power communications-interface for communicating with the network 702. In this way, the tape node 718 and wireless communications unit 716 create a hierarchical wireless network of tape nodes for transmitting, forwarding, bridging, relaying, or otherwise communicating wireless messages to, between, or on behalf of the tape node 718 in a power-efficient and cost-effective way.

In some examples, a mobile gateway 710 is a mobile phone that is operated by a human operator and executes a client application 722 that is configured by a network service to communicate with a designated set of tape nodes, including a secondary or tertiary tape node 724 that is adhered to a parcel 726 (e.g., a box), and is further configured to communicate with a server 704 over the network 702. In the illustrated example, the parcel 726 contains a first parcel labeled or sealed by a master tape node 728 and containing a first asset 730, and a second parcel labeled or sealed by a master tape node 732 and containing a second asset 734. The secondary or tertiary tape node 724 communicates with each of the master tape nodes 728, 732 and also communicates with the mobile gateway 710. In some examples, each of the master tape nodes 728, 732 includes a lower-power wireless-communications interface of the type used in, e.g., segment 640 (shown in FIG. 6A), and the secondary/tertiary tape node 724 is implemented by a tape node (e.g., segment 670 or segment 680, shown in FIGS. 6B and 6C) that includes a low-power communications interface for communicating with the master tape nodes 728, 732 contained within the parcel 726, and a higher-power communications interface for communicating with the mobile gateway 710. The secondary or tertiary tape node 724 is operable to relay wireless communications between the master tape nodes 728, 732 contained within the parcel 726 and the mobile gateway 710, and the mobile gateway 710 is operable to relay wireless communications between the secondary or tertiary tape node 724 and the server 704 over the network 702. In this way, the master tape nodes 728 and 732 and the secondary or tertiary tape node 724 create a wireless network of nodes for transmitting, forwarding, relaying, or otherwise communicating wireless messages to, between, or on behalf of the master tape nodes 728, 732, the secondary or tertiary tape node 724, and the network service (not shown) in a power-efficient and cost-effective way.

In some embodiments, the client application 722 is installed on a mobile device (e.g., smartphone) that may also operate as mobile gateway 710. The client application 722 may cause the mobile device to function as a mobile gateway 710. For example, the client application 722 runs in the background to allow the mobile device to bridge communications between tape nodes that are communicating on one protocol to other tape nodes that are communicating on another protocol. For example, a tape node transmits data to the mobile device through Bluetooth, and the mobile device (running the client application 722) relays that data to the server 704 via cellular (2G, 3G, 4G, 5G) or Wi-Fi. Further, the client application 722 may cause the mobile device to establish a connection with, and receive pings (e.g., alerts to nearby assets that an environmental profile threshold has been exceeded), from the tape nodes or from the server 704. The tape nodes or server may request services (e.g., to display alert messages within a graphical user interface of the mobile device, relay messages to nearby tape nodes or mobile or stationary gateways, delegate tasks to the mobile device, such as determining the location of the tape node, etc.) from the mobile device. For example, the mobile device running the client application 722 may share location data with the tape node, allowing the tape node to pinpoint its location.

In some examples, the stationary gateway 714 is implemented by a server 704 executing a network service application 706 that is configured by the network service 708 to communicate with a designated set 740 of master tape nodes 742, 744, 746, 748 that are adhered to respective parcels containing respective assets 750, 752, 754, 756 on a pallet 758. In other examples, the stationary gateway 714 is implemented by a secondary or tertiary tape node 760 (e.g., segments 670 or 680, respectively shown in FIGS. 6B and 6C) that is adhered to, for example, a wall, column or other infrastructure component of the physical premise's environment 700, and includes a low-power communications interface for communicating with nodes within range of the stationary gateway 714 and a higher-power communications interface for communicating with the network 702.

In one embodiment, each of the master tape nodes 742-748 is a master tape node and is configured by the network service 708 to communicate individually with the stationary gateway 714, which relays communications from the master tape nodes 742-748 to the network service 708 through the stationary gateway 714 and over the network 702. In another embodiment, one of the master tape nodes 742-748 at a time is configured to transmit, forward, relay, or otherwise communicate wireless messages to, between, or on behalf of the other master nodes on the pallet 758. In this embodiment, the master tape node may be determined by the master tape nodes 742-748 or designated by the network service 708. In some examples, the master tape nodes 742-748 with the longest range or highest remaining power level is determined to be the master tape node. In some examples, when the power level of the current master tape node drops below a certain level (e.g., a fixed power threshold level or a threshold level relative to the power levels of one or more of the other master tape nodes), another one of the master tape nodes assumes the role of the master tape node. In some examples, a master tape node 759 is adhered to the pallet 758 and is configured to perform the role of a master node for the other master tape nodes 742-748. In these ways, the master tape nodes 742-748, 759 are configurable to create different wireless networks of nodes for transmitting, forwarding, relaying, bridging, or otherwise communicating wireless messages with the network service 408 through the stationary gateway 714 and over the network 702 in a power-efficient and cost-effective way.

In the illustrated example, the stationary gateway 714 also is configured by the network service 708 to communicate with a designated network of tape nodes, including the secondary or tertiary tape node 760 that is adhered to the inside of a door 762 of a shipping container 764, and is further configured to communicate with the network service 708 over the network 702. In the illustrated example, the shipping container 764 contains a number of parcels labeled or sealed by respective master tape nodes 766 and containing respective assets. The secondary or tertiary tape node 760 communicates with each of the master tape nodes 766 within the shipping container 764 and communicates with the stationary gateway 714. In some examples, each of the master tape nodes 766 includes a low-power wireless communications-interface (e.g., the low-power wireless-communication interface 652, with reference to FIG. 6A), and the secondary or tertiary tape node 760 includes a low-power wireless-communications interface (low-power wireless-communication interfaces 652′, 652″, with reference to FIGS. 6B-6C) for communicating with the master tape nodes 766 contained within the shipping container 764, and a higher-power wireless-communications interface (e.g., medium-power wireless-communication interface 672′, medium-power wireless-communication interface 672″, high-power wireless-communication interface 682″, with reference to FIGS. 6B-6C) for communicating with the stationary gateway 714. In some examples, either a secondary or tertiary tape node, or both, may be used, depending on whether a high-power wireless-communication interface is necessary for sufficient communication.

In some examples, when the doors of the shipping container 764 are closed, the secondary or tertiary tape node 760 is operable to communicate wirelessly with the master tape nodes 766 contained within the shipping container 764. In some embodiments, both a secondary and a tertiary node are attached to the shipping container 764. Whether a secondary and a tertiary node are used may depend on the range requirements of the wireless-communications interface. For example, if out at sea a node will be required to transmit and receive signals from a server located outside the range of a medium-power wireless-communications interface, a tertiary node will be used because the tertiary node includes a high-power wireless-communications interface.

In an example, the secondary or tertiary tape node 760 is configured to collect sensor data from master tape nodes 766 and, in some embodiments, process the collected data to generate, for example, statistics from the collected data. When the doors of the shipping container 764 are open, the secondary or tertiary tape node 760 is programmed to detect the door opening (e.g., using a photodetector or an accelerometer component of the secondary or tertiary tape node 760) and, in addition to reporting the door opening event to the network service 708, the secondary or tertiary tape node 760 is further programmed to transmit the collected data and/or the processed data in one or more wireless messages to the stationary gateway 714. The stationary gateway 714, in turn, is operable to transmit the wireless messages received from the secondary or tertiary tape node 760 to the network service 708 over the network 702. Alternatively, in some examples, the stationary gateway 714 also is operable to perform operations on the data received from the secondary or tertiary tape node 760 with the same type of data produced by the secondary or tertiary tape node 760 based on sensor data collected from the master tape nodes 742-748. In this way, the secondary or tertiary tape node 760 and master tape node 766 create a wireless network of nodes for transmitting, forwarding, relaying, or otherwise communicating wireless messages to, between, or on behalf of the master tape node 766, the secondary or tertiary tape nodes 760, and the network service 708 in a power-efficient and cost-effective way.

In an example of the embodiment shown in FIG. 7, there are three types of backward compatible tape nodes: a short-range master tape node (e.g., segment 640), a medium-range secondary tape node (e.g., segment 670), and a long-range tertiary tape node (e.g. segment 680), as respectively shown in FIGS. 6A-6C (here, “tape node” is used interchangeably with “agent”, as described with reference to FIGS. 1-6C). The short-range master tape nodes typically are adhered directly to parcels containing assets. In the illustrated example, the master tape nodes 718, 728, 732, 742-748, 766 are short-range tape nodes. The short-range tape nodes typically communicate with a low-power wireless-communication protocol (e.g., Bluetooth LE, Zigbee, or Z-wave). The segment 670 are typically adhered to objects (e.g., a parcel 726 and a shipping container 764) that are associated with multiple parcels that are separated from the medium-range tape nodes by a barrier or a long distance. In the illustrated example, the secondary and/or tertiary tape nodes 724 and 760 are medium-range tape nodes. The medium-range tape nodes typically communicate with low and medium-power wireless-communication protocols (e.g., Bluetooth, LoRa, or Wi-Fi). The segments 680 typically are adhered to mobile or stationary infrastructure of the network communications environment 700.

In the illustrated example, the mobile gateway 712 and the stationary gateway 714 are implemented by, e.g., segment 680. The segments 680 typically communicate with other nodes using a high-power wireless-communication protocol (e.g., a cellular data communication protocol). In some examples, the wireless communications unit 716 (a secondary or tertiary tape node) is adhered to a mobile gateway 712 (e.g., a truck). In these examples, the wireless communications unit 716 may be moved to different locations in the network communications environment 700 to assist in connecting other tape nodes to the wireless communications unit 716. In some examples, the stationary gateway 714 is a tape node that may be attached to a stationary structure (e.g., a wall) in the network communications environment 700 with a known geographic location (e.g., GPS coordinates). In these examples, other tape nodes in the environment may determine their geographic location by querying the stationary gateway 714.

In some examples, in order to conserve power, the tape nodes typically communicate according to a schedule promulgated by the network service 708. The schedule usually dictates all aspects of the communication, including the times when particular tape nodes should communicate, the mode of communication, and the contents of the communication. In one example, the server (not shown) transmits programmatic Global Scheduling Description Language (GSDL) code to the master tape node and each of the secondary and tertiary tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the server 704, either directly or indirectly through a gateway tape node (e.g., the long-range tape node, such as wireless communication unit 716, adhered to the mobile gateway 712, or a long-range tape node, such as stationary gateway 714, that is adhered to an infrastructure component of the network communications environment 700). In other examples, the master tape node processes the information contained in the received data packets and transmits the processed information to the server 704.

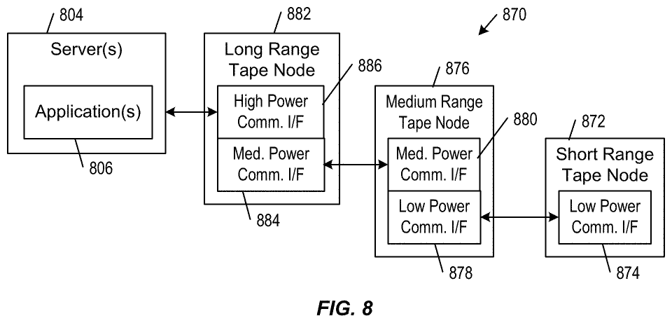

FIG. 8 shows an example hierarchical wireless communications network 870 of tape nodes. In this example, the short-range tape node 872 and the medium range tape node 876 communicate with one another over their respective low power wireless communication interfaces 874, 878. The medium range tape node 876 and the long-range tape node 882 communicate with one another over their respective medium power wireless communication interfaces 880, 884. The long-range tape node 882 and the one or more network service servers 804 (e.g., server(s) 704, FIG. 7) running applications 806 (e.g., application(s) 706, FIG. 7) communicate with one another over the high-power communication interface 884. In some examples, the low power communication interfaces 874, 878 establish wireless communications with one another in accordance with the Bluetooth LE protocol, the medium power communication interfaces 880, 884 establish wireless communications with one another in accordance with the LoRa communications protocol, and the high-power communication interface 886 establishes wireless communications with the one or more network service servers 804 in accordance with a cellular communications protocol.

In some examples, the different types of tape nodes are deployed at different levels in the communications hierarchy according to their respective communications ranges, with the long-range tape nodes generally at the top of the hierarchy, the medium range tape nodes generally in the middle of the hierarchy, and the short-range tape nodes generally at the bottom of the hierarchy. In some examples, the different types of tape nodes are implemented with different feature sets that are associated with component costs and operational costs that vary according to their respective levels in the hierarchy. This allows system administrators flexibility to optimize the deployment of the tape nodes to achieve various objectives, including cost minimization, asset tracking, asset localization, and power conservation.

In some examples, one or more network service servers 804 designates a tape node at a higher level in a hierarchical communications network as a master node of a designated set of tape nodes at a lower level in the hierarchical communications network. For example, the designated master tape node may be adhered to a parcel (e.g., a box, pallet, or shipping container) that contains one or more tape nodes that are adhered to one or more packages containing respective assets. In order to conserve power, the tape nodes typically communicate according to a schedule promulgated by the one or more network service servers 804. The schedule usually dictates all aspects of the communication, including the times when particular tape nodes should communicate, the mode of communication, and the contents of the communication. In one example, the one or more network service servers 804 transmits programmatic Global Scheduling Description Language (GSDL) code to the master tape node and each of the lower-level tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the one or more network service servers 804, either directly or indirectly through a gateway tape node (e.g., the long-range wireless communication unit 716 adhered to the mobile gateway 712 (which could be a vehicle, ship, plane, etc.) or the stationary gateway 714 is a long-range tape node adhered to an infrastructure component of the environment 700). In other examples, the master tape node processes the information contained in the received data packets and transmits the processed information to the one or more network service servers 804/704.

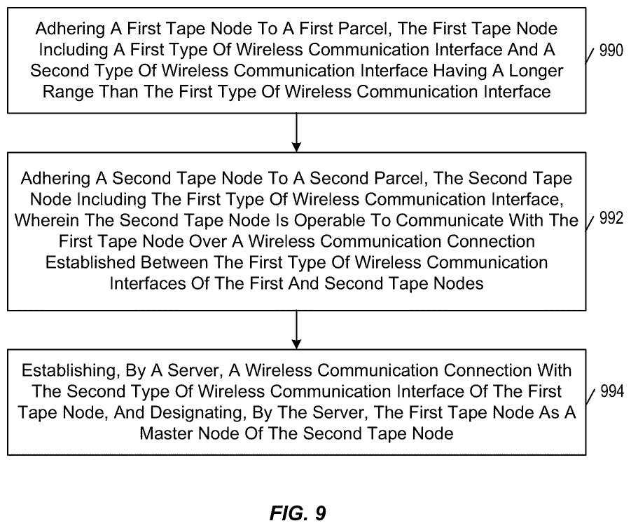

FIG. 9 shows an example method of creating a hierarchical communications network. In accordance with this method, a first tape node is adhered to a first parcel in a set of associated parcels, the first tape node including a first type of wireless communication interface and a second type of wireless communication interface having a longer range than the first type of wireless communication interface (FIG. 9, block 990). A second tape node is adhered to a second parcel in the set, the second tape node including the first type of wireless communication interface, wherein the second tape node is operable to communicate with the first tape node over a wireless communication connection established between the first type of wireless communication interfaces of the first and second tape nodes (FIG. 9, block 992). An application executing on a computer system (e.g., the one or more network service servers 804 of a network service 808) establishes a wireless communication connection with the second type of wireless communication interface of the first tape node, and the application transmits programmatic code executable by the first tape node to function as a master tape node with respect to the second tape node (FIG. 9, block 994).

As used herein, the term “node” refers to both a tape node and a non-tape node unless the node is explicitly designated as a “tape node” or a “non-tape node.” In some embodiments, a non-tape node may have the same or similar communication, sensing, processing and other functionalities and capabilities as the tape nodes described herein, except without being integrated into a tape platform. In some embodiments, non-tape nodes can interact seamlessly with tape nodes. Each node is assigned a respective unique identifier.

Embodiments of the present disclosure further describe a distributed software operating system that is implemented by distributed hardware nodes executing intelligent agent software to perform various tasks or algorithms. In some embodiments, the operating system distributes functionalities (e.g., performing analytics on data or statistics collected or generated by nodes) geographically across multiple intelligent agents that are bound to logistic items (e.g., parcels, containers, packages, boxes, pallets, a loading dock, a door, a light switch, a vehicle such as a delivery truck, a shipping facility, a port, a hub, etc.). In addition, the operating system dynamically allocates the hierarchical roles (e.g., master and slave roles) that nodes perform over time in order to improve system performance, such as optimizing battery life across nodes, improving responsiveness, and achieving overall objectives. In some embodiments, optimization is achieved using a simulation environment for optimizing key performance indicators (PKIs).

In some embodiments, the nodes are programmed to operate individually or collectively as autonomous intelligent agents. In some embodiments, nodes are configured to communicate and coordinate actions and respond to events. In some embodiments, a node is characterized by its identity, its mission, and the services that it can provide to other nodes. A node's identity is defined by its capabilities (e.g., battery life, sensing capabilities, and communications interfaces). A node may be defined by the respective program code, instructions, or directives it receives from another node (e.g., a server or a master node) and the actions or tasks that it performs in accordance with that program code, instructions, or directives (e.g., sense temperature every hour and send temperature data to a master node to upload to a server). A node's services may be defined by the functions or tasks that it is permitted to perform for other nodes (e.g., retrieve temperature data from a peripheral node and send the received temperature data to the server). At least for certain tasks, once programmed and configured with their identities, missions, and services, nodes can communicate with one another and request services from and provide services to one another independently of the server.

Thus, in accordance with the runtime operating system every agent knows its objectives (programmed). Every agent knows which capabilities/resources it needs to fulfill objective. Every agent communicates with every other node in proximity to see if it can offer the capability. Examples include communicate data to the server, authorize going to lower-power level, temperature reading, send an alert to local hub, send location data, triangulate location, any boxes in same group that already completed group objectives.

Nodes can be associated with logistic items. Examples of a logistic item includes, for example, a package, a box, pallet, a container, a truck or other conveyance, infrastructure such as a door, a conveyor belt, a light switch, a road, or any other thing that can be tracked, monitored, sensed, etc. or that can transmit data concerning its state or environment. In some examples, a server or a master node may associate the unique node identifiers with the logistic items.

Communication paths between tape and/or non-tape nodes may be represented by a graph of edges between the corresponding logistic items (e.g., a storage unit, truck, or hub). In some embodiments, each node in the graph has a unique identifier. A set of connected edges between nodes is represented by a sequence of the node identifiers that defines a communication path between a set of nodes.

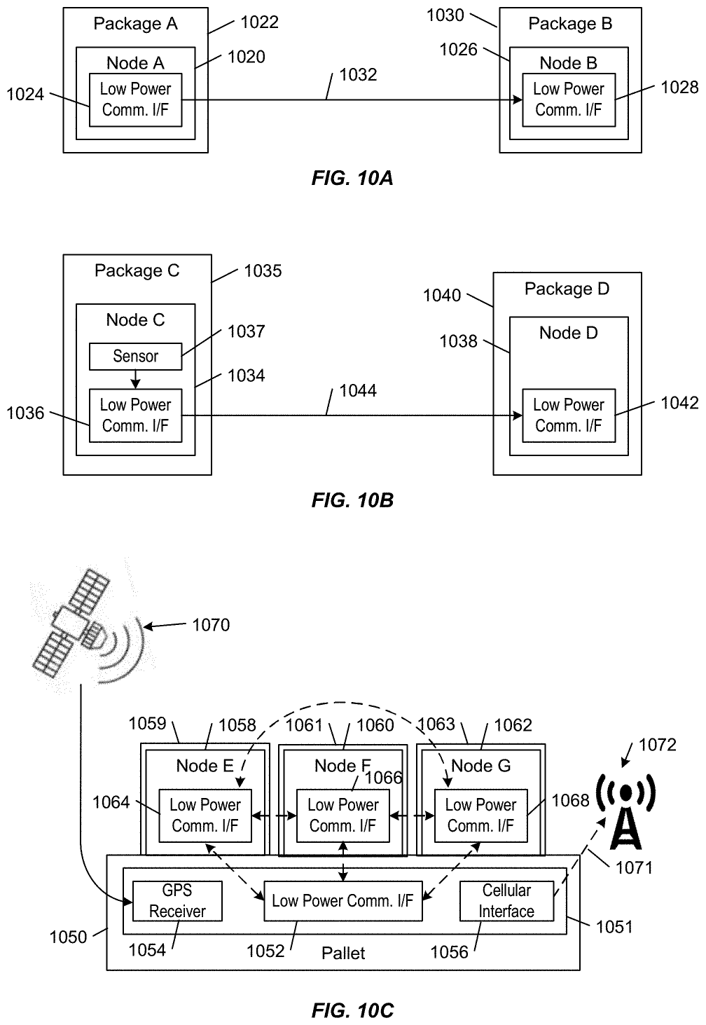

Referring to FIG. 10A, a node 1020 (Node A) is associated with a package 1022 (Package A). In some embodiments, the node 1020 may be implemented as a tape node that is used to seal the package 1022 or it may be implemented as a label node that is used to label the package 1022; alternatively, the node 1020 may be implemented as a non-tape node that is inserted within the package 1022 or embedded in or otherwise attached to the interior or exterior of the package 1022. In the illustrated embodiment, the node 1020 includes a low power communications interface 1024 (e.g., a Bluetooth Low Energy communications interface). Another node 1026 (Node B), which is associated with another package 1030 (Package B), is similarly equipped with a compatible low power communications interface 1028 (e.g., a Bluetooth Low Energy communications interface).

In an example scenario, in accordance with the programmatic code stored in its memory, node 1026 (Node B) requires a connection to node 1020 (Node A) to perform a task that involves checking the battery life of Node A. Initially, Node B is unconnected to any other nodes. In accordance with the programmatic code stored in its memory, Node B periodically broadcasts advertising packets into the surrounding area. When the other node 1020 (Node A) is within range of Node B and is operating in a listening mode, Node A will extract the address of Node B and potentially other information (e.g., security information) from an advertising packet. If, according to its programmatic code, Node A determines that it is authorized to connect to Node B, Node A will attempt to pair with Node B. In this process, Node A and Node B determine each other's identities, capabilities, and services. For example, after successfully establishing a communication path 1032 with Node A (e.g., a Bluetooth Low Energy formatted communication path), Node B determines Node A's identity information (e.g., master node), Node A's capabilities include reporting its current battery life, and Node A's services include transmitting its current battery life to other nodes. In response to a request from Node B, Node A transmits an indication of its current battery life to Node B.

Referring to FIG. 10B, a node 1034 (Node C) is associated with a package 1035 (Package C). In the illustrated embodiment, the Node C includes a low power communications interface 1036 (e.g., a Bluetooth Low Energy communications interface), and a sensor 1037 (e.g., a temperature sensor). Another node 1038 (Node D), which is associated with another package 1040 (Package D), is similarly equipped with a compatible low power communications interface 1042 (e.g., a Bluetooth Low-Energy communications interface).

In an example scenario, in accordance with the programmatic code stored in its memory, Node D requires a connection to Node C to perform a task that involves checking the temperature in the vicinity of Node C. Initially, Node D is unconnected to any other nodes. In accordance with the programmatic code stored in its memory, Node D periodically broadcasts advertising packets in the surrounding area. When Node C is within range of Node D and is operating in a listening mode, Node C will extract the address of Node D and potentially other information (e.g., security information) from the advertising packet. If, according to its programmatic code, Node C determines that it is authorized to connect to Node D, Node C will attempt to pair with Node D. In this process, Node C and Node D determine each other's identities, capabilities, and services. For example, after successfully establishing a communication path 1044 with Node C (e.g., a Bluetooth Low Energy formatted communication path), Node D determines Node C's identity information (e.g., a peripheral node), Node C's capabilities include retrieving temperature data, and Node C's services include transmitting temperature data to other nodes. In response to a request from Node D, Node C transmits its measured and/or locally processed temperature data to Node D.

Referring to FIG. 10C, a pallet 1050 is associated with a master node 1051 that includes a low-power communications interface 1052, a GPS receiver 1054, and a cellular communications interface 1056. In some embodiments, the master node 1051 may be implemented as a tape node or a label node that is adhered to the pallet 1050. In other embodiments, the master node 1051 may be implemented as a non-tape node that is inserted within the body of the pallet 1050 or embedded in or otherwise attached to the interior or exterior of the pallet 1050.

The pallet 1050 provides a structure for grouping and containing packages 1059, 1061, 1063 each of which is associated with a respective peripheral node 1058, 1060, 1062 (Node E, Node F, and Node G). Each of the peripheral nodes 1058, 1060, 1062 includes a respective low power communications interface 1064, 1066, 1068 (e.g., Bluetooth Low Energy communications interface). In the illustrated embodiment, each of the nodes E, F, G, and the master node 1051 are connected to each of the other nodes over a respective low power communications path (shown by dashed lines).

In some embodiments, the packages 1059, 1061, 1063 are grouped together because they are related. For example, the packages 1059, 1061, 1063 may share the same shipping itinerary or a portion thereof. In an example scenario, the master pallet node 1051 scans for advertising packets that are broadcasted from the peripheral nodes 1058, 1060, 1062. In some examples, the peripheral nodes broadcast advertising packets during respective scheduled broadcast intervals. The master node 1051 can determine the presence of the packages 1059, 1061, 1063 in the vicinity of the pallet 1050 based on receipt of one or more advertising packets from each of the nodes E, F, and G. In some embodiments, in response to receipt of advertising packets broadcasted by the peripheral nodes 1058, 1060, 1062, the master node 1051 transmits respective requests to the server to associate the master node 1051 and the respective peripheral nodes 1058, 1060, 1062. In some examples, the master tape node requests authorization from the server to associate the master tape node and the peripheral tape nodes. If the corresponding packages 1059, 1061, 1063 are intended to be grouped together (e.g., they share the same itinerary or certain segments of the same itinerary), the server authorizes the master node 1051 to associate the peripheral nodes 1058, 1060, 1062 with one another as a grouped set of packages. In some embodiments, the server registers the master node and peripheral tape node identifiers with a group identifier. The server also may associate each node ID with a respective physical label ID that is affixed to the respective package.

In some embodiments, after an initial set of packages is assigned to a multi package group, the master node 1051 may identify another package arrives in the vicinity of the multi-package group. The master node may request authorization from the server to associate the other package with the existing multi-package group. If the server determines that the other package is intended to ship with the multi-package group, the server instructs the master node to merge one or more other packages with currently grouped set of packages. After all packages are grouped together, the server authorizes the multi-package group to ship. In some embodiments, this process may involve releasing the multi-package group from a containment area (e.g., customs holding area) in a shipment facility.

In some embodiments, the peripheral nodes 1058, 1060, 1062 include environmental sensors for obtaining information regarding environmental conditions in the vicinity of the associated packages 1059, 1061, 1063. Examples of such environmental sensors include temperature sensors, humidity sensors, acceleration sensors, vibration sensors, shock sensors, pressure sensors, altitude sensors, light sensors, and orientation sensors.

In the illustrated embodiment, the master node 1051 can determine its own location based on geolocation data transmitted by a satellite-based radio navigation system 1070 (e.g., GPS, GLONASS, and NAVSTAR) and received by the GPS receiver 1054 component of the master node 1051. In an alternative embodiment, the location of the master pallet node 1051 can be determined using cellular based navigation techniques that use mobile communication technologies (e.g., GSM, GPRS, CDMA, etc.) to implement one or more cell-based localization techniques. After the master node 1051 has ascertained its location, the distance of each of the packages 1059, 1061, 1063 from the master node 1051 can be estimated based on the average signal strength of the advertising packets that the master node 1051 receives from the respective peripheral node. The master node 1051 can then transmit its own location and the locations of the package nodes E, F, and G to a server over a cellular interface connection with a cellular network 1072. Other methods of determining the distance of each of the packages 1059, 1061, 1063 from the master node 1051, such as Received Signal-Strength Index (RSSI) based indoor localization techniques, also may be used.

In some embodiments, after determining its own location and the locations of the peripheral nodes, the master node 1051 reports the location data and the collected and optionally processed (e.g., either by the peripheral nodes peripheral nodes 1058, 1060, 1062 or the master node 1051) sensor data to a server over a cellular communication path 1071 on a cellular network 1072.

In some examples, nodes are able to autonomously detect logistics execution errors if packages that are supposed to travel together no longer travel together and raise an alert. For example, a node (e.g., the master node 1051 or one of the peripheral nodes 1058, 1060, 1062) alerts the server when the node determines that a particular package 1059 is being or has already been improperly separated from the group of packages. The node may determine that there has been an improper separation of the particular package 1059 in a variety of ways. For example, the associated peripheral node 1058 that is bound to the particular package 1059 may include an accelerometer that generates a signal in response to movement of the package from the pallet. In accordance with its intelligent agent program code, the associated peripheral node 1058 determines that the master node 1051 has not disassociated the particular package 1059 from the group and therefore broadcasts advertising packets to the master node, which causes the master node 1051 to monitor the average signal strength of the advertising packets and, if the master node 1051 determines that the signal strength is decreasing over time, the master node 1051 will issue an alert either locally (e.g., through a speaker component of the master node 1051) or to the server.

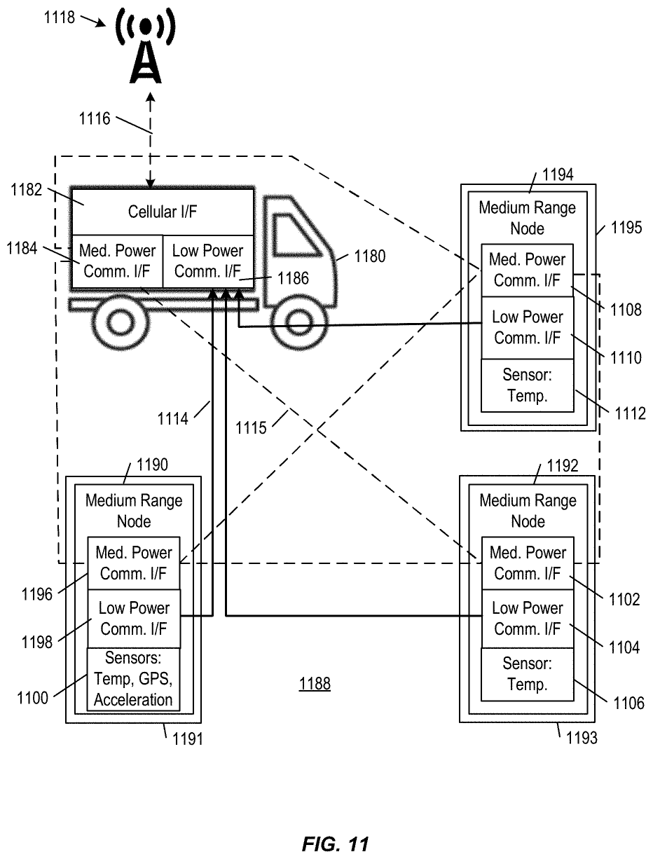

Referring to FIG. 11, a truck 1180 is configured as a mobile node or mobile hub that includes a cellular communications interface 1182, a medium-power communications interface 1184, and a low power communications interface 1186. The communications interfaces 1180-1186 may be implemented on one or more tape and non-tape nodes. In an illustrative scenario, the truck 1180 visits a logistic storage facility, such as a warehouse 1188, to wirelessly obtain temperature data generated by temperature sensors in the medium range nodes 1190, 1192, 1194. The warehouse 1188 contains nodes 1190, 1192, and 1194 that are associated with respective logistic containers 1191, 1193, 1195. In the illustrated embodiment, each node 1190-1194 is a medium range node that includes a respective medium power communications interface 1196, 1102, 1108, a respective low power communications interface 1198, 1104, 1110 and one or more respective sensors 1100, 1106, 1112. In the illustrated embodiment, each of the package nodes 1190, 1192, 1194 and the truck 1180 is connected to each of the other ones of the package nodes through a respective medium power communications path (shown by dashed lines). In some embodiments, the medium power communications paths are LoRa formatted communication paths.

In some embodiments, the communications interfaces 1184 and 1186 (e.g., a LoRa communications interface and a Bluetooth Low Energy communications interface) on the node on the truck 1180 is programmed to broadcast advertisement packets to establish connections with other network nodes within range of the truck node. A warehouse 1188 includes medium range nodes 1190, 1192, 1194 that are associated with respective logistic containers 1191, 1193, 1195 (e.g., packages, boxes, pallets, and the like). When the truck node's low power interface 1186 is within range of any of the medium range nodes 1190, 1192, 1194 and one or more of the medium range nodes is operating in a listening mode, the medium range node will extract the address of truck node and potentially other information (e.g., security information) from the advertising packet. If, according to its programmatic code, the truck node determines that it is authorized to connect to one of the medium range nodes 1190, 1192, 1194, the truck node will attempt to pair with the medium range node. In this process, the truck node and the medium range node determine each other's identities, capabilities, and services. For example, after successfully establishing a communication path with the truck node (e.g., a Bluetooth Low Energy formatted communication path 1114 or a LoRa formatted communication path 1117), the truck node determines the identity information for the medium range node 1190 (e.g., a peripheral node), the medium range node's capabilities include retrieving temperature data, and the medium range node's services include transmitting temperature data to other nodes. Depending of the size of the warehouse 1188, the truck 1180 initially may communicate with the nodes 1190, 1192, 1194 using a low power communications interface (e.g., Bluetooth Low Energy interface). If any of the anticipated nodes fails to respond to repeated broadcasts of advertising packets by the truck 1180, the truck 1180 will try to communicate with the non-responsive nodes using a medium power communications interface (e.g., LoRa interface). In response to a request from the medium-power communication interface 1184, the medium range node 1190 transmits an indication of its measured temperature data to the truck node. The truck node repeats the process for each of the other medium range nodes 1192, 1194 that generate temperature measurement data in the warehouse 1188. The truck node reports the collected (and optionally processed, either by the medium range nodes 1190, 1192, 1194 or the truck node) temperature data to a server over a cellular communication path 1116 with a cellular network 1118.

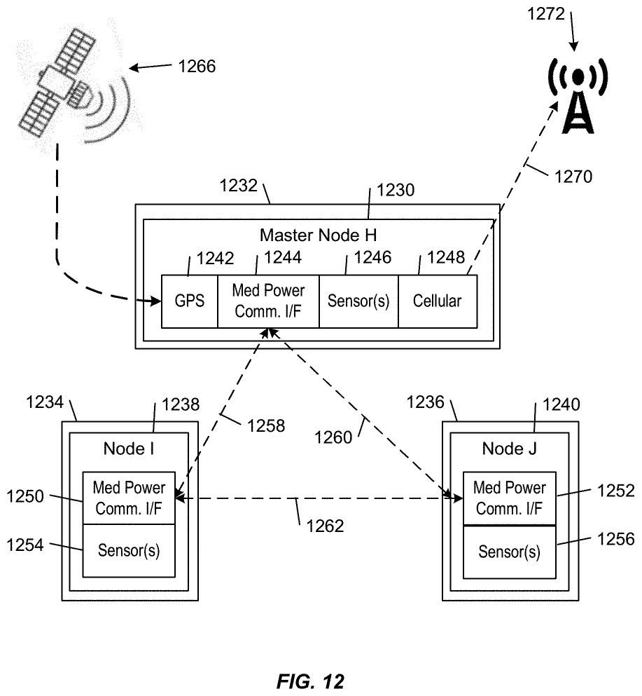

Referring to FIG. 12, a master node 1230 is associated with a logistic item 1232 (e.g., a package) and grouped together with other logistic items 1234, 1236 (e.g., packages) that are associated with respective peripheral nodes 1238, 1240. The master node 1230 includes a GPS receiver 1242, a medium power communications interface 1244, one or more sensors 1246, and a cellular communications interface 1248. Each of the peripheral nodes 1238, 1240 includes a respective medium power communications interface 1250, 1252 and one or more respective sensors 1254, 1256. In the illustrated embodiment, the peripheral and master nodes are connected to one another other over respective pairwise communications paths (shown by dashed lines). In some embodiments, the nodes 1230, 1238, 1240 communicate through respective LoRa communications interfaces over LoRa formatted communications paths 1258, 1260, 1262.

In the illustrated embodiment, the master and peripheral nodes 1230, 1238, 1240 include environmental sensors for obtaining information regarding environmental conditions in the vicinity of the associated logistic items 1232, 1234, 1236. Examples of such environmental sensors include temperature sensors, humidity sensors, acceleration sensors, vibration sensors, shock sensors, pressure sensors, altitude sensors, light sensors, and orientation sensors.

In accordance with the programmatic code stored in its memory, the master node 1230 periodically broadcasts advertising packets in the surrounding area. When the peripheral nodes 1238, 1240 are within range of master node 1230, and are operating in a listening mode, the peripheral nodes 1238, 1240 will extract the address of master node 1230 and potentially other information (e.g., security information) from the advertising packets. If, according to their respective programmatic code, the peripheral nodes 1238, 1240 determine that they are authorized to connect to the master node 1230, the peripheral nodes 1238, 1240 will attempt to pair with the master node 1230. In this process, the peripheral nodes 1238, 1240 and the master node 1230 determine each other's identities, capabilities, and services. For example, after successfully establishing a respective communication path 1258, 1260 with each of the peripheral nodes 1238, 1240 (e.g., a LoRa formatted communication path), the master node 1230 determines certain information about the peripheral nodes 1238, 1240, such as their identity information (e.g., peripheral nodes), their capabilities (e.g., measuring temperature data), and their services include transmitting temperature data to other nodes.

After establishing LoRa formatted communications paths 1258, 1260 with the peripheral nodes 1238, 1240, the master node 1230 transmits requests for the peripheral nodes 1238, 1240 to transmit their measured and/or locally processed temperature data to the master node 1230.

In the illustrated embodiment, the master node 1230 can determine its own location based on geolocation data transmitted by a satellite-based radio navigation system 1266 (e.g., GPS, GLONASS, and NAVSTAR) and received by the GPS receiver 1242 component of the master node 1230. In an alternative embodiment, the location of the master node 1230 can be determined using cellular based navigation techniques that use mobile communication technologies (e.g., GSM, GPRS, CDMA, etc.) to implement one or more cell-based localization techniques. After the master node 1230 has ascertained its location, the distance of each of the logistic items 1234, 1236 from the master node 1230 can be estimated based on the average signal strength of the advertising packets that the master node 1230 receives from the respective peripheral node. The master node 1230 can then transmit its own location and the locations of the package nodes H, J, and I to a server over a cellular interface connection with a cellular network 1272. Other methods of determining the distance of each of the logistic items 1234, 1236 from the master node 1230, such as Received Signal-Strength Index (RSSI) based indoor localization techniques, also may be used.

In some embodiments, after determining its own location and the locations of the peripheral nodes, the master node 1230 reports the location data, the collected and optionally processed (e.g., either by the peripheral nodes peripheral nodes 1238, 1240 or the master node 1230) sensor data to a server over a cellular communication path 1270 on a cellular network 1272.

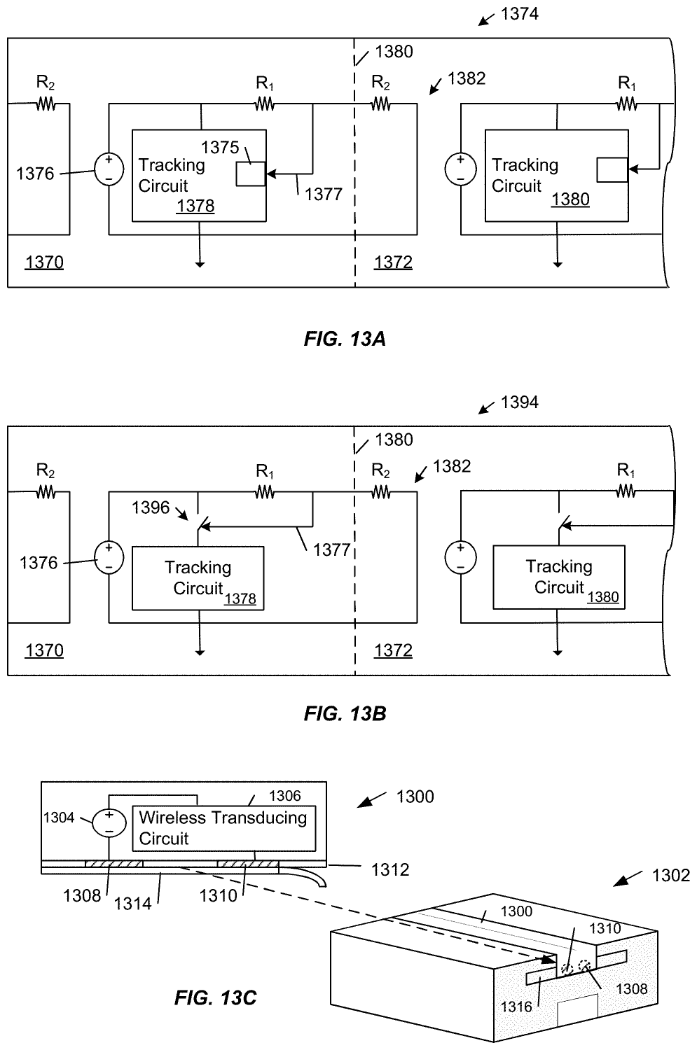

Referring to FIG. 13A, in some examples, each of one or more of the segments 1370, 1372 of a tracking adhesive product 1374 includes a respective circuit 1375 that delivers power from the respective energy source 1376 to the respective tracking circuit 1378 (e.g., a processor and one or more wireless communications circuits) in response to an event. In some of these examples, the wake circuit 1375 is configured to transition from an off-state to an on-state when the voltage on the wake node 1377 exceeds a threshold level, at which point the wake circuit transitions to an on-state to power-on the segment 1370. In the illustrated example, this occurs when the user separates the segment from the tracking adhesive product 1374, for example, by cutting across the tracking adhesive product 1374 at a designated location (e.g., along a designated cut-line 1380). In particular, in its initial, un-cut state, a minimal amount of current flows through the resistors R1 and R2. As a result, the voltage on the wake node 1377 remains below the threshold turn-on level. After the user cuts across the tracking adhesive product 1374 along the designated cut-line 1380, the user creates an open circuit in the loop 1382, which pulls the voltage of the wake node above the threshold level and turns on the wake circuit 1375. As a result, the voltage across the energy source 1376 will appear across the tracking circuit 1378 and, thereby, turn on the segment 1370. In particular embodiments, the resistance value of resistor R1 is greater than the resistance value of R2. In some examples, the resistance values of resistors R1 and R2 are selected based on the overall design of the adhesive product system (e.g., the target wake voltage level and a target leakage current).

In some examples, each of one or more of the segments of a tracking adhesive product includes a respective sensor and a respective wake circuit that delivers power from the respective energy source to the respective one or more components of the respective tracking circuit 1378 in response to an output of the sensor. In some examples, the respective sensor is a strain sensor that produces a wake signal based on a change in strain in the respective segment. In some of these examples, the strain sensor is affixed to a tracking adhesive product and configured to detect the stretching of the tracking adhesive product segment as the segment is being peeled off a roll or a sheet of the tracking adhesive product. In some examples, the respective sensor is a capacitive sensor that produces a wake signal based on a change in capacitance in the respective segment. In some of these examples, the capacitive sensor is affixed to a tracking adhesive product and configured to detect the separation of the tracking adhesive product segment from a roll or a sheet of the tracking adhesive product. In some examples, the respective sensor is a flex sensor that produces a wake signal based on a change in curvature in the respective segment. In some of these examples, the flex sensor is affixed to a tracking adhesive product and configured to detect bending of the tracking adhesive product segment as the segment is being peeled off a roll or a sheet of the tracking adhesive product. In some examples, the respective sensor is a near field communications sensor that produces a wake signal based on a change in inductance in the respective segment.

FIG. 13B shows another example of a tracking adhesive product 1394 that delivers power from the respective energy source 1376 to the respective tracking circuit 1378 (e.g., a processor and one or more wireless communications circuits) in response to an event. This example is similar in structure and operation as the tracking adhesive product 1394 shown in FIG. 13A, except that the wake circuit 1375 is replaced by a switch 1396 that is configured to transition from an open state to a closed state when the voltage on the switch node 1377 exceeds a threshold level. In the initial state of the tracking adhesive product 1394, the voltage on the switch node is below the threshold level as a result of the low current level flowing through the resistors R1 and R2. After the user cuts across the tracking adhesive product 1394 along the designated cut-line 1380, the user creates an open circuit in the loop 1382, which pulls up the voltage on the switch node above the threshold level to close the switch 1396 and turn on the tracking circuit 1378.

A wireless sensing system includes a plurality of wireless nodes configured to detect tampering in assets. Tampering may include, but is not limited to, opening assets such as boxes, containers, storage, or doors, moving the asset without authorization, moving the asset to an unintended location, moving the asset in an unintended way, damaging the asset, shaking the asset in an unintended way, orienting an asset in a way that it is not meant to be oriented. In many cases, these actions may compromise the integrity or safety of assets. Wireless nodes associated with the asset are configured to detect a tampering event. In an embodiment, a tampering event is associated with an action, a time, and a location. In an embodiment, the wireless nodes communicate the tampering event to the wireless sensing system. The wireless sensing system is configured to provide a notification or alert to a user of the wireless sensing system. In some embodiments, a wireless node may directly transmit the notification or alert to the user. In other embodiments, a wireless node may include a display that indicates whether or not a tampering event has occurred (e.g., the display may be an indicator light or LED).

Alerts may be transmitted to server/cloud, other wireless nodes, a client device, or some combination thereof. For example, in an embodiment, a wireless node of the wireless sensing system captures sensor data, detects a tampering event, and transmits an alarm to a user of the wireless sensing system (e.g., without communicating with a server or cloud of the wireless sensing system). In another embodiment, a wireless node of the wireless sensing system captures sensor data and transmits the sensor data to a gateway, parent node (e.g., black tape), or client device. The gateway, parent node, or client device detects a tampering event based on the received sensor data and transmits an alarm to a user of the wireless sensing system. In another embodiment, the wireless node of the wireless sensing system captures sensor data, detects a tampering event, and transmits information describing the tampering event to a server or cloud of the wireless sensing system. The server or cloud of the wireless sensing system transmits an alarm to a user of the wireless sensing system.

FIG. 13C shows a diagrammatic cross-sectional front view of an example adhesive tape platform 1300 and a perspective view of an example asset 1302. Instead of activating the adhesive tape platform in response to separating a segment of the adhesive tape platform from a roll or a sheet of the adhesive tape platform, this example is configured to supply power from the energy source 1304 to turn on the wireless transducing circuit 1306 in response to establishing an electrical connection between two power terminals 1308, 1310 that are integrated into the adhesive tape platform. In particular, each segment of the adhesive tape platform 1300 includes a respective set of embedded tracking components, an adhesive layer 1312, and an optional backing sheet 1314 with a release coating that prevents the segments from adhering strongly to the backing sheet 1314. In some examples, the power terminals 1308, 1310 are composed of an electrically conductive material (e.g., a metal, such as copper) that may be printed or otherwise patterned and/or deposited on the backside of the adhesive tape platform 1300. In operation, the adhesive tape platform can be activated by removing the backing sheet 1314 and applying the exposed adhesive layer 1312 to a surface that includes an electrically conductive region 1316. In the illustrated embodiment, the electrically conductive region 1316 is disposed on a portion of the asset 1302. When the adhesive backside of the adhesive tape platform 1300 is adhered to the asset with the exposed terminals 1308, 1310 aligned and in contact with the electrically conductive region 1316 on the asset 1302, an electrical connection is created through the electrically conductive region 1316 between the exposed terminals 1308, 1310 that completes the circuit and turns on the wireless transducing circuit 1306. In particular embodiments, the power terminals 1308, 1310 are electrically connected to any respective nodes of the wireless transducing circuit 1306 that would result in the activation of the tracking circuit 1306 in response to the creation of an electrical connection between the power terminals 1308, 1310.

In some examples, after a tape node is turned on, it will communicate with the network service to confirm that the user/operator who is associated with the tape node is an authorized user who has authenticated himself or herself to the network service. In these examples, if the tape node cannot confirm that the user/operator is an authorized user, the tape node will turn itself off.

Detecting and Tracking Assets in a Vehicle

Embodiments of tape nodes of the adhesive tape platform may include RFID tags or RFID components integrated into the tape node. Tape nodes with integrated RFID components and the manufacturing of the tape nodes thereof is discussed in further detail in U.S. patent application Ser. No. 16/953,238, filed Nov. 19, 2020, U.S. patent application Ser. No. 16/839,048, filed on Apr. 2, 2020, and U.S. patent application Ser. No. 17/067,608, filed on Oct. 9, 2020, all of which are incorporated by reference herein in their entirety.

The tape nodes with RFID capabilities described above (referred to herein as “RFID tape nodes”) may be attached to, stored with, stored alongside, and/or otherwise coupled to assets that are tracked in the tracking system 700 of FIG. 7. The RFID tape nodes may be positioned at known locations and may communicate with an RFID reader system(s) in environments with a known location for identifying the asset and determining the asset's location. The RFID reader system(s) are associated with the tracking system 700 and communicate with server(s) of the tracking system 700 to update a database of the tracking system 700 on the location of the assets.

The “RFID tape nodes” may include varying functionality depending on the application. In one example of “RFID tape node”, the RFID tape node is an “RFID reader node” that may read passive or active RFID tags (or other RFID tape nodes) attached to assets. The RFID reader node may act as an infrastructure node, in that it is permanently (or semi-permanently) placed in a set location within the environment. In embodiments, the RFID reader node may be a “RFID illumination node” in which it only operates to illuminate a given area with an RFID illumination signal (also referred to as an interrogation signal herein), but the response thereto (e.g., RFID response signal) is captured by another device and sent to the RFID illumination node via a non-RFID-based communication channel, or sent to another external device. The RFID reader node embodiments of the RFID tape nodes may receive RFID response signal information about one or more RFID tags (or RFID tape nodes) attached to the assets and analyze said RFID response signal information according to one or more mission objectives. In one example, the one or more mission objectives includes transmitting the RFID response signal information to another device, such as a gateway over Bluetooth® or other wireless channel (Wi-Fi, LoRa, Cellular, etc.).

Thus, the term “illumination” or “illumination signal” indicates a signal, such as an RFID-based signal, generated by a device, such as the “RFID illumination node” or another RFID antenna (e.g., antennas 1420, 1430, 1440 or slot antennas 2006, 2110 discussed below) that causes another RFID device (e.g., RFID tags 1490, and/or reference RFID readers 2402 discussed below) to generate a response signal to the illumination. The illumination or illumination signal may be a generically broadcast signal that triggers any responding tags to respond, or it may be encoded such that only one or more select responding tags are triggered based on the encoding. The features associated with illuminator 1420 and illumination signal 1421 discussed in U.S. Patent Publication No. 2023/0024103, entitled “Multi-communication-interface system for fine locationing”, and filed Sep. 12, 2022, may apply to the RFID illumination signal, RFID interrogation signals, and devices that generate said RFID illumination signal or RFID interrogation signals herein. As such, U.S. Patent Publication No. 2023/0024103 is incorporated by reference herein to the extent that the illumination and response discussed therein applies to illumination and interrogation signals discussed herein.

In another example of “RFID tape node”, the RFID tape node is a “tape” or “flexible” form factor that adheres to an asset/package. The form factor may be a flexible or semi-flexible device. The RFID tape node may include a QR code for associating the RFID tape node with a given asset, wherein said association is stored in memory of another device (e.g., another RFID tape node, an RFID reader device, or an external server such as server 704 discussed above with respect to FIG. 7. The RFID tape node may be reprogrammable with read and write functionality for additional features, including changing the data the RFID tape node transmits to an RFID reader or other external device.

In another example of “RFID tape node”, the RFID tape node has an RFID tag inlay that is passive or active. The RFID tag inlay operates to respond to RFID interrogation signals and transmit an RFID response signal which is read by another device, which may be the device generating the RFID interrogation signal, or another device such as another RFID reader and/or another RFID tape node.

The above examples of RFID tape node are non-limiting. Any of the above-discussed features of “nodes” (such as features discussed with respect to “tape nodes”, “nodes”, “tape platforms”, or the like discussed above with respect to FIGS. 1-13) may be implemented in one or more RFID tape nodes, and any combination of types of RFID tape nodes may be implemented for a given environment (e.g., within a given vehicle as discussed below, or within a given monitoring area such as distribution center or warehouse.

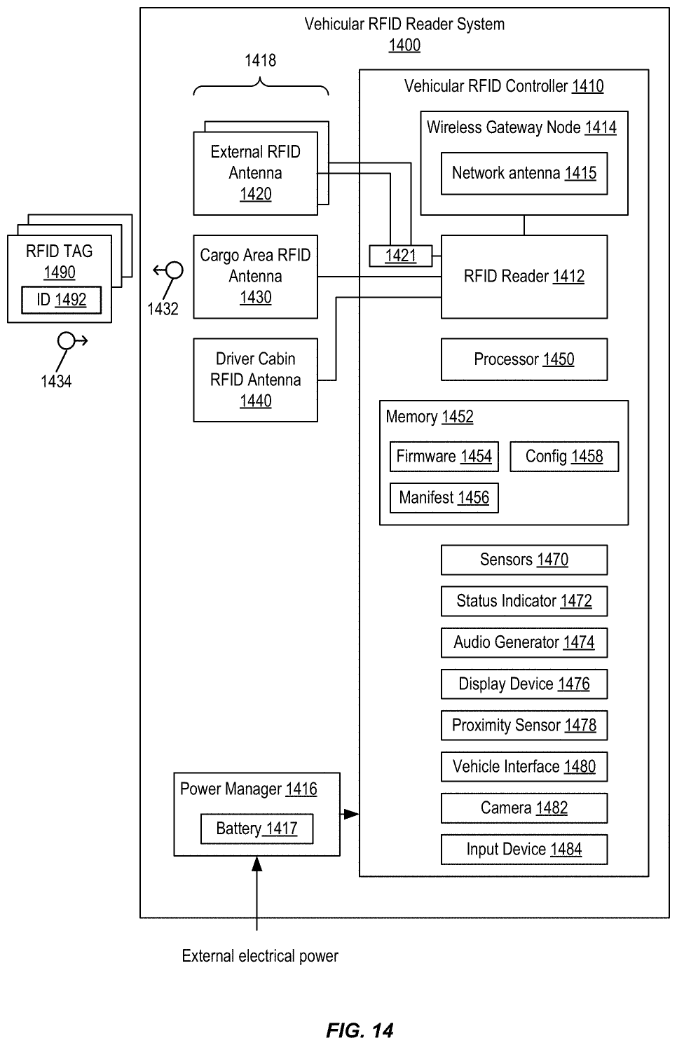

FIG. 14 is a block diagram illustrating one example RFID reader system 1400 configured for use in a vehicle, in embodiments. RFID reader system 1400 includes an RFID reader 1412 (which may be an RFID reader tape node, or a non-tape node embodiment) coupled to an RFID antenna array 1418 and a wireless gateway node 1414 (see also mobile gateway 712 in FIG. 7) that includes at least one network antenna 1415 and provides wireless communication with tracking system 700 and/or components thereof. Network antenna 1415 represents one or more antennas configured for communication using protocols selected from the group including LoRa, BLE, Wi-Fi, and satellite communication.

In the example of FIG. 14, RFID antenna array 1418 includes at least one external RFID antenna 1420, at least one cargo area RFID antenna 1430, and at least one driver cabin RFID antenna 1440. However, RFID antenna array 1418 may have more or fewer RFID antennas 1430 without departing from the scope hereof. For example, one or both of external RFID antenna 1420 and driver cabin RFID antenna 1440 may be omitted in certain embodiments. The RFID antennas 1430 are shown with a read area (“Field of View”) as indicated by the dashed lines extending downward from the RFID antennas 1430. The read area is not constrained to the angle shown, and may be manipulated to configure the beam shape to fit the desired monitored area (e.g., within the cargo area 1504). Similar read areas may be used for other RFID antennas herein (e.g., external RFID antennas 1420 and/or cabin RFID antennas 1440), and the read areas may be directed at other directions other than downward depending on position and intended monitoring area of the given RFID antenna.

RFID reader 1412 and wireless gateway node 1414 may be incorporated into the same physical housing, referred to herein as an RFID controller 1410. However, in other embodiments, one or both of RFID reader 1412 and wireless gateway node 1414 are external to RFID controller 1410. RFID controller 1410 may also implement a computer (e.g., a digital processor 1450 with memory 1452 storing firmware 1454 having machine readable instructions executable by processor 1450 to implement functionality of RFID reader system 1400) and/or other devices and controls RFID antennas 1420, 1430, 1440, and RFID reader 1412 to detect and read data from RFID return signals received via the RFID antennas. Processor 1450 and memory 1452 may represent parts of RFID reader 1412 or wireless gateway node 1414 without departing from the scope hereof. The Processor 1450 and memory 1452 may be the same computing elements of the RFID reader 1412, in that they directly control the RFID reader 1412 and also implement data analysis on data transmitted to or from the RFID reader 1412 and/or other components within the controller 1410.

In certain embodiments, RFID antennas 1420, 1430, and 1440 each operate to both transmit an RFID interrogation signal 1432 (e.g., an electromagnetic interrogation pulse) and receive RFID response signals 1434 from RFID tags 1490 within range. In other embodiments, one RFID antenna 1430 operates to transmit the RFID interrogation signal 1432, and other RFID antennas 1420, 1430, and 1440 operate to receive any RFID response signals 1434.

The RFID antenna(s) 1430 collectively have field of view that includes locations where assets enter and/or are loaded into a cargo area of a vehicle for example. The type and configuration of the RFID antenna 1430 may vary based on the number of RFID antennas 1430 included in the system. For example, in one embodiment where a single RFID antenna 1430 is used, a patch antenna may be implemented to increase the spatial coverage of the FOV of the antenna to allow for more coverage in the cargo area. Non-patch RFID antennas may be implemented in multi-RFID antenna 1430 embodiments, or where a single RFID antenna 1430 is monitoring a smaller cargo area and a patch antenna is not needed to provide adequate spatial coverage. Multi-RFID antenna 1430 embodiments may include combination of patch and non-patch antennas.

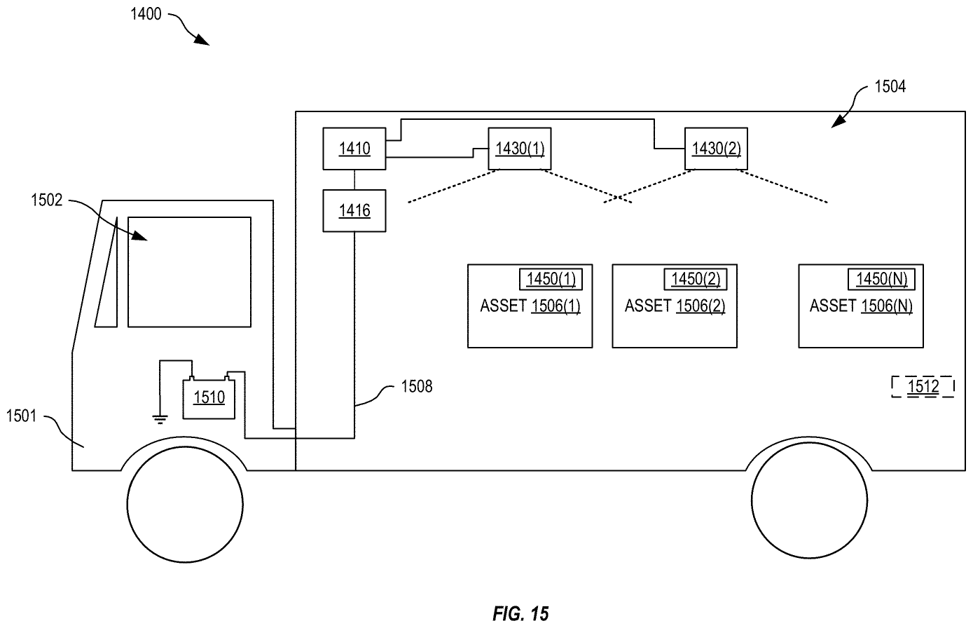

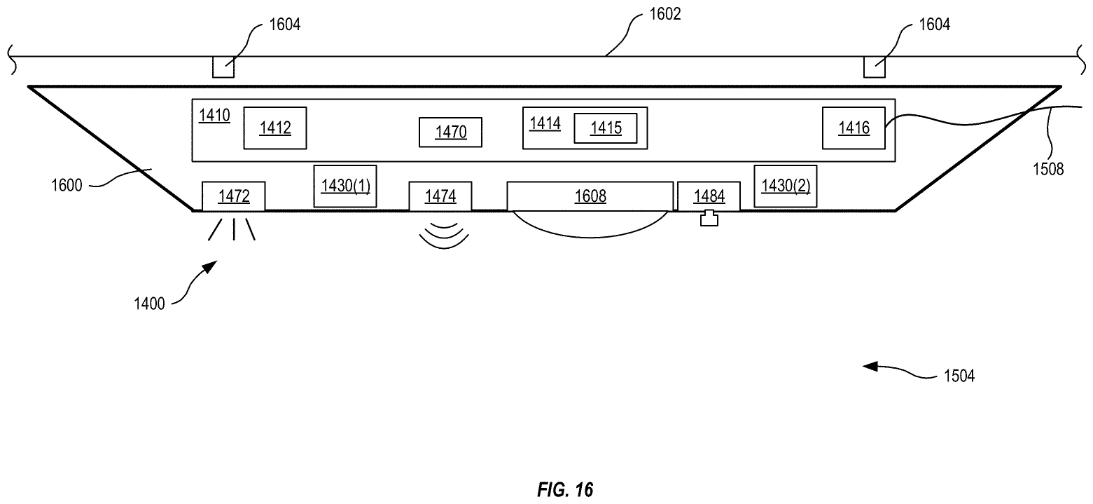

RFID reader system 1400 may also include a power manager 1416 that provides electrical power to RFID controller 1410. In certain embodiments, power manager 1416 includes a monitoring capability and an isolation circuit to connect/disconnect power to/from RFID reader system 1400 when anomalies (e.g., overvoltage, undervoltage, overcurrent, undercurrent, over temperature, etc.) are detected. Power manager 1416 may also include conditioning electronics that condition electrical power received from a vehicle (see vehicle 1501, FIGS. 15 and 16) in which RFID reader system 1400 is installed to power components of RFID reader system 1400.

In certain embodiments, power manager 1416 includes electrical storage, such as one or more rechargeable batteries 1417, that may be recharged from the received external electrical power and used to provide power to other components of RFID reader system 1400. The received external electrical power may be from a component of the vehicle (e.g., alternator, battery), or another external power source such as a solar panel, etc. Accordingly, power manager 1416 may use one or more rechargeable batteries 1417 to provide power to RFID reader system 1400 when vehicle power is unavailable. In certain embodiments, one or more rechargeable batteries 1417 may be located in RFID controller 1410 and are charged using power received from power manager 1416. Power manager 1416 may include one or more diodes to prevent inadvertent discharge of one or more rechargeable batteries 1417. Power manager 1416 may be included within the same housing as RFID controller 1410, or in a separate housing therefrom, without departing from the scope hereof.

In one example of operation, RFID controller 1410 controls RFID reader 1412 to detect and read any RFID tags 1490 within wireless range of RFID antennas 1420, 1430, and 1440. RFID tags 1490 may be passive or active RFID tags and/or RFID tape nodes.

RFID controller 1410 may also include one or more sensors 1470 that may be read to determine environmental characteristics of RFID reader system 1400. For example, sensors 1470 may include at least one temperature sensor, a UV sensor, at least one accelerometer, and so on, that are used to monitor conditions within a vehicle in which RFID reader system 1400 is installed.

RFID controller 1410 may also include at least one status indicator 1472 and/or at least one audio generator 1474. Status indicator 1472 and/or audio generator 1474 may be used to indicate an operating status or RFID controller 1410 and/or to indicate when an anomalous situation has been detected, described in further detail below.

RFID controller 1410 may also include at least one display device 1476 for providing textual and/or graphical outputs. Display device 1476 is for example one of an LCD display, an E-ink display, and an HMI display capable of outputting alphanumeric and/or graphical information.

RFID controller 1410 may also include a proximity sensor 1478 that detects proximity of a person to RFID controller 1410. For example, proximity sensor 1478 may be one of an infra-red movement detector, a camera, light sensor and so on.

RFID controller 1410 may also include a vehicle interface 1480 that communicates with components of vehicle 1501. For example, vehicle interface 1480 may be an OBD port that facilitates communication with computers of vehicle 1501 to receive global navigation satellite system (GNSS) location information (e.g., GPS coordinates) from a vehicle navigation unit.

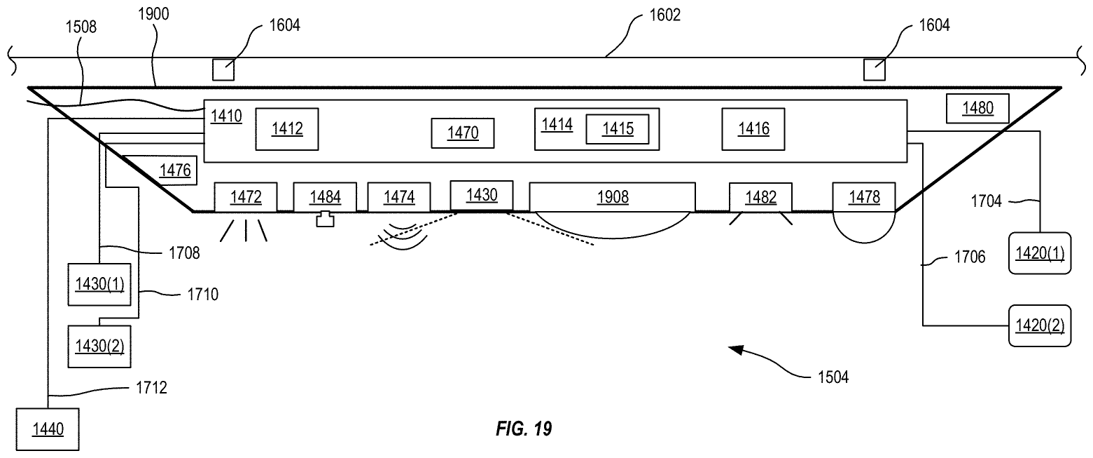

RFID controller 1410 may also include at least one camera 1482 for capturing images of activity detected by one or both of RFID reader 1412 and proximity sensor 1478. The at least one camera 1482 may have a different field of view other than downward as shown in FIG. 19, such as forward, or rearward towards the entrance to cargo area 1504. RFID controller 1410 may store captured images for a predetermined period of time and allow retrieval of images for detected events.

RFID controller 1410 may also include an input device 1484 that allows an operator and/or an installation technician to provide inputs to RFID controller 1410. Input device 1484 may include a button, or other touch screen control. Input device 1484 may additionally or alternatively include a microphone for inputting audio, such as for enabling one or two-way communication between the user within the cargo area and another device. In embodiments, display device 1476 and input device 1484 may act as a user interface for RFID controller 1410.

Advantageously, where assets loaded into a vehicle are equipped with an RFID tape node (e.g., adhered to the asset or stored inside a portion of the asset or asset's container, such as a box). RFID reader system 1400 configured with the vehicle may then: capture movement of assets into the vehicle from rear door; capture movement of assets from a cargo area of the vehicle to a driver's cabin of the vehicle, and vice versa; capture real time inventory of the vehicle by detecting incremental changes to the inventory; and capture movement of packages out of the driver's cabin through a front door of the vehicle.

### Installation Within Vehicle

FIG. 15 is a schematic diagram illustrating example RFID reader system 1400 installed within a vehicle 1501, in embodiments. Vehicle 1501 is for example a delivery van, a truck, a package car, cargo van, or some other vehicle for storing and transporting assets 1506. In other embodiments, the vehicle 1501 is a different type of vehicle, such as a passenger vehicle, an airplane, a boat, a helicopter, or some other vehicle which can store and transport assets and people. As shown, vehicle 1501 includes a driver cabin 1502 where the driver of vehicle 1501 sits to drive vehicle 1501 and a cargo area 1504 where assets 1506 or other objects are loaded for transportation by vehicle 1501. As shown, cargo area 1504 is separate from driver cabin 1502; however, in other vehicles, driver cabin 1502 connects with cargo area 1504 via a door, window, or opening that allows assets 1506, objects or people to pass between driver cabin 1502 and cargo area 1504 directly.

In this embodiment, vehicle 1501 is fitted with RFID reader system 1400 that includes RFID controller 1410, cargo area RFID antennas 1430(1) and 1430(2) positioned within cargo area 1504, and power manager 1416. That is, external RFID antennas 1420 and driver cabin RFID antenna 1440 are omitted in this embodiment. Although shown with two cargo area RFID antennas 1430, RFID reader system 1400 may have more or fewer cargo area RFID antennas 1430 without departing from the scope hereof. For example, RFID reader system 1400 may include a single RFID antenna 1430 positioned near the center of the ceiling of the cargo area of vehicle 1501 that operates to both transmit an RFID interrogation signal 1432 and receive any RFID response signal(s) 1434. In another example where RFID reader system 1400 includes two or more cargo RFID antennas 1430, one cargo RFID antenna 1430(1) may operate to transmit the RFID interrogation signal 1432 and the other cargo RFID antennas 1430 may operate to receive any RFID response signal(s) 1434. In yet other embodiments, an external RFID device generates the RFID interrogation signal 1432 and each cargo RFID antenna 1430 operates to receive any RFID response signals 1434.

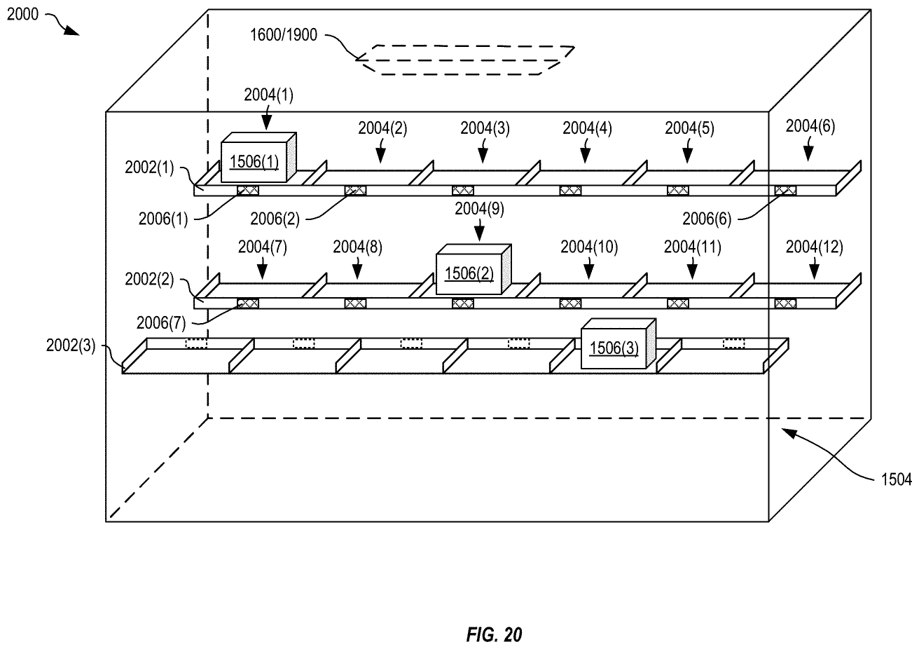

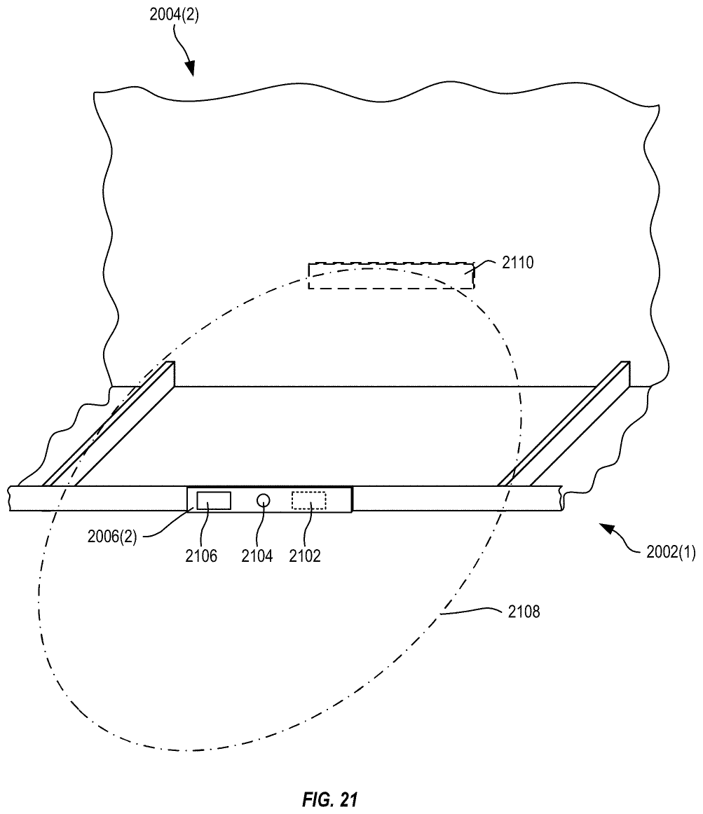

The RFID antenna 1430 collectively have field of view that spans the locations where packages enter and/or are loaded into cargo area 1504 of vehicle 1501. In embodiments, the RFID antenna 1430 are controlled such that they do not detect RFID signals generated from outside of the cargo area (e.g., via beam steering, or sensitivity control) to provide granularity in the detected signals by the RFID antennas 1430. In some embodiments, the RFID controller may detect an RFID response signal 1434 from an RFID tag 1490 at an RFID antenna (e.g., either at the RFID controller 1410 or at another device such as another RFID tag 1490, or slot antenna discussed herein, or other gateway capable of detecting said RFID response signal), but the detecting device will not register an RFID detection event or track location within a specified zone if the received signal strength is not above a threshold value. Settings and locations of the RFID antennas 1430 may be implemented to increase the granularity of the detection area, such as by putting antennas associated with slots of an asset rack as discussed with respect to FIGS. 20 and 21, below. The type and configuration of the RFID antenna 1430 may vary based on the number of RFID antennas 1430 included in system 1400. For example, in one embodiment where a single RFID antenna 1430 is used, a patch (or otherwise planar) antenna may be implemented to increase the spatial coverage of the FOV of the antenna to allow for more coverage in the cargo area. Non-patch RFID antennas may be implemented in multi-RFID antenna 1430 embodiments, or where a single RFID antenna 1430 is monitoring a smaller cargo area and a patch antenna is not needed to provide adequate spatial coverage. Multi-RFID antenna 1430 embodiments may include combination of patch and non-patch antennas.

Although shown separately and within cargo area 1504, RFID controller 1410 and power manager 1416 may be combined into a single device that may be within cargo area 1504 or positioned elsewhere on vehicle 1501. Power manager 1416 is shown receiving electrical power from a battery 1510 of vehicle 1501 via a power cable 1508. Power cable 1508 may connect to other power sources (e.g., a fuse box, a power socket, light socket, solar panel, etc.) of, or attached to, vehicle 1501 without departing from the scope hereof.

In one example of operation, RFID controller 1410 controls RFID reader 1412 to detect RFID tags 1490 within cargo area 1504 using cargo area RFID antennas 1430(1) and 1430(2). RFID reader system 1400 may determine which RFID tags 1490 and corresponding assets 1506 are added to, or removed from, cargo area 1504 or cabin 1502. RFID controller 1410 and/or RFID reader 1412 may communicate detected RFID tags 1490, or changes to detected RFID tags 1490, to wireless gateway node 1414, which may relay the information to tracking system 700 of FIG. 7, or components thereof.

The assets 1506 may be packages, cargo, or other tangible assets, in an embodiment. In another embodiment, the asset 1506 is a person, such as a driver, loader, or unloader of the vehicle 1501, wherein the person is wearing, holding, or otherwise associated with one or more of the RFID tags 1490 in the form of a wearable, necklace, bracelet, smart device (e.g., smartphone), ticket, etc. Thus, it should be appreciated that the vehicle 1501 need not be a cargo vehicle as shown, but may also be a passenger transport vehicle (such as a bus, train, plane, rideshare vehicle, etc.), where the RFID tag 1490 is associated with a passenger who is utilizing the passenger transport vehicle. The “cargo area 1504” in the passenger transport vehicle need not be a component of the vehicle itself, but may also be an intermediate loading device, such as a jet bridge in an airport gate, etc., wherein the RFID system 1400 is operating to identify passengers loading/unloading a plane (or train, etc.) as they pass through the intermediate loading device.

In certain embodiments, RFID controller 1410 may receive a manifest 1456 from a remote server (e.g., server 704 of tracking system 700) that defines RFID identifiers of RFID tags 1490 that should be within vehicle 1501 and at which locations within the vehicle 1501. For example, manifest 1456 may list RFID identifiers of RFID tags 1490 corresponding to assets 1506 that should be loaded onto vehicle 1501 at a transfer depot. Further, manifest 1456 may also define a location or area where each RFID tag 1490 should be removed from vehicle 1501 (e.g., for delivery), based on a delivery address of the corresponding asset 1506 not being within threshold distance of a current location and/or a predefined route of vehicle 1501. Advantageously, RFID controller 1410 may immediately indicate, using status indicator 1472 (e.g., a red flashing light) and or audio generator 1474 (e.g., an alert sound), when an incorrect asset is loaded onto vehicle 1501, such as when an RFID identifier 1492 read from an RFID tag 1490 (e.g., included in an RFID response signal 1434) is not included in manifest 1456. Accordingly, an operator of vehicle 1501 is alerted of a potential error in loading of vehicle 1501. Further, when RFID controller 1410 no longer detects the RFID identifier of RFID tag 1490 within cargo area 1504 prior to vehicle 1501 reaching a delivery location of the corresponding asset, RFID controller 1410 may immediately generate an alert using one or both of status indicator 1472 (e.g., a red flashing light) and or audio generator 1474. Accordingly, the operator of vehicle 1501 is immediately alerted of a potential delivery error.

### Monolithic Apparatus

FIG. 16 is a schematic illustrating one example monolithic RFID reader apparatus 1600, in embodiments. Monolithic RFID reader apparatus 1600 is a single device that includes functionality of RFID reader system 1400 as described for the embodiment of FIG. 15 in a single package that simplifies retrofitting of a vehicle with RFID reader system 1400. In one example of installation, monolithic RFID reader apparatus 1600 is attached to a ceiling 1602 or ceiling ribs 1604 of cargo area 1504 of vehicle 1501 of FIG. 15. Monolithic RFID reader apparatus 1600 includes RFID controller 1410 with RFID reader 1412, at least one cargo area RFID antenna 1430, wireless gateway node 1414 with at least one network antenna 1415, and power manager 1416 that is optionally connected to electrical power of vehicle 1501 via single power cable 1508. Monolithic RFID reader apparatus 1600 may include one or more sensors 1470, status indicator 1472, audio generator 1474, and input device 1484. Network antenna 1415 may be positioned on an external surface of Monolithic RFID reader apparatus 1600 for example.

In embodiments where monolithic RFID reader apparatus 1600 includes a single cargo RFID antenna 1430, the single cargo RFID antenna 1430 operates to both transmit an RFID interrogation signal 1432 and receive any RFID response signal(s) 1434. In another example where monolithic RFID reader apparatus 1600 includes two or more cargo RFID antennas 1430, one cargo RFID antenna 1430(1) may operate to transmit the RFID interrogation signal 1432 and the other cargo RFID antennas 1430 may operate to receive any RFID response signal(s) 1434. In yet other embodiments, an external RFID device generates the RFID interrogation signal 1432 and each cargo RFID antenna 1430 within monolithic RFID reader apparatus 1600 operates to receive any RFID response signal(s) 1434.

Monolithic RFID reader apparatus 1600 may also include any one or more of display device 1476, proximity sensor 1478, vehicle interface 1480, at least one camera 1482, and combination thereof; however, since this embodiment represents a minimal install, they are omitted.

Advantageously, installation of monolithic RFID reader apparatus 1600 is simple, requiring minimal wiring (e.g., only power cable 1606) and is therefore convenient for retrofitting of existing vehicles. Monolithic RFID reader apparatus 1600 may also include a lamp 1608, allowing Monolithic RFID reader apparatus 1600 to be installed by replacing an existing lamp of vehicle 1501.

### High-Fidelity Configuration

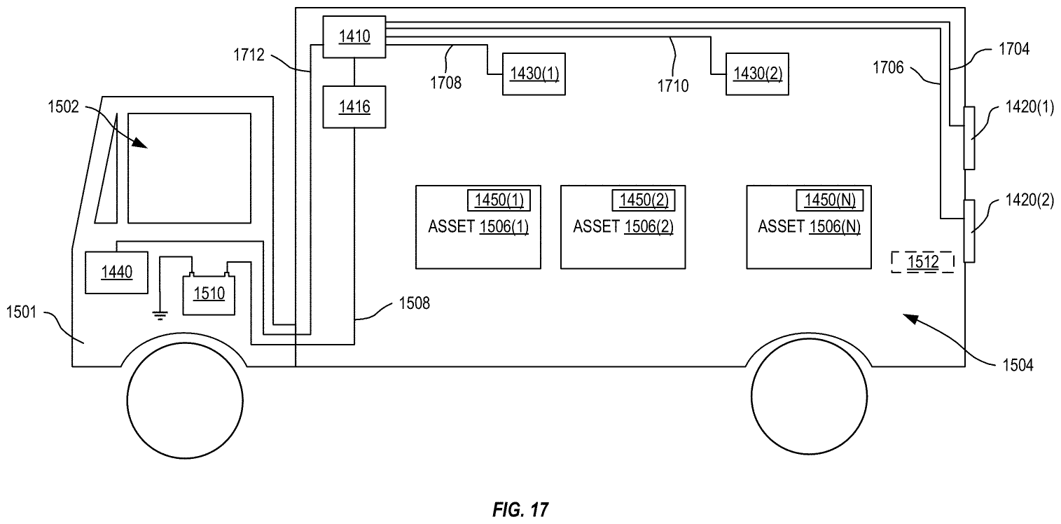

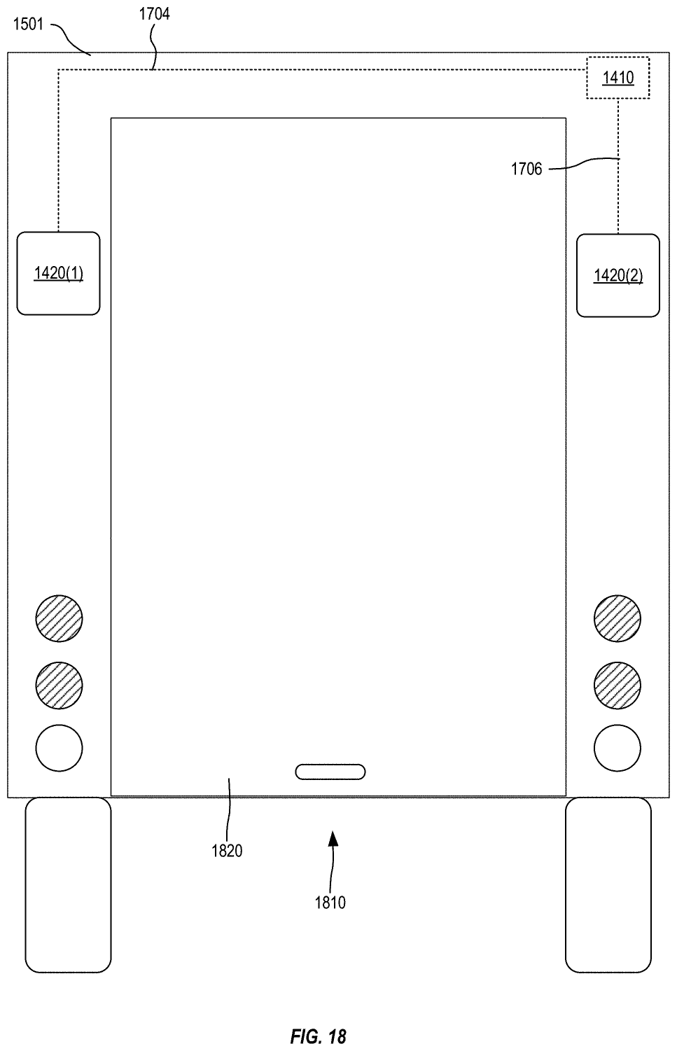

FIG. 17 is a schematic diagram illustrating example fitting of RFID reader system 1400 to vehicle 1501 of FIG. 15, in embodiments. FIG. 18 is a diagram illustrating a rear end 1810 of vehicle 1501 of FIG. 17, according to certain embodiments. FIGS. 17 and 18 are best viewed together with the following description. The embodiments of FIGS. 17 and 18 establish additional features that may be included in the RFID reader system 1400 to improve the fidelity of the RFID reader system in analyzing the vehicle and associated cargo area to identify assets therein and potential mis-load applications.

Vehicle 1501 is fitted with RFID reader system 1400 that includes RFID controller 1410, cargo area RFID antennas 1430(1) and 1430(2) that connected to RFID reader 1412 by cables 1708 and 1710 such that they are positionable within cargo area 1504, external RFID antennas 1420(1) and 1420(2) connected to RFID reader 1412 by cables 1704 and 1706 such that they are positionable at an external surface of rear end 1810 of vehicle 1501, driver cabin RFID antenna 1440 connected to RFID reader 1412 such that it is positionable within driver cabin 1502, and power manager 1416 that may be coupled by cable 1508 to vehicle power (e.g., a battery 1510 of vehicle 1501). Although shown separately and within cargo area 1504, RFID controller 1410 and power manager 1416 may be combined into a single device that may be within cargo area 1504 or positioned elsewhere on vehicle 1501. Although power manager 1416 is shown connected to battery 1510, power manager 1416 may connect to other power sources (e.g., a fuse box, a power socket, light socket, solar panel, etc.) of, or attached to, vehicle 1501 without departing from the scope hereof.

As shown in FIG. 18, external RFID antennas 1420 are positioned on an external surface of vehicle 1501 either side of rear door 1820 to face rearward from vehicle 1501. Each external RFID antenna 1420 is directional having a substantially rear-facing lobe. Accordingly, external RFID antennas 1420 detect RFID tags 1490 external of cargo area 1504 and rearward of vehicle 1501. In certain embodiments, external RFID antennas 1420 are used for vehicle-to-vehicle (V2V) communication under certain circumstances, as described in detail below.

In embodiments, one cargo RFID antenna 1430(1) may operate to transmit an RFID interrogation signal 1432 and the other cargo RFID antennas 1430, cabin RFID antenna 1440 and external RFID antennas 1430 may operate to receive any RFID response signal(s) 1434. In yet other embodiments, an external RFID device generates the RFID interrogation signal 1432 and each cargo RFID antenna 1430, cabin RFID antenna 1440, and external RFID antenna 1430 of RFID reader system 1400 operates to receive any RFID response signal(s) 1434. In other embodiments, one cargo RFID antenna 1430 may operate to transmit the RFID interrogation signal 1432, the other cargo RFID antenna 1430 may operate to receive any RFID response signal(s) 1434. Also in this embodiment, cabin RFID antenna and external RFID antenna 1430 may operate to both transmit the RFID interrogation signal 1432 and receive any RFID response signal(s) 1434.

### High-Fidelity Monolithic Apparatus

FIG. 19 shows one example monolithic RFID reader apparatus 1900, in embodiments. Monolithic RFID reader apparatus 1900 is similar to monolithic RFID reader apparatus 1600 of FIG. 16, but includes functionality and connectivity to facilitate higher-fidelity implementation of RFID reader system 1400 as shown in the embodiment of FIGS. 17 and 18.

Monolithic RFID reader apparatus 1900 is a single device that includes functionality of RFID reader system 1400 as described for the embodiment of FIGS. 17 and 18 in a single package that simplifies retrofitting of a vehicle with RFID reader system 1400, while maintain the versatility of adding any number (including zero) of additional RFID antennas external to the monolithic housing of monolithic RFID reader apparatus 1900, such as zero, one, or more additional cargo area RFID antennas 1930 (which are equivalent to cargo area RFID antennas 1430 discussed above) positionable outside of monolithic RFID reader apparatus 1900, at least one driver cabin RFID antenna 1440, and external RFID antennas 1420. In one example of installation, monolithic RFID reader apparatus 1900 is attached to a ceiling 1602 or ceiling ribs 1604 of cargo area 1504 of vehicle 1501. Monolithic RFID reader apparatus 1900 includes RFID controller 1410, RFID reader 1412, RFID antenna 1430 wireless gateway node 1414 with at least one, power manager 1416 that is optionally connected to electrical power of vehicle 1501 via single power cable 1508, display device 1476, proximity sensor 1478, vehicle interface 1480, and at least one camera 1482. Network antenna 1415 may be positioned on an external surface of Monolithic RFID reader apparatus 1900 for example.

Monolithic RFID reader apparatus 1900 may include at least one connector for coupling with cables 1704 and 1706 that connect external RFID antennas 1420 to RFID reader 1412, at least one connector for coupling with cables 1708 and 1710 that connect cargo area RFID antennas 1930(1) and 1930(2) to RFID reader 1412 (more or fewer cargo area RFID antennas 1930 may be used without departing from scope hereof), and at least one connector for coupling with cable 1712 that connects driver cabin RFID antenna 1440 with RFID reader 1412. Monolithic RFID reader apparatus 1600 may include one or more sensors 1470, status indicator 1472, audio generator 1474, and input device 1484.

The RFID antenna 1430 may be an integrated antenna housed within the monolithic RFID reader apparatus 1900, and have field of view that spans downward when the monolithic RFID reader apparatus 1900 is mounted at a ceiling, or high, location within the cargo area (or other monitored area such as a intermediate loading device, such as a jet bridge in an airport gate, etc.) to monitor the locations where packages enter and/or are loaded into cargo area 1504 of vehicle 1501 and eventually positioned during transport. The type and configuration of the RFID antenna 1430 may vary based on the number of RFID antennas 1430, and additional RFID antennas 1930 that are coupled with the monolithic RFID reader apparatus 1900 (e.g., via cables 1708 and/or 1710). For example, in one embodiment where a single RFID antenna 1430 is used, a patch (or otherwise planar) antenna may be implemented to increase the spatial coverage of the read area (FOV) of the antenna to allow for more coverage in the cargo area. Non-patch RFID antennas may be implemented as the RFID antenna 1430, and/or any of the external cargo area RFID antennas 1930 without departing from scope hereof, such as where a single RFID antenna 1430 is monitoring a smaller cargo area and a patch antenna is not needed to provide adequate spatial coverage. Multi-RFID antenna embodiments that include an internal cargo area RFID antenna 1430 and additional external cargo area RFID antennas 1930 may include combination of patch and non-patch antennas.

Installation of RFID reader system 1400 required mounting of monolithic RFID reader apparatus 1900, mounting of antenna 1420, 1430, and 1440, running of cabling 1508, 1704, 1706, 1708, 1710, and 1712. Thus, monolithic RFID reader apparatus 1900 provides a convenient way to retrofit existing vehicles. Monolithic RFID reader apparatus 1900 may also include a lamp 1908, allowing Monolithic RFID reader apparatus 1900 to be installed by replacing an existing lamp of vehicle 1501.

Although shown with two external RFID antennas 1420, two cargo area RFID antennas 1430, and one driver cabin RFID antenna 1440, RFID reader system 1400 may have more or fewer RFID antennas 1420, 1430, and 1440 without departing from the scope hereof. As shown in FIG. 18, one external RFID antenna 1420 is mounted each side of a rear door 1820.

In embodiments, at least one of the RFID antennas 1430 (e.g., one cargo RFID antenna 1430(1)) may operate to transmit an RFID interrogation signal 1432 and the other cargo RFID antennas 1430, cabin RFID antenna 1440 and external RFID antennas 1430 may operate to receive any RFID response signal(s) 1434. In yet other embodiments, an external RFID device generates the RFID interrogation signal 1432 and each cargo RFID antenna 1430, cabin RFID antenna 1440, and external RFID antenna 1430 of RFID reader system 1400 operates to receive any RFID response signal(s) 1434. In other embodiments, one cargo RFID antenna 1430 may operate to transmit the RFID interrogation signal 1432, the other cargo RFID antenna 1430 may operate to receive any RFID response signal(s) 1434. Also in this embodiment, cabin RFID antenna and external RFID antenna 1430 may operate to both transmit the RFID interrogation signal 1432 and receive any RFID response signal(s) 1434. Additionally or alternatively, at least one of the RFID antennas 1430 may transmit the RFID interrogation signal 1432, and another RFID tag, such as one or more of RFID tags 1490 attached to each asset, may receive an RFID response signal 1434 to the RFID interrogation signal 1432 from a responding one of the RFID tags 1490. The one or more RFID tags 1490 that receive the RFID response signal(s) 1434 may then relay the received RFID response signal 1434 to the vehicular RFID reader system 1400 (e.g., vehicular RFID controller 1410), or another device such as server 704 discussed above in FIG. 7.

RFID reader system 1400 detects RFID tags 1490 entering vehicle 1501, within vehicle 1501, and exiting vehicle 1501. That is, RFID reader system 1400 tracks the assets 1506, or other objects, based on detecting and identifying RFID tags 1490 associated with the assets 1506 or objects being transported. Particularly, RFID reader system 1400 may detect RFID tags 1490 within driver cabin 1502 using driver cabin RFID antenna 1440 and may detect RFID tags 1490 within cargo area 1504 using cargo area RFID antenna 1430. RFID reader system 1400 may also detect RFID tags 1490 approaching a rear end 1810 of vehicle 1501 or leaving vehicle 1501 in a rearward direction. RFID controller 1410 records inventory within vehicle cargo area 1504 and driver cabin 1502, and may thereby discern when RFID tags 1490 enter or exit these areas. Accordingly, using previous RFID control and decode iterations, RFID reader system 1400 may detect when assets 1506 or objects move into, or out of, driver cabin 1502 and/or cargo area 1504 based on when previously detected RFID tags 1490 are no longer detected, and when previously undetected RFID tags 1490 are newly detected. Further, by knowing the relationship between the driver cabin 1502, cargo area 1504, and area behind vehicle 1501, RFID controller 1410 may determine a direction of movement of RFID tags 1490 and thus associated assets 1506.

In one example of operation, at intervals, RFID controller 1410 controls RFID reader 1412 to detect RFID tags 1490 within cargo area 1504 using cargo area RFID antennas 1430(1) and 1430(2), to detect RFID tags 1490 within driver cabin 1502 using driver cabin RFID antenna 1440, and to detect RFID tags 1490 behind vehicle 1501 using external RFID antennas 1420. Accordingly, RFID controller 1410 determines when inventory within these areas changes, and which assets 1506 are added or removed. RFID controller 1410 may communicate inventory, or changes to the inventory, within each of driver cabin 1502 and cargo area 1504 to wireless gateway node 1414, which may relay the information to tracking system 700 of FIG. 7, or components thereof, such as server 704 for example.

Accordingly, when asset 1506 is inside the vehicle, RFID reader system 1400 may detect where specifically inside the vehicle asset 1506 is located by detecting RFID tag 1490 attached to asset 1506. In particular, RFID reader system 1400 may determine whether an asset is inside cargo area 1504 or driver cabin 1502, in addition to detecting an asset moving between cargo area 1504 and driver cabin 1502. Additionally, RFID reader system 1400 may determine whether the asset has exited vehicle 1501 from cargo area 1504 or from driver cabin 1502.

Further, external RFID antennas 1420 may be used to track location and movement of assets 1506 relative to vehicle 1501 based upon detecting the corresponding RFID tags 1490 using external RFID antennas 1420. Using more than one RFID antenna increases signal to noise and increases the ability of RFID reader system 1400 to determine directionality of RFID tags 1490 with respect to vehicle 1501 (using triangulation, trilateration, multilateration, and/or other techniques based off of received signal strength and directionality of received signals).

In certain embodiments, RFID controller 1410 includes a passive combiner 1421 (see FIG. 14) to combine outputs of one or more of the RFID antennas (e.g., external RFID antennas 1420(1) and 1420(2)) as a single input into RFID reader 1412. Passive combiner 1421 adds the signals received from the external RFID antennas 1420 together and provides the combined signal as an input (e.g., corresponding to the overall antenna array 1420) to RFID reader 1412 in RFID controller 1410.

External RFID antennas 1420(1) and 1420(2) connect to passive combiner 1421 via cables 1704 and 1706, respectively, and the length of cables 1704 and 1706 are tuned to ensure outputs from external RFID antennas 1420 are phase matched to each other, where cable 1704 adds a phase of P1 to the output of external RFID antenna 1420(1) and cable 1706 adds a phase of P2 to the output of external RFID antenna 1420(2). For a given operational frequency of external RFID antennas 1420, an electrical length of cables 1704 and 1706 are adjusted such that, P₁=2nπ+P₂.

Vehicle Racks with Asset Tracking

FIG. 20 is a perspective schematic illustrating one example slot tracking system 2000 within vehicle 1501 of FIG. 15, in embodiments. Slot tracking system 2000 includes RFID reader system 1400 (illustratively shown as either monolithic RFID reader apparatus 1600 or 1900). Following the example of FIGS. 14, 15, and 17, cargo area 1504 of vehicle 1501 is fitted with racks 2002 (also referred to as shelves) that are partitioned into slots 2004 (also referred to as bins) sized and shaped for storing assets 1506 during transportation by vehicle 1501. Although not shown in FIG. 20 for clarity of illustration, floor space within cargo area 1504 may also be divided into slots 2004. FIG. 21 is a perspective view showing slot 2004(2) of FIG. 20 in further example detail, in embodiments. FIGS. 20 and 21 are best viewed together with the following description.

Racks 2002(1) and 2002(2) are mounted at a first side wall (rearward in FIG. 20) of cargo area 1504 and rack 2002(3) is mounted at a second side wall (forward in FIG. 20 and shown in dashed outline for clarity of illustration) of cargo area 1504. Cargo area 1504 may have more or fewer racks 2002 and slots 2004 without departing from the scope hereof. Slot tracking system 2000 extends RFID reader system 1400 by further including a slot RFID device 2006 (which may be a tape node, in which case it is referred to herein as slot tape node 2006 (e.g., an RFID tape node) attached (e.g., adhered) to each slot 2004. For clarity purposes herein, slot RFID device 2006 is referred to as slot tape node 2006, but does not necessarily need to be a tape node and may additionally or alternatively be integral with the rack or otherwise have a different form factor than a tape node. The slot tape node 2006 may operate as an RFID reader node as discussed above, where it operates to receive RFID response signals to a generated RFID interrogation signal. The slot tape node 2006 may generate the RFID interrogation signal, or the RFID interrogation signal may be generated by another device such as another slot tape node 2006, or an RFID antenna associated with the monolithic device 1600 or 1900 as discussed above.

In embodiments, the slot tape node 2006 is a wireless, battery-powered device. Alternatively, the slot tape node 2006 is wired and/or line-powered. E.g., if a more permanent installation is preferred, the slot tape node 2006 may be wired to either a gateway node, the vehicle power, the power manager 1416 discussed above, another wired power source, a solar panel, or combinations thereof.

Slot tape node 2006 includes a wireless transducing circuit 2102 (e.g., wireless transducing circuit 410 of FIG. 4) that facilitates communication with RFID controller 1410 via wireless gateway node 1414 and further includes RFID capability such that it may detect proximity of RFID tags 1490. In embodiments, slot tape node 2006 does not generate an RFID interrogation signal 1432, but detects wireless response signal(s) (e.g., RFID response signal 1434, discussed above) from RFID tags 1490 that are within range when triggered by an RFID interrogation signal 1432 generated by RFID reader system 1400 or by an externally generated RFID interrogation signal 1432. In other embodiments, each slot tape node 2006 generates its own RFID interrogation signal to interrogate RFID tags 1490. Slot tape node 2006 may also include one or both of an indicator 2104 (e.g., an LED) and a display 2106 (e.g., an LCD display, an LED display, an e-ink display, etc.).

Sensitivity and/or operational RFID range (including one or more of RFID channel, transmit power control, hopping protocol (multiplexing between frequency channels), RF beam profile, and receiver sensitivities indicated by ellipse 2108) of slot tape node 2006 is configured to primarily detect RFID tags 1490 within its slot 2004. As such, the operational RFID range may be less than a full operational range of the hardware components such that the RFID operation of slot tape node 2006 reduces interference with alternate RFID components within the vehicle (such as other components of RFID reader system 1400 discussed herein). Alternatively, slot tape node 2006 may use signal strength to determines whether a detected RFID tag 1490 is within its slot 2004. Although slot tape node 2006 is shown positioned at the front of its slot 2004, it may alternatively be positioned at the back of its slot 2004, indicated as slot tape node position 2110, or at any other location in the given slot 2004. In some embodiments, each slot 2004 may have multiple slot tape nodes 2006 that communicate to determine when a detected RFID tag 1490 is within its slot 2004. In addition, additional RFID reader nodes may be located throughout the monitored area, and not just as the slot tape nodes 2006. Wireless configuration and adaptivity of use of the RFID tape nodes (and multiple types/configurations of the RFID tape nodes such as some that are just RFID reader nodes, and/or some that are RFID illumination nodes, and/or some that are just passive/active RFID nodes, etc.)

Each asset 1506 may have a shipping label, or other label, that displays transit information including a truck number (e.g., an identifier of vehicle 1501), and optionally other information, to assist an employee or operator in loading, unloading, transporting, and storing the asset. The transit information may further include a shelf/rack identifier and/or a slot identifier. That is, the label on asset 1506 may identify one of slots 2004 within vehicle 1501 for storing the asset. In certain embodiments, the shipping label attached to asset 1506 is an RFID tape node that may be detected and read by RFID reader system 1400. This RFID tape node may also store the transit information corresponding to its asset 1506 in its memory/storage, and may transmit at least part of the transit information in response to RFID interrogation from RFID reader system 1400. Accordingly, RFID reader system 1400 may learn of the designated slot for the asset and may provide further guidance to the operator in loading of asset 1506 into the designated slot 2004 based on the received transmit information. For example, the indicator 2104 or display 2106 on the slot tape node 2006 associated with the designated slot 2004 may be controlled to indicate the asset 1506 should be loaded into the designated slot 2004 (or is wrongly loaded).

In one embodiment, one cargo RFID antenna 1430 of RFID reader system 1400, or an external RFID device, may transmit an RFID interrogation signal (e.g., RFID interrogation signal 1432) within cargo area 1504 and other cargo RFID antennas 1430 and each slot tape node 2006 operate to receive any RFID response signal(s) (e.g., RFID response signal(s) 1434). However, in certain embodiments, one or more slot tape nodes 2006 may both generate an RFID interrogation signal and receive any RFID response signals.

In one example of operation, when RFID controller 1410 detects the RFID tag 1490 on asset 1506 and determines that it is being loaded into vehicle 1501, RFID controller 1410 may determine which slot 2004 asset 1506 is assigned to and send instructions to the corresponding slot tape node 2006 located at the assigned slot to indicate, via activation (e.g., turning on, or turning to a specific color) of the indicator 2104 or display 2106, the destination for asset 1506. In one example, the tape node on asset 1506(1) sends a message to RFID controller 1410 indicating slot 2004(1). In another example, RFID controller 1410 determines slot 2004(1) is assigned to asset 1506(1) based on an RFID identifier read from RFID tag 1490 on asset 1506(1) and manifest 1456. RFID controller 1410 may then instruct, via wireless gateway node 1414, slot tape node 2006(1) to activate its indicator 2104 (e.g., one or more of turn on the indicator, turn the indicator to a designated color, flash the indicator, and the like) and/or instruct slot tape node 2006(1) to display an identifier of asset 1506(1) on its display 2106. Advantageously, the operator bringing asset 1506(1) into vehicle 1501 is aided in placement of asset 1506(1) into slot 2004(1).

Similar functionality may be performed via vehicle unloading. For example, RFID controller 1410 may monitor location of the vehicle 1501, and, based on manifest 1456 determine that a given package is to be delivered at the current location. Additionally, or alternatively, a signal may be transmitted to the RFID controller 1410, or one or more of the slot tape nodes 2006 indicating that a package is up for current delivery. The RFID controller 1410 may, in turn, transmit a control message to instruct the designated slot tape node 2006 associated with the package up for delivery to activate its indicator 2104 (e.g., one or more of turn on the indicator, turn the indicator to a designated color, flash the indicator, and the like) and/or instruct slot tape node 2006(1) to display an identifier of asset 1506(1) on its display 2106. This advantageously allows the delivery personnel to quickly and efficiently obtain the package set for delivery from the rack.

In certain embodiments, as asset 1506 is placed into slot 2004, the corresponding slot tape node 2006 detects the RFID tag 1490 on asset 1506 and sends the RFID identifier to RFID controller 1410. RFID controller 1410 may then verify that asset 1506 is stored in the correct slot 2004, for example by comparing the asset 1506 against the manifest 1456. Further, RFID controller 1410 may generate an alert (e.g., an alarm sounds and/or visual indication) to indicate when asset 1506 is stored correctly and/or incorrectly. For example, where asset 1506(1) is incorrectly placed into slot 2004(2), slot tape node 2006(2) may report detection of asset 1506(1) to RFID controller 1410, which may then generate the alert, allowing the operator to reposition asset 1506(1), rather than be unable to find asset 1506(1) at a later time. A further advantage is that RFID reader system 1400 operates to direct the operator in storing and retrieving assets 1506 without direct interaction with the operator. That is, the operation receives direction just by carrying asset 1506, and is automatically corrected when positioned errors are made. By ensuring assets 1506 are stored in the correct slot 2004, the operator retrieves the asset 1506 quickly when offloading it (e.g., delivering it to a specific address) from vehicle 1501. Advantageously, RFID reader system 1400, racks 2002, slots 2004, and slot tape nodes 2006 facilitate storage and retrieval of assets 1506 by alerting the operator to storing errors and thereby avoiding problems locating misplaced assets.

Although slot tracking system 2000 is shown within vehicle 1501, slot tracking system 2000 may be used within other environments (e.g., warehouses, storage areas, loading docks, ships, aircraft, and so on) without departing from the scope hereof. Further, slot tracking system 2000 may be used to determine inventory and/or capacity of each slot 2004. For example, since each slot tape node 2006 detects and reports identified RFID tags 1490 within its respective slot 2004, RFID controller 1410 (or server 704) may maintain a database of assets 1506 stored in each slot 2004, and thereby determine space available in each slot 2004. For example, based on and know size of slots 2004 and size of each asset 1506 (e.g., defined within manifest 1456), RFID controller 1410 may determine space remaining in each slot for additional assets.

### Warehouse Racks

In one example of operation, slot tracking system 2000 is implemented in a warehouse where an operator is to move assets from a pile (e.g., pallet) into racks for storage. To the operator, the racks may seem full and therefore the operator has difficulty in placing the assets on the racks. Advantageously, slot tracking system 2000 inventories assets already stored in slots 2004, determines which slots 2004 have remaining space, and directs the operator to store assets from the pile in the slots having the remaining space. For example, RFID controller 1410 may direct each slot tape node 2006 corresponding to slots with remaining space to blink its status indicator 1472 to indicate the available space to the operator, thereby simplifying the operators task of storing assets from the pile onto the racks. As assets are loaded into the slots, RFID controller 1410 recalculates slot inventories and updates the indications of slots with available space.

Further, since each slot tape node 2006 identifies assets stored in that slot, RFID controller 1410 facilitates retrieval of a particular asset from racks 2002 by directing the operator to the slot containing the particular asset. For example, based on the RFID identifier corresponding to the asset being retrieved, RFID controller 1410 determines the slot 2004 in which it is stored and instructs the corresponding slot tape node 2006 to flash its status indicator 1472. Advantageously, the operator is immediately directed to the slot containing the required asset.

### Additional Use of External RFID Antennas

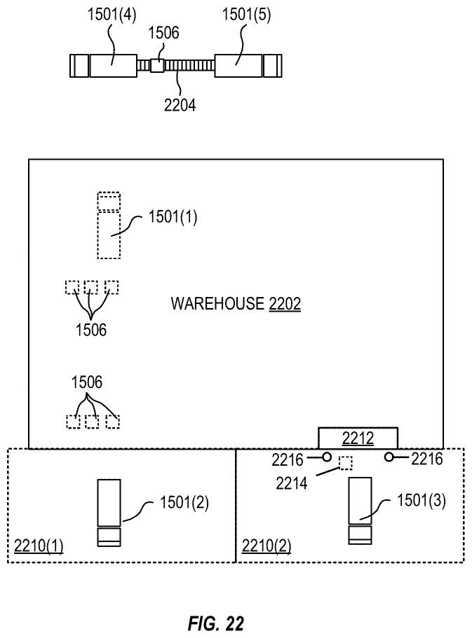

Further to detecting loading and unloading of RFID tags 1490 to and from vehicle 1501 via rear door 1820, external RFID antennas 1420 have additional uses. FIG. 22 is a block diagram showing a warehouse 2202 that stores (e.g., as a depot) assets for transportation by vehicles 1501(1)-5), in embodiments. In this example, a first vehicle 1501(1) is posited within warehouse 2202 for loading, and second and third vehicles 1501(2) and 1501(3) are posited at external loading bays of warehouse 2202. Vehicles 1501(1), 1501(2), and 1501(3) are fitted with RFID reader system 1400 as shown in FIGS. 17 and 18.

In one example, external RFID antennas 1420 may be used for sensing objects and obstacles behind vehicle 1501, thereby assisting the driver when maneuvering vehicle 1501. As the environment behind vehicle 1501 changed during a maneuver (e.g., reversing), wireless signals reflected and/or absorbed by objects behind vehicle 1501 also change and may be detected by RFID reader 1412. For example, as vehicle 1501(3) reverses towards the loading bay 2212 of warehouse 2202, external RFID antennas 1420 may be used to sense objects (expected and/or unexpected) blocking passage of vehicle 1501(3). Further, as vehicle 1501(3) reverses towards the loading bay 2212 of warehouse 2202, external RFID antennas 1420 may be used to sense a distance between vehicle 1501(3) and warehouse 2202.

For example, an asset 2214 with an RFID tag (e.g., RFID tag 1490) may be located on a street or curb or otherwise in an area to which the vehicle 1501(3) is backing up, and the system 1400 can identify said asset 2214 using external RFID antennas 1420 and can warn that the driver is about reverse over it by performing RFID-based location sensing with the RFID tag 1490 attached to the asset 2214. Similarly, RFID tags can be placed on objects of interest, like a stationary part of a loading bay or a wall such as posts 2216. Thus, proximity sensing using the RFID communication with the RFID tag 1490 on posts 2216 or other objects can be used to warn/guide a driver.

In another example, external RFID antennas 1420 may be used to detect assets 1506 being transferred into or out of vehicle 1501(4) on a conveyor belt 2204, such as when assets are transferred between vehicles 1501(4) and 1501(5). Accordingly, based on manifest 1456, RFID controller 1410 may detect when an expected asset 1506 is missed and when an unexpected asset is transferred unintentionally.

In another example, external RFID antennas 1420 may be used for communication between two vehicles 1501 when rear ends 1810 of each vehicle are facing one another. It should be appreciated that external RFID antennas 1420 need not be only on the rear of the vehicle 1501, but may also be located on sides and/or front of the vehicle (or top/bottom). In such situations, the communication may be made between two vehicles 1501 that are not rear to rear facing, but instead parallel parked, or otherwise including one external RFID antenna 1420 that is facing or within range of a second external RFID antenna 1420 on a second vehicle. That is, external RFID antennas 1420 are repurposed for local inter-vehicle communication when other communication paths may be blocked. For example, when vehicle 1501(1) is within warehouse 2202, one or both of gateway nodes 1414 and 1512 on vehicle 1501(1) is blocked (e.g., by the structure of warehouse 2202, by other similar structures, or blocked by local interference) from using long-range communication protocols, but gateway nodes on vehicle 1501(2), positioned outside of warehouse 2202 is not blocked and is available for long-range communication with other nodes of tracking system 700. In this situation, vehicle 1501(1) may use external RFID antennas 1420 communicate with vehicle 1501(2), which may then use its gateway nodes to relay the messages to tracking system 700. Under certain conditions, wireless gateway nodes 1414 of the two vehicles 1501(1) and 1501(2) may also communicate directly; however, when such communication is blocked (e.g., due to wireless interference etc.), external RFID antennas 1420 may be used to form a communication path between the two vehicles 1501(1) and 1501(2), and other vehicles as needed, to permit communication. Further, V2V communication may be used between two vehicles 1501 to share telematics data or to provide a communication path for vehicle diagnostic data, OBD data, tracking data, and so on.

RFID antennas may also be used for proximity detection between vehicles. For example, RSSI associated with signals generated by one or more antennas (e.g., external RFID antennas 1420, cargo antennas 1430 and/or driver cab antennas 1440) located on a first vehicle (e.g., 1501(4)) may be captured by a second vehicle (e.g., 1501(5)), and used to determine how close the first and second vehicles are to one another. Thus, if a given vehicle is backing up or maneuvering nearby another vehicle where an antenna is, proximity-based analysis based on RSSI of RFID signals between the two vehicles can be used for warning/guiding a driver.

Where both vehicle 1501 are in a geographical area with poor wireless signal reception, each vehicle may exchange data destined for tracking system 700 that is stored by gateway nodes 1414 and/or 1512 until such time when communication with tracking system 700 is available (e.g., when the gateway nodes 1414, 1512 move to a geographic area where long-range communication is available, or when within Wi-Fi range of another node of tracking system 700). In some embodiments, a first vehicle with poor signal reception or connectivity to the cloud (e.g., external server 704) may transfer some data stored on its memory/storage (e.g., memory 1452) to a nearby second vehicle using V2V communication that is scheduled to depart soon. The second vehicle stores the received data from the first vehicle and a timestamp of when it received the data. The second vehicle departs and reaches a location with adequate cellular signal reception or adequate connectivity to the cloud via another communication network and uploads the data to a database (e.g., database 708) hosted on the cloud using cellular communications. If the first vehicle does not reach a location with adequate cellular signal or connectivity to the cloud before the second vehicle does, the cloud is able to be updated with the data from the first vehicle with lower latency than without V2V communication. When the first vehicle reaches an area of adequate cellular signal or cloud connectivity at an earlier time than the second vehicle, the second vehicle's upload of the data received from the first vehicle may be ignored or overwritten by the cloud server, in some embodiments. When the first vehicle reaches a location of adequate cellular signal or cloud connectivity at a later time than the second vehicle, the first vehicle may communicate with the cloud to update the database with the most recent data or confirm that the uploaded data from the second vehicle is still valid.

In some examples, data may be transmitted over LoRa-based communication connections to wireless nodes with LoRa communication capabilities (e.g., medium or high-power wireless communication interfaces as discussed above) or over 900 ISM-based communications using the external RFID antennas, since 900 ISM may be used by the RFID transceivers (sometimes by cellular and narrowband Internet of Things, NB-IOT). In certain embodiments, other wireless nodes of tracking system 700 relay the data to a cellular equipped wireless node (and/or a medium or high-power wireless communication interface as discussed above) which then uploads the data to server 704 of tracking system 700. In some embodiments, wireless gateway node 1414 and/or gateway node 1512 instructs other nearby wireless nodes of tracking system 700 to search for a backup communication path to server 704. For example, a backup path may be via one or more of (a) a gateway node installed at a building or other location, (b) another vehicle RFID gateway that has cellular or satellite communication capabilities, (c) a smartphone of a user or driver, or (d) via another wireless node associated with the tracking system 700.

Each vehicle 1501 operates RFID reader system 1400 using an RFID configuration 1458, illustratively shown stored in memory 1452 of RFID controller 1410, FIG. 14, that defines one or more of RFID channel, transmit power control, hopping protocol (multiplexing between frequency channels), RF beam profile, and receiver sensitivities. The RFID configuration settings 1458 may be determined internally by the RFID controller 1410, and/or are received from an external device and dynamically changed based on RFID configuration of nearby RFID systems. The external device may be one or more of a server (e.g. server 704 discussed above), another RFID controller associated with a different vehicle, or a warehouse management system. In one embodiment, the RFID configuration 1458 may change automatically based on location of the vehicle. For example, area 1501(1) may have a designated set of RFID configuration 1458, and area 2210(2) may have a second designated set of RFID configuration 1458. As each vehicle 1501 moves within the area encompassing areas 2210(1) and 2210(2), the RFID controller may automatically change to the designated set of RFID configuration 1458 associated with the given area 2210. Location of the vehicle may be determined using on-board navigation system, or other location determining means herein, or via an external device such as a camera, etc. Vehicle-to-vehicle communication may also be used to resolve or avoid RFID interference between two vehicles that are near one another. RFID interference occurs when both vehicles are using the same, or similar, RFID configuration. System parameters, such as one or more of RFID channel, hopping protocol (multiplexing between frequency channels), and high receiver sensitivities may be altered in one vehicle to avoid interference. In one example of operation, to avoid or resolve any RFID interference, two vehicles 1501(5) and 1501(5) may (a) determine that they are near one another, and (b) exchange RFID configuration 1458 and thereby learn of potential interference. Accordingly, RFID controller 1410 may dynamically change parameters of RFID configuration 1458 to avoid interference from nearby vehicles. For example, where RFID controller 1410 within vehicle 1501(4) receives, from nearby vehicle 150(5)1, RFID configuration 1458 defining an RFID channel and hopping protocol that is the same as its current RFID configuration 1458, it may change one or both of its RFID channel and hopping protocol to avoid or resolve interference. RFID controller 1410 may change any parameters of RFID configuration 1458 as needed. In certain embodiments, RFID controller 1410 in each vehicle 1501(4) and 1501(5) may communicate potential changes to RFID configuration 1458 prior to making them and thereby avoid further interference issues.

Vehicle 1501 may include a gateway node 1512 (see FIGS. 15 and 17) that is independent of RFID reader system 1400. Gateway node 1512 may represent any one of the short range, medium range, and long range adhesive tape platform tape nodes shown in FIGS. 6A-6C and FIG. 8, and/or one of mobile gateways 710 and 712 of FIG. 7. Gateway node 1512 may communicate with other nodes of tracking system 700, such as to provide tracking of vehicle 1501 and/or of non-RFID based assets. In certain embodiments, gateway node 1512 stores RFID configuration 1458 and communicates with similar gateway nodes on other vehicles to exchange RFID configuration 1458 and thereby avoid interferences due to proximity. Gateway node 1512 may communicate received RFID configurations received from a gateway node on another vehicle to its local RFID controller 1410, via wireless gateway node 1414 for example, whereby RFID controller 1410 may change its own RFID configuration 1458 to avoid interference with the other vehicle. RFID controller 1410 may send RFID configuration 1458 to gateway node 1512 whenever it is changed such that it may be shared with other nearby vehicles by gateway node 1512.

### Additional Configuration Information

The foregoing description of the embodiments of the disclosure have been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

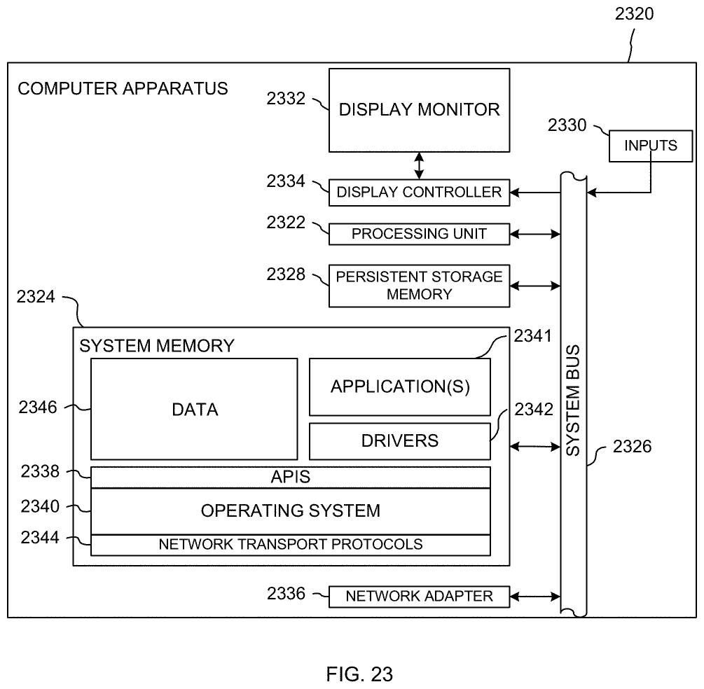

FIG. 23 shows an example embodiment of computer apparatus 2320 that, either alone or in combination with one or more other computing apparatus, is operable to implement one or more of the computer systems described in this specification. For example, computer apparatus 2320 may represent computing apparatus of any of segments 113 of FIGS. 1 and 2, wireless transducing circuit 410 of FIG. 4, segments 640, 670, and 680 of FIGS. 6A-6C, and any of the tape nodes derived therefrom, and server 704 of FIG. 7. Computer apparatus 2320 may also represent computing apparatus of any of RFID controller 1410, RFID reader 1412, and wireless gateway node 1414 of FIG. 14. The computer apparatus 2320 includes a processing unit 2322, a system memory 2324, and a system bus 2326 that couples the processing unit 2322 to the various components of the computer apparatus 2320. The processing unit 2322 may include one or more data processors, each of which may be in the form of any one of various commercially available computer processors. The system memory 2324 includes one or more computer-readable media that typically are associated with a software application addressing space that defines the addresses that are available to software applications. The system memory 2324 may include a read only memory (ROM) that stores a basic input/output system (BIOS) that contains start-up routines for the computer apparatus 2320, and a random-access memory (RAM). The system bus 2326 may be a memory bus, a peripheral bus, or a local bus, and may be compatible with any of a variety of bus protocols, including PCI, VESA, Microchannel, ISA, and EISA. The computer apparatus 2320 also includes a persistent storage memory 2328 (e.g., a hard drive, a floppy drive, a CD ROM drive, magnetic tape drives, flash memory devices, and digital video disks) that is connected to the system bus 2326 and contains one or more computer-readable media disks that provide non-volatile or persistent storage for data, data structures and computer-executable instructions.

A user may interact (e.g., input commands or data) with the computer apparatus 2320 using one or more input devices 2330 (e.g. one or more keyboards, computer mice, microphones, cameras, joysticks, physical motion sensors, and touch pads). Information may be presented through a graphical user interface (GUI) that is presented to the user on a display monitor 2332, which is controlled by a display controller 2334. The computer apparatus 2320 also may include other input/output hardware (e.g., peripheral output devices, such as speakers and a printer). The computer apparatus 2320 connects to other network nodes through a network adapter 2336 (also referred to as a “network interface card” or NIC).

A number of program modules may be stored in the system memory 2324, including application programming interfaces 2338 (APIs), an operating system (OS) 2340 (e.g., the Windows® operating system available from Microsoft Corporation of Redmond, Wash. U.S.A.), software applications 2341 including one or more software applications programming the computer apparatus 2320 to perform one or more of the steps, tasks, operations, or processes of the positioning and/or tracking systems described herein, drivers 2342 (e.g., a GUI driver), network transport protocols 2344, and data 2346 (e.g., input data, output data, program data, a registry, and configuration settings).

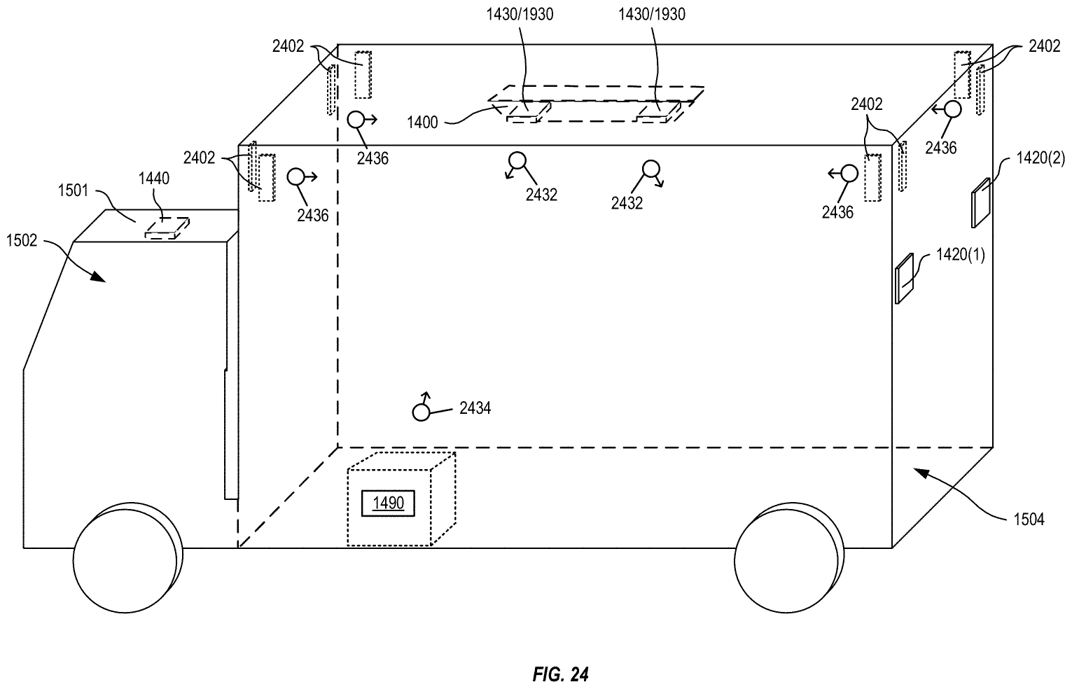

FIG. 24 is a perspective diagram illustrating example use of reference RFID reader tape nodes 2402 within a vehicle 1501 to improve the fidelity of RFID reader system 1400 of FIGS. 14-20, in embodiments. The RFID reader tape nodes 2402 may be any of the above-discussed tape nodes discussed with reference to FIGS. 1-13. As shown, a pair of RFID reader tape nodes 2402 are attached to each top internal corner of cargo area 1504. More or fewer RFID reader tape nodes 2402 may be used without departing from the scope hereof. Each RFID reader tape node includes at least an RFID receiver, and a wireless communication system for transmitting data based on received RFID signals. In embodiments, each RFID reader tape node 2402 may also include an RFID transmitter for transmitting RFID interrogation signals. However, in embodiments where the RFID reader tape node 2402 does not include the RFID transmitter, the RFID reader tape node 2402 reduces its operational power consumption because the line-powered RFID antenna 1430 in the RFID system 1400/1600/1900 supplies the higher-power requiring interrogation signal.

The RFID reader tape nodes 2402 may be wireless RFID readers similar to the slot RFID tape nodes 2006, 2110 discussed above (or any other wireless tape node discussed herein. The RFID reader tape nodes 2402 provide the advantage of customized placement and flexibility in achieving high-fidelity monitoring of the cargo area. As such, the RFID reader tape nodes 2402 may be used in replacement of, or additionally to, RFID antennas 1430. In the monolithic configurations 1600/1900, the RFID reader tape nodes may supplement the central RFID antenna 1430 located in the monolithic housing without requirement of additional cables connecting the RFID reader tape nodes 2402 to the monolithic housing.

In one example of operation, RFID reader system 1400 interrogates RFID tags 1490 attached to assets by transmitting a interrogation signal 2432 from one or more RFID antenna 1430 (or one or more RFID reader nodes 2402). One or more of the RFID reader node 2402 measures a signal strength of a RFID response signal 2434 generated by each RFID tag 1490 and generates a relayed response 2436 which may be transmitted back to the RFID reader system 1400. The relayed response 2436 may be transmitted back to the gateway node 1414 using wireless communication, e.g. a wireless communication method and system other than RFID, in some embodiments. In further embodiments, Bluetooth-based communications are used to communicate between the gateway node 1414 and the RFID reader tape nodes.

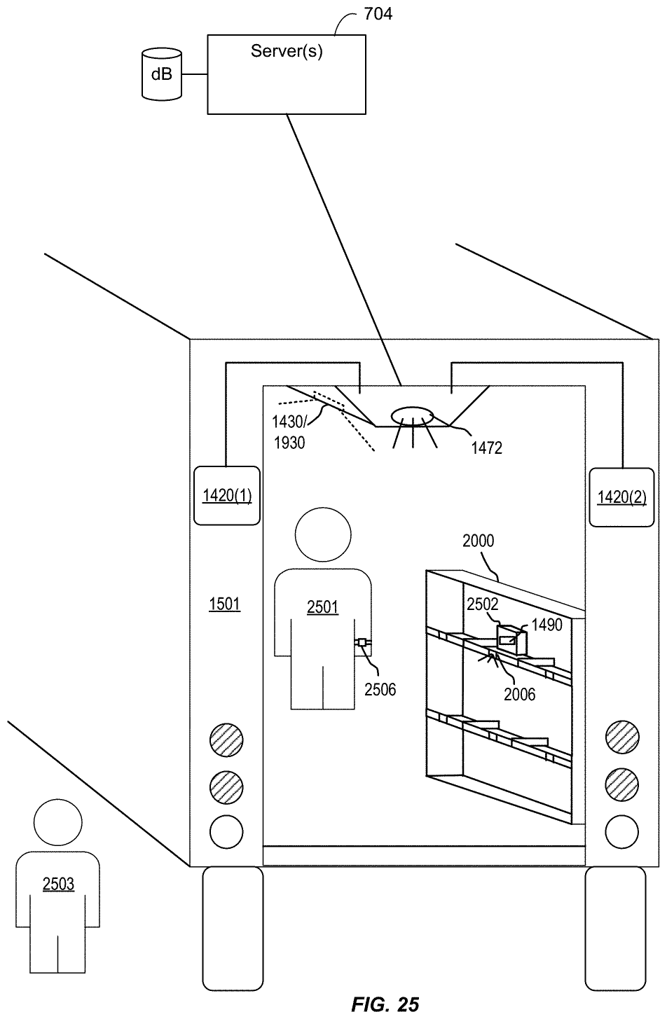

FIG. 25 shows an example operating environment of the RFID reader system 1400, in embodiments. A user 2501 loads package 2502 into cargo area of vehicle 1501, which is an example of the above-discussed assets. Package 2502 has a RFID tag 1490 attached to it. As the user 2501 (or another user, or the package via a conveyor belt) approaches entrance 2506 to of the vehicle 1501, rear-facing external RFID antennas 1420 may identify tag 1490, and compare it to a manifest (e.g., manifest 1456 discussed above). Additionally the RFID reader system 1400 is able to distinguish if the RFID tag 1490 is inside of the vehicle 1501, outside of the vehicle 1501, currently being loaded into the vehicle 1501, and currently being unloaded from the vehicle 1501. These functions may also be triggered using one or more of the above-described components of RFID reader system 1400, including those described with respect to monolithic reader system 1600 and/or 1900. Because RFID reader system 1400 includes locally-stored manifest 1456, the RFID reader system 1400 is capable of in near-real time (e.g., within seconds as opposed to minutes, or within less than a second) provide an indication of whether the correct asset is being loaded, or whether an incorrect asset is being loaded. This indication may be in the form of controller 1410 activating status indicator 1472 (e.g., one or more of turn on the indicator, turn the indicator to a designated color, flash the indicator, and the like) such that a visual indication is observable by the user 2501 and/or user 2503. Other indications may be implemented, such as audio or tactile indication (e.g., using audio generator 1474). The other indications may additionally or alternatively be implemented using an external device, such as via transmission of an indicator instruction to a device 2506 worn by one or both of users 2501 and 2503 that causes the device 2506 to vibrate. The device 2506 need not be a watch, or wearable, but may be a device used by the user 2501 or user 2503, such as a smartphone, personal device, local display nearby the user 2501/2503, etc. The indication to the external device may be implemented using RFID transmission, or other wireless transmission protocol, such as Bluetooth connectivity between the RFID controller 1410 (or wireless gateway node 1414) and the external device 2506. The user 2501 (or another user outside of the vehicle assisting with loading/unloading of assets within the vehicle) may then have real-time feedback of correct loading as opposed to other systems which require transmission of an alert to a server, and then relay back to a given indication device. Such non-local indication lags and is not appropriate for the fast-paced interaction required a distribution centers and loading/unloading zones.

FIG. 25 also shows the optional slot tracking system 2000 (but it is not necessary in all embodiments). In embodiments using slot tape nodes 2006 (only one of which is labeled in FIG. 25 for clarity) that have integral indicator 2104 and/or a display 2106, the slot tape nodes 2006 may determine whether the package is properly loaded into the correct slot. If so, or if the asset 2502 in the slot is due for delivery, the slot tape nodes 2006 may activate (e.g., one or more of turn on the indicator, turn the indicator to a designated color, flash the indicator, and the like) the indicator 2104 to indicate proper/improper/or current loading/unloading.

Although local indication is provided by the system shown in FIG. 25 (and discussed above regarding wireless RFID reader systems 1400/1600/1900), it should be appreciated that the RFID controller 1410 may still be in operational communication with an external server (e.g., server 704 discussed above) for providing information to (e.g., alerts and/or status updates regarding loaded assets within cargo area and/or driver cabin) and receiving information from (e.g., manifest 1456).

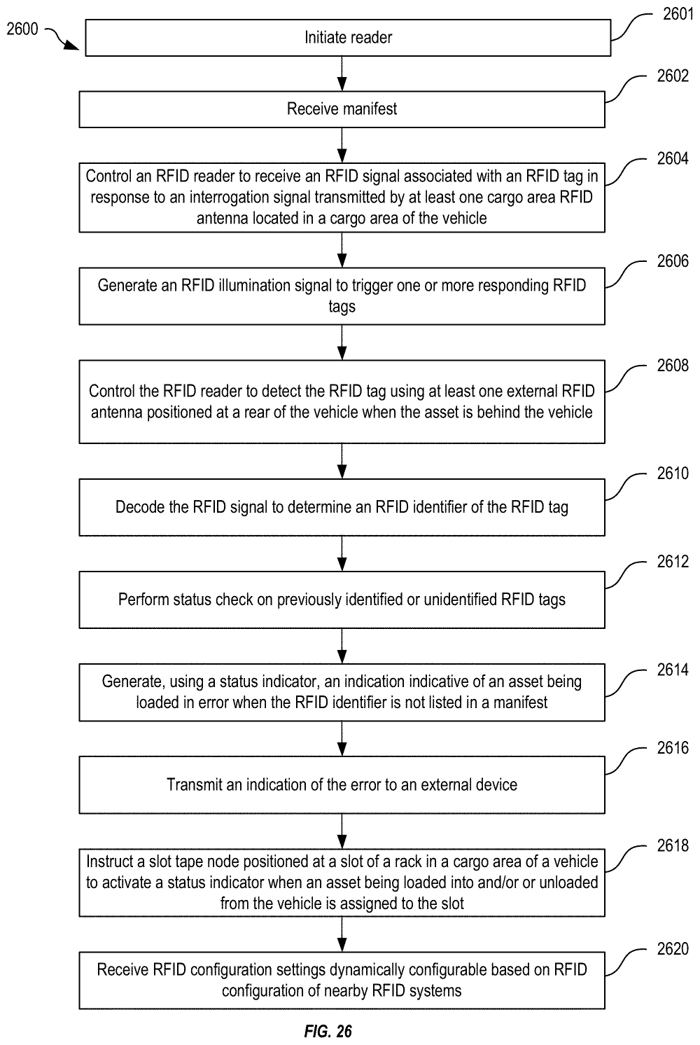

FIG. 26 is a flowchart showing one example method 2600 for detecting and tracking assets in a vehicle, in embodiments. Method 2600 is implemented using the RFID wireless system 1400, 1600, and/or 1900 discussed above in FIGS. 14-24, such as using RFID controller 1410, for example.

In block 2601, the RFID wireless system is initiated. In one example of block 2601, a proximity sensor (e.g., proximity sensor 1478 located internal to the RFID reader system 1400/1600/1900, or an external proximity sensor located in the vehicle or proximate thereto) may be used to wake up the RFID controller 1410 and to start scanning the cargo area using cargo area RFID antennas 1430 and/or proximate area nearby the vehicle using external RFID antenna 1420 and/or driver cabin using driver cabin RFID antenna 1440. In alternate or additional example, a door open/close sensor on one of the vehicle's doors may be used to wake up the RFID controller 1410. In alternate or additional example, the RFID wireless system is initiated in response to the RFID controller 1410, or an external device thereto detecting change in momentum of the vehicle using an accelerometer, change in location data (including GPS), or other system change that may be used as a trigger point for waking up the RFID controller and/or reader and scanning for egress/ingress or updating the status of loaded assets.

In block 2602, method 2600 receives a manifest. In one example of block 2602, RFID controller 1410 receives manifest 1456. The manifest 1456 may be received from an external device, such as server 704 of FIG. 7 discussed above.

In block 2604, the method 2600 controls an RFID reader to receive an RFID signal associated with an RFID tag in response to an interrogation signal transmitted by at least one cargo area RFID antenna located in a cargo area of the vehicle. In one example of block 2604, RFID controller 1410 controls RFID reader 1412 to receive RFID response 1434 in response to RFID interrogation signal 1432 being transmitted by one or more of RFID antenna 1420, cargo area RFID antenna 1430, and driver cabin RFID antenna 1440.

Method 2600 may optionally include block 2606 performed prior to block 2604. In block 2606, the method 2600 generates an RFID illumination signal to trigger one or more responding RFID tags. In on example of block 2606, the RFID controller 1410 controls one or more of RFID antenna 1420, cargo area RFID antenna 1430, and driver cabin RFID antenna 1440 to generate RFID illumination signal 1432 as discussed above. If block 2606 is included, in certain embodiments, block 2604 may include receiving an RFID signal as a relayed RFID response signal from an RFID device other than the one or more responding RFID tags. Using the relayed response signal embodiments provides the advantage that fidelity of the system may be increased because the response signal 1434 generated by the RFID tag 1490 responding to interrogation signal 1432 may have too much noise for accurate and specific location determination if it was required to be detected by the ceiling-mounted RFID reader 1412. Using other RFID devices (such as other ones of the RFID tags 1490, or the slot tape nodes 2006 discussed above, allows the fidelity of the location detection to be improved because the response signal 1434 generated by the responding one of the RFID tags 1490 is detected by another RFID device that is closer to the responding one of the RFID tags 1490, or detected by multiple other RFID devices and then triangulated or subjected to multilateration to improve the accuracy of the position/location determination.

Method 2600 may additionally optionally include block 2608 performed prior to blocks 2604 and/or 2606. If block 2608 is included, method 2600 controls the RFID reader to detect the RFID tag using at least one external RFID antenna positioned at a rear of the vehicle when the asset is behind the vehicle. In one example of operation of block 2608, RFID controller 1410 controls RFID reader 1412 to detect an oncoming RFID tag 1490 using one or more external RFID antenna 1420 that is positioned on the rear of vehicle 1501. Detection of the oncoming RFID tag 1490 may initiate other steps in method 2600, such as blocks 2604 and 2606 to save power consumption when no RFID tag 1490 is expected. Alternate or additional embodiments of block 2608 my include using a proximity sensor (e.g., proximity sensor 1478, or camera 1482) to determine when an object is approaching the RFID wireless system 1400 to initiate aspects of method 2600.

In block 2610, method 2600 decodes the RFID signal to determine an RFID identifier of the RFID tag. In one example of block 2610, the RFID controller 1410 decodes the received RFID signal (either the directly received RFID response signal 1434, or a relayed implementation thereof), to determine an RFID identifier 1492 associated with the responding RFID tag 1490.

Method 2600 may additionally optionally include block 2612. In block 2612, method 2600 performs a status check on previously identified or unidentified RFID tags. In one example of block 2612, method 2600 determines, based on previous controlling and decoding iterations, that the RFID identifier is newly detected and/or no longer detected. In one example of block 2612, RFID controller 1410 compares previously determined RFID identifiers 1492 received within a threshold period prior to the currently-identified RFID identifier to determine that the currently-identified RFID identifier is newly detected and/or a previously-identified RFID identifier is no longer detected. This allows method 2600 to ignore responding RFID tags 1490 that have already been analyzed, and also allows method 2600 to determine when an RFID tag 1490 that may have been loaded in error has been removed from the vehicle.

In another example of block 2612, RFID controller 1410 updates a list of “currently loaded” assets by re-scanning all RFID tags 1490 (e.g., transmitting an RFID interrogation signal and receiving an RFID response signal or relayed RFID response signal associated with each RFID tag 1490) currently located within the cargo area. Block 2612 may be triggered based on a current operational status of the vehicle 1501, or other trigger. For example, block 2612 may be triggered when the vehicle stops for a threshold period, periodically triggered, triggered in response to identification of a wireless network (e.g., identification of a network associated with a distribution center or other warehouse), location of the vehicle, and the like. The RFID controller 1410 may then store any changes or differences from the manifest 1456 and report said changes or differences to an external device such as server 704.

In block 2614, method 2600 generates, using a status indicator, an indication indicative of an asset being loaded in error when the RFID identifier is not listed in a manifest or not in error when the RFID identifier corresponds to the manifest. In one example of block 2600, controller 1410 controls status indicator 1472 to provide an indication (e.g., visual, audio, or tactile indication) when the asset associated with RFID tag 1490 associated with the RFID identifier determined in block 2610 is not listed in manifest 1456.

Method 2600 may additionally optionally include block 2616. In block 2616, method 2600 transmits an indication of the error or non-error to an external device. In one example of block 2616, the RFID controller 1410 transmits an indication of the error or non-error to an external device. For example, the RFID controller 1410 may transmit an indication of the error to external server 704 discussed above with respect to FIG. 7. Block 2616 may be implemented using wireless gateway node 1414 discussed above. Additionally or alternatively, block 2616 may be implemented using one or more external RFID antennas 1420. For example, as discussed above with respect to FIG. 22, the RFID controller 1410 may relay communication between one or more vehicles when each of the vehicles 1501 has an external RFID antenna 1420 that is facing another external RFID antenna 1420 of another vehicle. This allows the advantage of transmitting data to an external server (or other device) even when communication via wireless gateway node 1414, or another communication system, is unavailable. The transmittal of the indication may cause the overall asset management system (that the external server 704 may be associated with) to perform at least one of: canceling a shipment, diverting another shipment of another similar asset, changing a delivery window time, or issuing a new shipment in response to the asset not being removed from the vehicle

Method 2600 may additionally be implemented using the rack system discussed above with respect to FIGS. 20-21. For example, method 2600 may additionally include block 2618. In block 2618, method 2600 instructs a slot tape node positioned at a slot of a rack in a cargo area of a vehicle to activate a status indicator when an asset being loaded into and/or or unloaded from the vehicle is assigned to the slot. In one example of block 2618, a slot tape node 2006 receives an instruction from RFID controller 1410 (or otherwise determines the instruction locally) to activate a status indicator of the slot tape node 2006 when an asset being loaded into and/or unloaded from the vehicle is assigned to the slot 2004. Correlation of the asset being loaded into and/or unloaded from the vehicle is assigned to the slot 2004 may be determined by comparing (e.g., by the slot tape node 2006 and/or the RFID controller 1410) the received RFID identifier 1492 to the manifest 1456. Moreover, additional information may be used to determine what slot 2004 the asset is to be loaded into, such as location of the vehicle to determine that the asset is at it's destination location for delivery, and/or size and shape of the asset and/or slot to determine necessary available space for storing the asset in the slot. Additional functionality discussed above with respect to FIGS. 20-21 may be implemented in addition to block 2618 and in conjunction with or without other blocks of method 2600.

Aspects of method 2600 may be modified based on the overall RFID wireless environment that the method 2600 is being implemented in. For example, block 2620, if included in method 2600, includes receiving RFID configuration settings dynamically configurable based on RFID configuration of nearby RFID systems, wherein the controlling an RFID reader includes operating the at least one cargo area RFID antenna according to the RFID configuration settings. In one example of block 2620, the RFID controller 1410 may receive RFID configuration settings 1458, either from an external device or locally determined by the RFID controller 1410, that are dynamically configurable based on RFID configuration of nearby RFID systems. Block 2604-2610 may then be implemented using the RFID configuration settings 1458. In examples of block 2620, the configuration settings 1458 are further identified using location of the vehicle that the RFID controller 1410 is installed. As discussed above with respect of FIG. 22, a given wireless environment may be divided into areas 2210, and the RFID configuration settings 1458 may automatically change when the RFID controller 1410 identifies that it has transitioned from one area 2210 to a second area 2210. Additionally and/or alternatively, the RFID controller 1410 may receive RFID signals generated by another RFID system, and manipulate its own RFID configuration 1458 to prevent interference with the another RFID system.

Additional functionality discussed above with respect to FIGS. 14-24 may be included in method 2600, even if not expressly stated herein. As such, it should be appreciated that the functionality discussed herein may be implemented using one or more software, hardware, and firmware modules that operate according to computer-readable instructions that when executed by a processor operate to control the given system to implement said functionality.

Thus, it should be appreciated that the RFID reader systems may be utilized with other spaces other than cargo vehicles. For example, the wireless RFID reader systems may be utilized with passenger transport vehicles (such as a bus, train, plane, rideshare vehicle, etc.), where the RFID tag 1490 is associated with a passenger who is utilizing the passenger transport vehicle. The “cargo area” in the passenger transport vehicle need not be a component of the vehicle itself, but may also be an intermediate loading device, such as a jet bridge in an airport gate, etc., wherein the RFID system is operating to identify passengers loading/unloading a plane (or train, etc.) as they pass through the intermediate loading device. Additionally, the RFID reader systems discussed herein may be applied to any enclosed spaces, such as spaces with Faraday caging/interference (e.g., shipping containers, etc.), warehouses, storage facilities, residences, cold storage (refrigerators and/or freezers), etc. without departing from the scope hereof. The RFID reader systems may also be used in multiple portions of vehicles, such as a trailer, a tractor, a coach, a recreational vehicle, or other examples of vehicles.

### Combination of Features

In embodiment (A1) of a first aspect, a system for a detecting and tracking assets in a vehicle, comprises: an RFID reader; at least one cargo area RFID antenna positioned within a cargo area of the vehicle and communicatively coupled with the RFID reader; and an RFID controller comprising: a status indicator for generating a visual indication; a processor; and memory, communicatively coupled with the processor and storing: a manifest defining RFID identifiers corresponding to assets expected to be transported by the vehicle; and firmware having machine-readable instructions that, when executed by the processor, cause the processor to: control the RFID reader to receive an RFID signal from an RFID tag using one of the at least one cargo area RFID antenna, decode the RFID signal to determine an RFID identifier of the RFID tag, and generate, using the status indicator, a visual indication indicative of an asset being loaded in error when the RFID identifier does not correspond to the manifest or not in error when the RFID identifier corresponds to the manifest.

In embodiment (A2) of the first aspect, in the embodiment (A1), the system further comprises a gateway node having wireless communication capability to communicate with a tracking system, wherein the manifest is received via the gateway node from a server of the tracking system.

In embodiment (A3) of the first aspect, in either of the embodiments (A1) or (A2), the firmware further comprises machine-readable instructions that, when executed by the processor, cause the processor to determine, based on previous control and decode iterations, that the RFID identifier is newly detected.

In embodiment (A4) of the first aspect, in any of the embodiments (A1) through (A3), the firmware further comprises machine-readable instructions that, when executed by the processor, cause the processor to determine, based on previous control and decode iterations, that the RFID identifier is no longer detected.

In embodiment (A5) of the first aspect, in any of the embodiments (A1) through (A4), the machine-readable instructions that, when executed by the processor, cause the processor to generate, using the status indicator, a visual indication indicative of an asset being loaded in error when the RFID identifier does not correspond to the manifest, include identifying that the RFID identifier listed in the manifest does not have a delivery address within a threshold distance of a current location of the vehicle or a predefined route of the vehicle.

In embodiment (A6) of the first aspect, in any of the embodiments (A5), the current location of the vehicle is determined using global navigation satellite system (GNSS).

In embodiment (A7) of the first aspect, in any of the embodiments (A5) or (A6), the current location of the vehicle is received from a navigation system of the vehicle.

In embodiment (A8) of the first aspect, in any of the embodiments (A1) through (A7), the RFID tag being an RFID tape node.

In embodiment (A9) of the first aspect, in any of the embodiments (A1) through (A8), the firmware further comprising machine-readable instructions that, when executed by the processor, cause the processor to control the RFID reader to generate an electromagnetic interrogation pulse using one of the at least one cargo area RFID antenna.

In embodiment (A10) of the first aspect, in any of the embodiments (A1) through (A9), wherein an electromagnetic interrogation pulse is generated by an antenna external to the system.

In embodiment (A11) of the first aspect, in any of the embodiments (A1) through (A10), the system further comprises: at least one slot tape node positioned respectively at a slot of a rack in the vehicle and having a status indicator; and the firmware further comprising machine-readable instructions that, when executed by the processor, cause the processor to send an instruction to the slot tape node to activate the status indicator when the asset being loaded is assigned to the slot.

In embodiment (A12) of the first aspect, in any of the embodiments (A11), the manifest defining the slot assigned to the asset.

In embodiment (A13) of the first aspect, in any of the embodiments (A11) or (A12), the slot being one of a plurality of slots within the vehicle, each of the plurality of slots having one or more of the at least one slot tape node.

In embodiment (A14) of the first aspect, in any of the embodiments (A13), each of the slot tape nodes being configured with an operational RFID range limited to detect RFID tags within its slot.

In embodiment (A15) of the first aspect, in any of the embodiments (A11) through (A14), the firmware further comprising machine-readable instructions that, when executed by the processor, cause the processor to instruct the slot tape node to activate its status indicator when the asset in the slot is to be unloaded from the vehicle.

In embodiment (A16) of the first aspect, in any of the embodiments (A1) through (A15), the system further comprises: a driver cabin RFID antenna electrically coupled with the RFID reader; and the firmware further comprising machine-readable instructions that, when executed by the processor, cause the processor to control the RFID reader to detect the RFID tag using the driver cabin RFID antenna when the asset is moved from a cargo area of the vehicle to the driver cabin.

In embodiment (A17) of the first aspect, in any of the embodiments (A1) through (A16), the system further comprises: at least one external RFID antenna mounted at a rear end of the vehicle and facing rearwards; and the firmware further comprising machine-readable instructions that, when executed by the processor, cause the processor to control the RFID reader to detect the RFID tag using the at least one external RFID antenna when the asset is behind the vehicle.

In embodiment (A18) of the first aspect, in any of the embodiments (A17), the firmware further comprises machine-readable instructions that, when executed by the processor, cause the processor to determine that the asset is being delivered when the RFID tag is detected by the at least one external RFID antenna.

In embodiment (A19) of the first aspect, in any of the embodiments (A1) through (A18), wherein the RFID reader, the at least one cargo area RFID antenna, and the RFID controller are co-housed in a monolithic housing.

In embodiment (A20) of the first aspect, in any of the embodiments (A19), the monolithic housing configured to retrofit a cargo area via one or more of, coupling to a ceiling of the cargo area, coupling to ribs within the cargo area, and replacing an existing lamp within the cargo area.

In embodiment (A21) of the first aspect, in any of the embodiments (A19) through (A20), the system further comprises a connector for coupling with additional RFID antennas located external to the monolithic housing.

In embodiment (A22) of the first aspect, in any of the embodiments (A19) through (A21), the system further comprises one or more of a proximity sensor, a vehicle interface for communicating with components of the vehicle, a camera, an input device, a light, and an audio generator.

In embodiment (A23) of the first aspect, in any of the embodiments (A1) through (A22), the system further comprising a power manager coupled to the RFID reader, the at least one cargo area RFID antenna, and the RFID controller to provide power thereto.

In embodiment (A24) of the first aspect, in any of the embodiments (A23), the power manager coupled to a vehicle power source of the vehicle.

In embodiment (A25) of the first aspect, in any of the embodiments (A1) through (A24), the memory further storing RFID configuration settings, wherein the RFID configuration settings are received from an external device and dynamically configurable based on RFID configuration of nearby RFID systems.

In embodiment (A26) of the first aspect, in any of the embodiments (A25), the external device being one or more of a server, another RFID controller associated with a different vehicle, or a warehouse management system.

In embodiment (A27) of the first aspect, in any of the embodiments (A25) through (A26), the RFID configuration settings defining one or more of RFID channel, transmit power control, hopping protocol, and receiver sensitivities for operating the at least one cargo RFID antenna or another RFID antenna.

In embodiment (A28) of the first aspect, in any of the embodiments (A1) through (A27), the firmware storing further computer-readable instructions that, when executed by the processor, cause the system to transmit an indication of the error to an external device.

In embodiment (A29) of the first aspect, in any of the embodiments (A1) through (A28), the system further comprising an external RFID antenna positioned on an exterior of the vehicle, wherein the transmit an indication of the error includes transmitting an indication of the error using the external RFID antenna to another vehicle for relay to an external server.

In embodiment (A30) of the first aspect, in any of the embodiments (A1) through (A29), the firmware storing further computer-readable instructions that, when executed by the processor, cause the system to generate an RFID illumination signal to trigger one or more responding RFID tags, wherein the control an RFID reader includes receive an RFID signal as a relayed RFID response signal from an RFID device other than the one or more responding RFID tags.

In embodiment (A31) of the first aspect, in any of the embodiments (A30), the RFID device being a slot RFID device attached to a package rack within the vehicle.

In embodiment (A32) of the first aspect, in any of the embodiments (A30) through (A31), the RFID device being a RFID tag located on an asset other than the RFID tag associated with the RFID identifier.

In embodiment (B1) of a second aspect, a method comprises: receiving data indicative of a potential change in a load status of assets in a vehicle; in response, controlling an RFID reader to generate an interrogation signal by at least one cargo area RFID antenna located in a cargo area of the vehicle and receive an RFID signal associated with an RFID tag attached to an asset in response to the interrogation signal; determining that an asset is being loaded onto the vehicle based on the received RFID signal; decoding the RFID signal to determine an RFID identifier of the RFID tag; updating a local database stored on a device in the vehicle with the RFID identifier; and tracking the location of the asset within the interior of the vehicle, based on further received RFID signals from the RFID tag.

In embodiment (B2) of the second aspect, in the embodiment (B1), the determining if the asset is being loaded onto the vehicle based on detecting a trajectory of the asset corresponding to entry into the vehicle based on received signal strength of the received RFID signal associated with the RFID tag.

In embodiment (B3) of the second aspect, in either embodiment (B1) or (B2), the method further comprises: comparing the RFID identifier to a received manifest; determining that the asset was erroneously loaded onto the vehicle based on the RFID identifier not being included in the received manifest; notifying a user that the asset was erroneously loaded, within a threshold period of time from when the user began loading the vehicle with the asset.

In embodiment (B4) of the second aspect, in any of the embodiments (B3), wherein the notifying the user comprises activating an indicator on the vehicle.

In embodiment (B5) of the second aspect, in any of the embodiments (B3) through (B4), wherein the notifying the user comprises sending a notification or message to a client device associated with the user.

In embodiment (B6) of the second aspect, in any of the embodiments (B1) through (B5), the method further comprises, responsive to the asset not being removed from the vehicle after notifying the user, communicating with a server to update a database on the asset being located on the vehicle.

In embodiment (B7) of the second aspect, in any of the embodiments (B6), the method further comprising, performing at least one of: canceling a shipment, diverting another shipment of another similar asset, or issuing a new shipment in response to the asset not being removed from the vehicle.

In embodiment (B8) of the second aspect, in any of the embodiments (B1) through (B7), wherein receiving data indicative of a potential load status of assets in the vehicle further comprises receiving sensor data that corresponds to a user entering or exiting the vehicle.

In embodiment (B9) of the second aspect, in any of the embodiments (B8), further comprising detecting the opening or closing of a door of the vehicle.

In embodiment (B10) of the second aspect, in any of the embodiments (B9), wherein the door is a door leading from a driver's cabin to a cargo storage area of the vehicle.

In embodiment (B11) of the second aspect, in any of the embodiments (B9), wherein the door is a door leading from outside of the vehicle to an interior of the vehicle.

In embodiment (B12) of the second aspect, in any of the embodiments (B1) through (B11), further comprising detecting that the asset has moved from a first location inside of the vehicle to a second location inside of the vehicle based on the further received RFID signals from the RFID tag.

In embodiment (B13) of the second aspect, in any of the embodiments (B1) through (B12), further comprising detecting that the asset has moved from a cargo area to a driver's cabin.

In embodiment (B14) of the second aspect, in any of the embodiments (B1) through (B13), further comprising detecting that the asset has moved from a driver's cabin to a cargo area.

In embodiment (B15) of the second aspect, in any of the embodiments (B1) through (B14), further comprising: receiving an inquiry on the location of the asset within the interior of the vehicle, and sending location data corresponding to the location of the asset within the interior of the vehicle, in response.

In embodiment (B16) of the second aspect, in any of the embodiments (B1) through (B17), wherein the location data comprises a rack identifier corresponding to a location on a rack in the vehicle that is holding the asset.

In embodiment (C1) of a third aspect, a method for a detecting and tracking assets in a vehicle, comprising: controlling an RFID reader to receive an RFID signal associated with an RFID tag in response to an interrogation signal transmitted by at least one cargo area RFID antenna located in a cargo area of the vehicle; decoding the RFID signal to determine an RFID identifier of the RFID tag; and generating, using a status indicator, a visual indication indicative of an asset being loaded in error when the RFID identifier is not listed in a manifest or not in error when the RFID identifier corresponds to the manifest.

In embodiment (C2) of the third aspect, in the embodiment (C1), further comprising receiving the manifest from a server of a tracking system.

In embodiment (C3) of the third aspect, in either of the embodiments (C1) or (C2), the method further comprises determining, based on previous controlling and decoding iterations, that the RFID identifier is newly detected.

In embodiment (C4) of the third aspect, in any of the embodiments (C1) through (C3), the method further comprises determining, based on previous controlling and decoding iterations, that the RFID identifier is no longer detected.

In embodiment (C5) of the third aspect, in any of the embodiments (C1) through (C4), the method further comprises generating the visual indication includes identifying the asset being unloaded in error when the RFID identifier listed in the manifest does not have a delivery address within a threshold distance of a current location of the vehicle or a predefined route of the vehicle.

In embodiment (C6) of the third aspect, in any of the embodiments (C5), the method further comprising determining the current location of the vehicle using a global navigation satellite system (GNSS).

In embodiment (C7) of the third aspect, in any of the embodiments (C5) through (C6), further comprising receiving the current location of the vehicle from a navigation system of the vehicle.

In embodiment (C8) of the third aspect, in any of the embodiments (C1) through (C7), further comprising generating an electromagnetic interrogation pulse using at least one cargo area RFID antenna.

In embodiment (C9) of the third aspect, in any of the embodiments (C1) through (C8), further comprising instructing a slot tape node positioned at a slot of a rack in a cargo area of a vehicle to activate a status indicator when an asset being loaded into the vehicle is assigned to the slot.

In embodiment (C10) of the third aspect, in any of the embodiments (C9), wherein the manifest defines the slot assigned to the asset.

In embodiment (C11) of the third aspect, in any of the embodiments (C9) through (C10), wherein the slot is one of a plurality of slots within the vehicle, and each of the plurality of slots has a slot tape node.

In embodiment (C12) of the third aspect, in any of the embodiments (C11), wherein each of the slot tape nodes is configured with an operational RFID range that is configured in a manner to primarily detect RFID tags within its slot.

In embodiment (C13) of the third aspect, in any of the embodiments (C11) through (C12), the method further comprising instructing the slot tape node to activate its status indicator when an asset in the slot is to be unloaded from the vehicle.

In embodiment (C14) of the third aspect, in any of the embodiments (C11) through (C13), the method further comprising controlling the RFID reader to detect the RFID tag using a cabin RFID antenna position in a driver cabin of the vehicle when the asset is moved from the cargo area of the vehicle to the driver cabin.

In embodiment (C15) of the third aspect, in any of the embodiments (C11) through (C14), the method further comprising controlling the RFID reader to detect the RFID tag using at least one external RFID antenna positioned at a rear of the vehicle when the asset is behind the vehicle.

In embodiment (C16) of the third aspect, in any of the embodiments (C11) through (C15), the method further comprising determining that the asset is being delivered when the RFID tag is detected by at least one external RFID antenna.

In embodiment (C17) of the third aspect, in any of the embodiments (C1) through (C16), further comprising receiving RFID configuration settings dynamically configurable based on RFID configuration of nearby RFID systems, wherein the controlling an RFID reader includes operating the at least one cargo area RFID antenna according to the RFID configuration settings.

In embodiment (C18) of the third aspect, in any of the embodiments (C17), the RFID configuration settings being received from an external device, the external device being one or more of a server, another RFID controller associated with a different vehicle, or a warehouse management system.

In embodiment (C19) of the third aspect, in any of the embodiments (C17) through (C18), the RFID configuration settings defining one or more of RFID channel, transmit power control, hopping protocol, and receiver sensitivities for operating the at least one cargo RFID antenna or another RFID antenna of a vehicle.

In embodiment (C20) of the third aspect, in any of the embodiments (C1) through (C19), the method further comprising transmitting an indication of the error to an external device.

In embodiment (C21) of the third aspect, in any of the embodiments (C20), wherein the transmit an indication of the error includes transmit an indication of the error using an external RFID antenna to another vehicle for relay to an external server.

In embodiment (C22) of the third aspect, in any of the embodiments (C1) through (C21), further comprising generating an RFID illumination signal to trigger one or more responding RFID tags, wherein the controlling an RFID reader includes receiving an RFID signal as a relayed RFID response signal from an RFID device other than the one or more responding RFID tags.

In embodiment (C23) of the third aspect, in any of the embodiments (C22), the RFID device being a slot RFID device coupled to a package rack within the vehicle.

In embodiment (C24) of the third aspect, in any of the embodiments (C22), the RFID device being a RFID tag located on an asset other than the RFID tag associated with the RFID identifier.

In embodiment (D1) of a fourth aspect, a system for assisting in loading an unloading a vehicle, comprises: a rack having a plurality of slots each sized and shaped for storing an asset; a plurality of slot RFID devices each associated with one of the slots, each slot RFID device comprising: a wireless transducing circuit that facilitates communication with an RFID controller external to the slot RFID device, a processor, and memory storing computer-readable instructions that when executed by the processor cause the slot RFID device to respectively: identify one or more RFID tags located within the respective slot, transmit indication of presence of one or more RFID tags located within the slot.

In embodiment (D2) of the fourth aspect, in the embodiment (D1), wherein sensitivity and/or operational RFID range of the plurality of slot RFID devices are configured to primarily detected RFID tags primarily within the associated slot.

In embodiment (D3) of the fourth aspect, in any embodiment (D2), wherein the sensitivity and/or operational RFID range of the plurality of slot RFID devices configured based on manipulating one or more of RFID channel, transmit power control, hopping protocol, RF beam profile, and receiver sensitivity of each slot RFID device.

In embodiment (D4) of the fourth aspect, in any of the embodiments (D1) through (D3), at least some of the slot RFID devices further comprising an indicator and/or display.

In embodiment (D5) of the fourth aspect, in any of the embodiments (D4), the at least some of the RFID devices storing further computer-readable instructions that, when executed by the respective processor cause the at least some of the RFID devices to activate the indicator and/or display in response to identification of intended loading or unloading spot of an asset within the rack.

In embodiment (D6) of the fourth aspect, in any of the embodiments (D5), the at least some of the RFID devices storing additional computer-readable instructions that, when executed by the respective processor cause the at least some of the RFID device to receive instruction from an external device indicating the intended loading or unloading spot of an asset within the rack.

In embodiment (D7) of the fourth aspect, in any of the embodiments (D6), the intended loading or unloading spot being based on package size associated with the asset and shape or size of the associated slot.

In embodiment (D8) of the fourth aspect, in any of the embodiments (D1) through (D7), the plurality of RFID devices storing further computer-readable instructions that, when executed by the respective processor cause the respective RFID device to receive an RFID response signal from the RFID tag after an RFID interrogation signal is generated.

In embodiment (D9) of the fourth aspect, in any of the embodiments (D8), the RFID interrogation signal being generated by the RFID controller.

In embodiment (D10) of the fourth aspect, in any of the embodiments (D8), the RFID interrogation signal being generated by the respective RFID slot device.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for a detecting and tracking assets in a vehicle, comprising:
an RFID reader;
at least one cargo area RFID antenna positioned within a cargo area of the vehicle and communicatively coupled with the RFID reader; and
an RFID controller comprising:
a status indicator for generating a visual indication;
a processor; and
memory, communicatively coupled with the processor and storing:
a manifest defining RFID identifiers corresponding to assets expected to be transported by the vehicle; and
firmware having machine-readable instructions that, when executed by the processor, cause the processor to:
control the RFID reader to receive an RFID signal from an RFID tag using one of the at least one cargo area RFID antenna,
decode the RFID signal to determine an RFID identifier of the RFID tag, and
generate, using the status indicator, a visual indication indicative of an asset being loaded in error when the RFID identifier does not correspond to the manifest or not in error when the RFID identifier corresponds to the manifest.

2. The system of claim 1, wherein the machine-readable instructions that, when executed by the processor, cause the processor to generate, using the status indicator, a visual indication corresponding to the RFID identifier listed in the manifest not having a delivery address within a threshold distance of a current location of the vehicle or a predefined route of the vehicle.

3. The system of claim 1, further comprising:
at least one slot tape node positioned respectively at a slot of a rack in the vehicle and having a status indicator; and
the firmware further comprising machine-readable instructions that, when executed by the processor, cause the processor to send an instruction to the slot tape node to activate the status indicator when the asset being loaded is assigned to the slot.

4. The system of claim 3, the manifest defining the slot assigned to the asset.

5. The system of claim 3, the slot being one of a plurality of slots within the vehicle, each of the plurality of slots having one or more of the at least one slot tape node.

6. The system of claim 1, further comprising:
at least one external RFID antenna mounted at a rear end of the vehicle and facing rearwards; and
the firmware further comprising machine-readable instructions that, when executed by the processor, cause the processor to control the RFID reader to detect the RFID tag using the at least one external RFID antenna when the asset is behind the vehicle.

7. The system of claim 1, wherein the RFID reader, the at least one cargo area RFID antenna, and the RFID controller are co-housed in a monolithic housing.

8. The system of claim 7, the monolithic housing configured to retrofit a cargo area via one or more of, coupling to a ceiling of the cargo area, coupling to ribs within the cargo area, and replacing an existing lamp within the cargo area.

9. The system of claim 7, further comprising one or more of a proximity sensor, a vehicle interface for communicating with components of the vehicle, a camera, an input device, a light, and an audio generator.

10. The system of claim 1, further comprising an external RFID antenna positioned on an exterior of the vehicle, wherein the transmit an indication of the error includes transmitting an indication of the error using the external RFID antenna to another vehicle for relay to an external server.

11. A method comprising:
receiving data indicative of a potential change in a load status of assets in a vehicle;
in response, controlling an RFID reader to generate an interrogation signal by at least one cargo area RFID antenna located in a cargo area of the vehicle and receive an RFID signal associated with an RFID tag attached to an asset in response to the interrogation signal;
determining that an asset is being loaded onto the vehicle based on the received RFID signal;
decoding the RFID signal to determine an RFID identifier of the RFID tag;
updating a local database stored on a device in the vehicle with the RFID identifier; and
tracking the location of the asset within the interior of the vehicle, based on additional RFID signals received from the RFID tag.

12. The method of claim 11, the determining if the asset is being loaded onto the vehicle based on detecting a trajectory of the asset corresponding to entry into the vehicle based on received signal strength of the received RFID signal associated with the RFID tag.

13. The method of claim 11, further comprising:
comparing the RFID identifier to a received manifest;
determining that the asset was erroneously loaded onto the vehicle based on the RFID identifier not being included in the received manifest;
notifying a user that the asset was erroneously loaded, within a threshold period of time from when the user began loading the vehicle with the asset.

14. The method of claim 13, wherein the notifying the user comprises activating an indicator on the vehicle.

15. The method of claim 13, wherein the notifying the user comprises sending a notification or message to a client device associated with the user.

16. The method of claim 13, further comprising responsive to the asset not being removed from the vehicle after notifying the user, communicating with a server to update a database on the asset being located on the vehicle.

17. The method of claim 16, further comprising, performing at least one of: canceling a shipment, diverting another shipment of another similar asset, or issuing a new shipment in response to the asset not being removed from the vehicle.

18. The method of claim 11, wherein receiving data indicative of a potential load status of assets in the vehicle further comprises receiving sensor data that corresponds to a user entering or exiting the vehicle.

19. The method of claim 18, further comprising detecting the opening or closing of a door of the vehicle.

20. The method of claim 19, wherein the door is a door leading from a driver's cabin to a cargo storage area of the vehicle.

21. The method of claim 19, wherein the door is a door leading from outside of the vehicle to an interior of the vehicle.

22. The method of claim 11, further comprising detecting that the asset has moved from a first location inside of the vehicle to a second location inside of the vehicle based on the further received RFID signals from the RFID tag.

23. The method of claim 11, further comprising detecting that the asset has moved from a cargo area to a driver's cabin.

24. The method of claim 11, further comprising detecting that the asset has moved from a driver's cabin to a cargo area.

25. The method of claim 11, further comprising:
receiving an inquiry on the location of the asset within the interior of the vehicle, and
sending location data corresponding to the location of the asset within the interior of the vehicle, in response.

26. The method of claim 11, wherein the location data comprises a rack identifier corresponding to a location on a rack in the vehicle that is holding the asset.
